(19) United States
(12) Patent Application Publication
(10) Pub. No.: US 2010/0067644 A1
(43) Pub. Date: Mar. 18, 2010

(54) Thorium-based nuclear reactor and method

(76) Inventor: Hector A. D'Auvergne, San Leandro, CA (US)

Correspondence Address: D. Joseph English, Suite 1000, 505 9th Street, NW, Washington, DC, 20004, US

(21) Appl. No.: 12/232,244

(22) Filed: Sep. 12, 2008

(51) Int. Cl. G21C 13/02; G21C 19/00

(52) U.S. Cl. 376/294; 376/264

(57) ABSTRACT

A nuclear reactor and method for generating energy from fertile and fissile nuclear fuel material. The reactor may comprise a pressure vessel for housing a nuclear reactor core, the vessel having a lower vessel with an upwardly facing opening and a vessel closure head having a sealable access port. The vessel closure head may be positionable in differing positions relative to the lower vessel so that differing portions of the interior of the pressure vessel may be accessed through the access port. The lower vessel may include penetrations for lateral insertion of one or more reactor control blades into the interior of the lower vessel. The reactor core may comprise an inner driver region having substantially fissile nuclear fuel material, a breeder region substantially surrounding the driver region and having substantially fertile nuclear fuel material, a moderator substantially surrounding the breeder region, and a distal burner region having substantially fissile nuclear fuel material with higher fission product concentration than the driver region and being adaptable to receive neutrons from the driver and breeder regions. Generated heat from nuclear fuel in the reactor core may be removed by a gaseous coolant whereby the heated coolant is utilized to maintain the temperature of the moderator.

### RELATED APPLICATIONS

The instant application is co-pending with and claims the priority benefit of Provisional Application No. 60/960,044, filed Sep. 12, 2007, entitled “Nuclear Reactor and Method,” by the same inventor, the entirety of which is incorporated herein by reference.

### BACKGROUND

Nuclear reactors are widely utilized for the production of thermal or electrical power. Numerous reactor designs have been developed, leading to extensive technological studies; however, conventional reactors are not without problems. Control of the operation of nuclear reactors is generally delicate, as dramatically demonstrated by some reactor accidents. For most conventional reactor designs, preparation of the nuclear fuel material involves isotopic separation, a complex and costly process giving rise to nuclear proliferation concerns. Nuclear proliferation concerns also arise from the production of fissile Plutonium during the operation of conventional nuclear reactors. Energy recovery from such Plutonium, e.g., by means of a breeder reactor, is difficult and is marginally employed in the industry. Moreover, Plutonium and other actinides produced in conventional reactors are radiologically toxic and the disposal of such actinides is difficult.

Conventional nuclear energy is primarily based upon fissions of U²³⁵, which constitutes about 0.7% of natural Uranium. Early in the development of nuclear energy, the importance of breeding artificial nuclear fuels from more abundant nuclear species was realized. For example, starting from the dominant U²³⁸, one may breed Pu²³⁹ and from natural Thorium (pure isotope Th²³²) one may breed readily fissionable U²³³. U²³⁸—Pu²³⁹ breeding has generally led to an extensive development of breeder reactors; however, relatively little progress has been made with the Th²³²—U²³³ breeding chain.

Conventional nuclear reactors and breeder reactors generally rely upon a critical chain reaction which is employed inside a sealed enclosure, but many problems still exist despite several decades of extensive developments.

Therefore, embodiments of the present subject matter may provide a viable alternative to conventional nuclear reactors for extracting nuclear energy, thereby circumventing a number of problems encountered with conventional reactors and breeder reactors. Embodiments of the present subject matter may also utilize Thorium as a constituent of the nuclear fuel material.

According to other embodiments of the present subject matter, a method may be provided for producing energy from a nuclear fuel material contained in an enclosure such as a nuclear pressure vessel, through a process of breeding a fissile element from a fertile element of the fuel material via a β-precursor of the fissile element and fission of the fissile element. Further, neutrons from a “driver” or “seed” fissile element may interact with heavy nuclei contained in the fertile element to produce additional high energy neutrons, the neutrons thereby produced being multiplied by the breeding and fission process.

Accordingly, there is a need for nuclear reactor and method for generating energy that would overcome the deficiencies of the prior art. Therefore, an embodiment of the present subject matter provides a pressure vessel for housing a nuclear reactor core. The vessel may comprise a lower vessel having a generally cylindrical wall forming a generally circular upwardly facing opening and a pressure vessel closure head having a generally cylindrical lower portion with a dimension for mating with the upper edge of the wall of the lower vessel to form an airtight closure of the opening. The pressure vessel closure head may also include a curved upper portion having a sealable access port extending along a radius thereof where the closure head is rotatable in a horizontal plane about its central axis so that the access port may be positioned relative to the lower vessel for accessing differing portions of the interior of the pressure vessel without removing the closure head. The lower vessel and the closure head may thus be adapted to house the core of a nuclear reactor.

Another embodiment of the present subject matter may provide a pressure vessel comprising a lower vessel having an upwardly facing opening and a vessel closure head having a sealable access port. The vessel closure head may be supported by the lower vessel and adapted to form an airtight closure of the opening. The vessel closure head may also be positionable in differing positions relative to the lower vessel so that differing portions of the interior of the pressure vessel may be accessed through the access port.

An additional embodiment of the present subject matter may provide a vessel for providing an airtight chamber, the vessel comprising a lower portion having an upwardly facing opening, a closure head supported by the lower portion and being adapted to form an airtight closure of the opening, and a vehicle guide supported by the closure head. The lower portion and the closure head may form an airtight chamber.

One embodiment of the present subject matter provides a system for rotating the closure head of a nuclear reactor pressure vessel. The system may comprise a lower vessel having a generally cylindrical upper wall, the wall having a circumferential laterally extending rim defining an upwardly facing mating surface. The system may also comprise a vessel closure head having a generally cylindrical lower portion with a circumferential laterally extending rim defining a downwardly facing mating surface, and a circumferential vertically extending rim, the rim comprising a geared surface. The closure head may be positioned on the lower vessel with the downwardly facing mating surface adjacent the upwardly facing mating surface of the lower vessel. The system may include a plurality of clamps spaced around the periphery of the circumferential laterally extending rims, each of the clamps comprising an upper engaging surface for engaging the upper surface of the laterally extending rim of the closure head and a lower engaging surface for engaging the lower surface of the laterally extending rim of the lower vessel. A rigid support structure laterally surrounds the upper portion of the lower vessel and the lower portion of the closure head where a plurality of jack rollers are attached to the vessel closure head and spaced around the circumference of the vessel closure head, each of the rollers comprising a vertically oriented disc having an axle. One or more jacks may be spaced around an inner portion of the rigid support structure, each of the jacks being positioned to engage the disc of a jack roller to thereby elevate the closure head when the jacks are extended. One or more driving mechanisms may be supported from the rigid support structure, the driving mechanisms comprising a gear for engaging the geared surface of the vertically extending rim of the closure head, and a motor for turning the gear to thereby rotate the closure head when the closure head is elevated by the jacks.

Another embodiment of the present subject matter provides a method of positioning a vessel closure head having a lower surface mated on an upper surface of a lower vessel from a first position maintained by a plurality of clamps spaced about the periphery of the closure head to a second position. The method may comprise removing the clamps from the periphery of the closure head and elevating the closure head so that the lower surface of the closure head is spaced from the upper surface of the lower vessel. The method may further comprise driving a plurality of rollers each having a surface in frictional contact with a surface of the closure head to thereby rotate the closure head about a vertical axis, and ceasing the driving of the rollers so that the closure head has rotated to the second position.

Yet another embodiment of the present subject matter may provide a method of providing access to each fuel cell in a nuclear reactor from above the cell. The method may comprise housing a reactor core in a pressure vessel having a lower vessel with an upper cylindrical wall and a closure head supported by the wall, the closure head having an access port extending from a central portion to the periphery of the closure head along a radius thereof, and rotating the closure head relative to the lower vessel so that a selected cell in the fuel cell array is accessible from above the cell through the access port.

One embodiment of the present subject matter may provide a pressure vessel comprising a lower vessel having an opening defined by a lip forming a mating surface and a vessel closure head having a lip forming a mating surface, the closure head being positioned so that the closure head mating surface is mated to the lower vessel mating surface. A flexible seal may be positioned between opposing grooves formed in the mating surfaces, the seal being inflatable to a predetermined pressure. Plural clamps may be positioned along the mated lips, each of the clamps engaging the closure head lip and the lower vessel lip to thereby maintain an airtight seal between the mating surfaces when the interior of the vessel contains a pressure greater than 100 psi.

Another embodiment of the present subject matter may provide a system for sealing a closure head on a pressure vessel wherein the closure head includes a mating surface positioned adjacent a mating surface of the vessel. The system may comprise an inflatable seal positioned in opposing grooves formed in the mating surfaces and a plurality of interlocking clamps frictionally engaged with the closure head and vessel to thereby maintain an airtight closure when the vessel contains pressure greater than 100 psi.

A further embodiment of the present subject matter may provide a pressure vessel having a weldless and threadless system for maintaining a pressure containing seal between a lower vessel and closure head. The pressure vessel may comprise a lower vessel comprising a generally cylindrical upper wall, the wall having a circumferential laterally extending rim defining an upwardly facing mating surface having a circumferential groove formed therein, the lower surface of the rim having a circumferential groove formed therein. The vessel closure head may comprise a generally cylindrical lower portion having a circumferential laterally extending rim defining a downwardly facing mating surface, the upper surface of the rim having a circumferential groove formed therein, the lateral surface of the rim forming a circumferential recessed portion, the rim including a curved surface interconnecting a lateral wall of the recessed portion to said mating surface, the closure head being positioned on the lower vessel with the downwardly facing mating surface adjacent the upwardly facing mating surface of the lower vessel to thereby form a channel bounded on the bottom half by the groove formed in the lower vessel mating surface and bounded on an upper quadrant by the curved interconnecting surface of the closure head rim. An inflatable seal may be positioned within the channel and a plurality of interlocking clamps may be spaced around the periphery of the circumferential laterally extending rims.

An additional embodiment of the present subject matter may provide a method for sealing a pressure vessel having a vessel closure head with a lower mating surface adaptable to mate with an upper mating surface of a lower vessel. The method may comprise the steps of installing an inflatable seal between the lower mating surface of the vessel closure head and the upper mating surface of the lower vessel and positioning the vessel closure head to thereby mate the upper and lower mating surfaces. A plurality of clamps may be positioned about the periphery of the closure head, each of the clamps including an upper engaging portion for engaging an upper surface of a laterally extending rim of the vessel closure head, a lower engaging portion for engaging a lower surface of a laterally extending rim of the lower vessel, and an elongated portion connecting the upper and lower engaging portions. The elongated portion may include a notch on one lateral side and a lateral extension on an opposing lateral side extending from approximately the midsection of the elongated portion to the notch of an adjacent clamp. The method may further include securing the position of each clamp by frictionally engaging the upper and lower engaging portions with the rims, and inflating the inflatable seal to a predetermined pressure.

An embodiment of the present subject matter may provide a system for controlling the reactivity of a nuclear reactor core. The system may include a pressure vessel for housing the nuclear reactor core, the vessel having a lower vessel and a vessel closure head where the vessel closure head is supported by the lower vessel. A plurality of neutron absorbing devices may be laterally inserted into the lower vessel to control the reactivity of the core.

Another embodiment of the present subject matter may provide a nuclear reactor having a core comprising a plurality of fuel cells aligned along substantially parallel axes and a system for controlling the reactivity of the reactor core comprising a plurality of neutron absorbing devices being insertable into the reactor core. The plurality of neutron absorbing devices may be inserted into the reactor core by rotating the devices about one or more axes substantially perpendicular to the axes of the fuel cells.

An additional embodiment of the present subject matter provides a nuclear reactor having a core comprising one or more fuel cells and a system for controlling the reactivity the reactor core comprising a plurality of neutron absorbing devices being insertable into the reactor core. The plurality of neutron absorbing devices may be inserted into the reactor core by moving along an arcuate path.

A further embodiment of the present subject matter provides a system for inserting one or more neutron absorbing devices into a nuclear reactor core and for withdrawing the one or more devices from the core. The system may comprise a rotatable axle having a disc connected proximate one end of said axle, the disc having a geared surface and being connected to the axle so that rotation of the disc effects rotation of the axle. The system may further comprise a neutron absorbing device having a configuration adapted for insertion of at least a neutron absorbing portion of the device into the nuclear reactor core, the device being connected to the rotatable axle and extending laterally from said axle so that the device rotates about the axis formed by the axle. The system may further include an axle driving mechanism having a motor operatively connected to a drive shaft, the drive shaft having a geared surface engaged with the geared surface of the disc so that rotation of the drive shaft effects rotation of the disc and axle, whereby the neutron absorbing device is rotatable about the axis of the axle from a position wherein the neutron absorbing portion is withdrawn from the core to a position wherein at least a portion of the neutron absorbing portion is inserted in the core.

One embodiment of the present subject matter provides a nuclear reactor core comprising a central driver region comprising a plurality of fissile nuclear fuel assemblies, a breeder region surrounding the central driver region, the breeder region comprising a plurality of fertile nuclear fuel assemblies, and a moderator region surrounding the breeder region, the moderator region comprising a material suitable for thermalizing fast neutrons.

Another embodiment of the present subject matter provides a nuclear reactor having a pressure vessel housing a nuclear reactor core. The nuclear reactor core may comprise a central driver region comprising a plurality of fissile nuclear fuel assemblies containing fissile material, and a breeder region surrounding the central driver region, the breeder region comprising a plurality of fertile nuclear fuel assemblies containing ThO2. The core may further include a moderator region surrounding the breeder region, the moderator region comprising a carbon-based material suitable for thermalizing fast neutrons, and a buffer region surrounding the moderator region. A burner region may also surround the buffer region, the burner region comprising a plurality of fuel assembly wells each adapted to receive a fissile nuclear fuel assembly from the plurality of fissile nuclear fuel assemblies in the driver region. A plurality of coolant pipes may also be positioned within the buffer region for transferring heat from the burner region to the moderator material. A shielding region may surround the burner region where a plurality of coolant pipes may be positioned between the shielding region and the wall of the pressure vessel for cooling the pressure vessel wall.

One embodiment of the present subject matter provides a method for reducing fission product concentration of fission products in a nuclear reactor. The method may comprise providing an inner first region in a nuclear reactor core, the first region having substantially fissile nuclear fuel material and providing a second region in the reactor core, the second region substantially surrounding the first region and having substantially fertile nuclear fuel material. The second region may be substantially surrounded with a moderator to slow neutrons escaping from the first and second regions and a distal third region appropriately positioned, the third region having substantially fissile nuclear fuel material, having a substantially higher fission product concentration than the first region, and being adapted to receive neutrons from the first and second regions.

In another embodiment of the present subject matter, a method for reducing concentration of fission products in nuclear fuel material is provided. The method may comprise providing an inner first region in a nuclear reactor core, the first region having substantially fissile nuclear fuel material having substantially high fission product concentrations and providing a second region in the reactor core, the second region substantially surrounding the first region and having substantially fertile nuclear fuel material. The second region may then be substantially surrounded with a moderator to slow neutrons escaping from the first and second regions, wherein one of the substantially high fission product concentrations is a function of plutonium.

Yet another embodiment of the present subject matter provides a method of producing energy. The method comprises providing fissile nuclear fuel material in a first region of a nuclear reactor core and providing fertile nuclear fuel material in a second region of the nuclear reactor core. A moderator may be provided in a third region of the nuclear reactor core, and the fertile nuclear fuel material may be irradiated with neutrons from the first region to breed fissile nuclear fuel material in the second region. Fissile nuclear fuel material may be removed from the second region as a function of fissile material concentration and fissile nuclear fuel material may be removed from the first region as a function of fission product concentration. The removed fissile nuclear fuel material may be positioned from the second region into the first region, and the removed fissile nuclear fuel material may be positioned from the first region into a distal fourth region of the nuclear reactor core. Additional fertile nuclear fuel material may the be provided in the second region to replace the removed fissile nuclear fuel material.

One embodiment of the present subject matter provides a nuclear reactor core sub-assembly for supporting and containing nuclear fuel rods. The sub-assembly may comprise a plurality of stacked fuel housing structures, each of the structures including a central region forming a central coolant channel having an axially extending lip surrounding the channel at one end and an axially extending recess at the other end surrounding the channel, and a peripheral region forming a plurality of fuel wells spaced around the central region, each of the wells having a closed bottom portion and being adapted to receive one or more nuclear fuel rods from an open top end. A first housing may be positioned on top of a second housing so that the axially extending recess of the first housing is positioned over the lip of the second housing, the channel of the first housing is axially aligned with the channel of the second housing, and the bottom surface of the peripheral region of the first housing covers the open ends of the fuel wells of the second housing.

Another embodiment of the present subject matter includes a nuclear reactor core sub-assembly comprising a plurality of stacked rectangular blocks. Each of the blocks may comprise a generally rectangular interior region forming a plurality of generally cylindrical wells extending between opposing major faces of said region, each well being adapted to receive a fuel housing structure, and a peripheral wall surrounding the interior region. The wall may extend axially from one of the major faces of the interior region forming a lip about the periphery of the major face, the peripheral wall terminating at a point axially spaced from the other of the major faces forming a recess about the periphery of the major face, where the recess may be adapted to receive the lip of an adjacent block.

One embodiment of the present subject matter provides a system for cooling a nuclear reactor comprising a pressure vessel having a lower vessel having an upwardly facing opening and a vessel closure head being supported by the lower vessel and being adapted to form an airtight closure of the opening. A nuclear reactor core may be positioned in the lower vessel, the core including a central driver region, a breeder region, and a moderator region. The reactor may include a coolant system comprising a first coolant manifold having an inlet plenum and a plurality of pylons positioned beneath fertile nuclear fuel assemblies, the pylons being in fluid communication with the coolant channels of the fuel assemblies and being configured to direct coolant flow into the channels at a first predetermined coolant flow rate, and a second coolant manifold having an inlet plenum and a plurality of pylons positioned beneath the fissile nuclear fuel assemblies, the pylons being in fluid communication with the coolant channels of the fuel assemblies and being configured to direct coolant flow into the channels at a second predetermined coolant flow rate. The coolant system may further include one or more coolant pumps adapted to pump coolant into the first and second coolant manifold inlet plenums, and a coolant outlet positioned above the fertile and fissile nuclear fuel assemblies and being configured to receive coolant flowing from the coolant channels of the fertile and fissile nuclear fuel assemblies and direct the flow to an outlet plenum. In another embodiment, the reactor core may further include reactor coolant exhaust pipes to receive heated reactor coolant from the core to control the temperature of the moderator region.

Yet another embodiment of the present subject matter provides a method for cooling a nuclear reactor. The method comprises providing a pressure vessel, vessel closure head being supported by the lower vessel, and a nuclear reactor core positioned in the lower vessel. The core may include first and second regions of nuclear fuel material a moderator. Reactor coolant may be directed to the first and second regions where the passage of the reactor coolant therethrough removes heat generated by the nuclear fuel materials.

One embodiment provides a method of removing heat from a nuclear reactor core. The method may comprise providing a pressure vessel having a lower vessel housing a nuclear reactor core and having a generally planar horizontal lower deck and a generally cylindrical wall extending upwardly from the lower deck and a vessel closure head being supported by the lower vessel. Water may be distributed through piping in the closure head in a first water coolant flow path and through piping in the generally cylindrical walls in a second water coolant flow path. Gaseous reactor coolant may be distributed to the reactor core in one or more gaseous coolant flow paths. The passage of the water and gaseous coolant removes heat generated by nuclear fuel materials in the reactor core. The first and second water coolant flow paths and the gaseous reactor coolant flow path may also be substantially independent of the other flows.

Another embodiment of the present subject matter provides a method of removing residual heat from a nuclear reactor core. The method may comprise providing a pressure vessel having a lower vessel housing a nuclear reactor core and having a generally planar horizontal lower deck and a generally cylindrical wall extending upwardly from the lower deck and a vessel closure head being supported by the lower vessel. If an abnormal temperature, pressure, or flow in the reactor core or supporting components thereof is sensed, then one or more neutron absorbing devices may be inserted into the interior of the lower vessel. Water may be distributed through piping in the closure head and generally cylindrical wall, and gaseous reactor coolant may be distributed to the reactor core. Passage of the water and gaseous coolant may thus remove heat generated by nuclear fuel materials in the reactor core.

These embodiments and many other objects and advantages thereof will be readily apparent to one skilled in the art to which the invention pertains from a perusal of the claims, the appended drawings, and the following detailed description of the embodiments.

### BRIEF DESCRIPTION OF THE DRAWINGS

FIG. 1 is a plot showing equilibrium concentration ratios of Th²³² and U²³³ as a function of neutron energy.

FIG. 2 is a diagram illustrating various nuclear reactions occurring from Th²³².

FIG. 3 is a side view of a pressure vessel according to an embodiment of the present subject matter.

FIG. 4 is a side view of the pressure vessel of FIG. 3 rotated clockwise ninety degrees.

FIG. 5 is a top plan view of a pressure vessel according to an embodiment of the present subject matter.

FIG. 6 is a perspective view of a pressure vessel according to an embodiment of the present subject matter.

FIG. 7 is a top plan view of a pressure vessel according to another embodiment of the present subject matter.

FIG. 8 is a portion of a cross section of the pressure vessel of FIG. 7 along line A-A.

FIGS. 9A and 9B are side views of a pressure vessel according to an embodiment of the present subject matter.

FIG. 10 is a block diagram representing another method according to one embodiment of the present subject matter.

FIG. 11 is a top plan view of a closure head according to one embodiment of the present subject matter.

FIG. 12 is a top plan view of a segment of a sealing system according to an embodiment of the present subject matter.

FIG. 13 is an enlarged view of a sealing system according to an embodiment of the present subject matter.

FIG. 14 is a cross-sectional view of a clamp in a sealed position according to an embodiment of the present subject matter.

FIGS. 15A and 15B are perspective views of a clamp according to an embodiment of the present subject matter.

FIG. 16 is a block diagram representing a method according to one embodiment of the present subject matter.

FIG. 17 is a horizontal cross section of a lower vessel of a pressure vessel according to an embodiment of the present subject matter.

FIG. 18 is a cross section of a pressure vessel protuberance housing neutron absorbing devices according to an embodiment of the present subject matter.

FIG. 19 is a perspective view of a neutron absorber actuator assembly according to an embodiment of the present subject matter.

FIG. 20 is a vertical cross section of a lower vessel of a pressure vessel according to an embodiment of the present subject matter.

FIG. 21 is a schematic diagram illustrating different regions of a reactor core according to one embodiment of the present subject matter.

FIG. 22 is a graph showing U²³³ concentration in a fertile nuclear fuel element according to one embodiment of the present subject matter.

FIG. 23 is a graph showing the evolution of fissile isotopes over time averaged over a nuclear reactor core according to an embodiment of the present subject matter.

FIG. 24 is a graph showing fuel inventory for an embodiment of the present subject matter.

FIG. 25 is a graph showing electrical generation over a fifteen year period according to an embodiment of the present subject matter.

FIG. 26 is a horizontal cross-sectional view of a pressure vessel including a reactor core according to an embodiment of the present subject matter.

FIG. 27 is a perspective view of the pressure vessel and reactor core of FIG. 26.

FIGS. 28 and 29 are a cross-sectional views of the pressure vessel and reactor core of FIG. 26 along lines A-A and B-B, respectively.

FIG. 30 is a block diagram representing a method according to one embodiment of the present subject matter.

FIG. 31 is a block diagram representing a method according to another embodiment of the present subject matter.

FIGS. 32A and 32B are perspective views of a nuclear fuel housing according to an embodiment of the present subject matter.

FIGS. 33A and 33B are top plan and bottom plan views of a nuclear fuel housing according to an embodiment of the present subject matter.

FIG. 34 is a cross-sectional view of the nuclear fuel housing of FIG. 32A along line A-A.

FIG. 35 is a cross-sectional view of a nuclear fuel sub-assembly according to an embodiment of the present subject matter.

FIGS. 36A and 36B are perspective views of a nuclear fuel assembly according to an embodiment of the present subject matter.

FIG. 37 is a top plan view of a nuclear fuel assembly according to an embodiment of the present subject matter.

FIG. 38 is a cross-sectional view of a nuclear fuel assembly according to an embodiment of the present subject matter.

FIG. 39 is a perspective view of a nuclear fuel array according to an embodiment of the present subject matter.

FIG. 40 is a perspective view of a coolant manifold system according to an embodiment of the present subject matter. With reference to FIG. 40,

FIG. 41 is a horizontal cross-sectional view of the upper coolant manifold of FIG. 40.

FIG. 42 is a horizontal cross-sectional view of the lower coolant manifold of FIG. 40.

FIGS. 43A-D are graphical illustrations of upper and lower manifold inlet plenums and transition components according to an embodiment of the present subject matter.

FIG. 44 is a block diagram representing a method according to one embodiment of the present subject matter.

FIGS. 45 and 46 are schematic diagrams of a reactor system under normal operating conditions according to an embodiment of the present subject matter.

FIGS. 47 and 48 are schematic diagrams of a reactor system under loss of coolant conditions according to an embodiment of the present subject matter.

FIG. 49 is a diagram of a reactor safety and control system according to one embodiment of the present subject matter.

### DETAILED DESCRIPTION

With reference to the figures where like elements have been given like numerical designations to facilitate an understanding of the present subject matter, the various embodiments of a nuclear reactor and method are herein described.

Embodiments of the present subject matter achieve the goal of creating practical nuclear energy based on the natural Thorium breeding-burning cycle by containing a minimal, constant amount of fissile material, resulting from a stable equilibrium condition between breeding and fissions. Spent nuclear fuel material, either originally fissile or fertile nuclear fuel material, may be placed in different portions of the nuclear reactor core to further reduce fission product concentration by continued absorption of neutrons. In another embodiment, spent fuel may be returned to an offsite facility to be regenerated, removing the “poisons” due to fission products and recovering the chemically separated Uranium isotopes which may then become “seeds” for another fuel load.

Thorium-based nuclear reactors and breeders offer several advantages with respect to Uranium-based nuclear reactors and breeders. For example, Thorium is more abundant than Uranium. More importantly, Thorium is a pure isotope, which can, in principle, all be used as fuel. Further, Thorium does not require a costly and complicated isotopic enrichment process. The breeding and energy producing reactions used in embodiments of the present subject matter generate few actinides among the radioactive waste. For example, during operation, an approximately constant quantity of fissionable nuclei is present and continuously burnt and regenerated from the bulk material. In contrast, conventional reactors produce a large surplus of long-lived and highly toxic Actinides (e.g., the number of Plutonium nuclei produced is typically 0.5 to 0.9 of the fissioned U²³⁵ nuclei), growing essentially indefinitely with the burn-up of the fuel. While there is a comparable quantity of fission products in both Thorium-based and Uranium-based nuclear reactors, the toxicity of the fission products for Thorium based reactors is strong, but short-lived. These fission products decay well below the toxicity level of a volume of natural Uranium ores for an equivalent energy delivery in a period of a few hundred years.

Additionally, with Thorium the risk of nuclear proliferation is negligible, since the potentially strategic material, namely U²³³, is present in the nuclear fuel as an isotopic mixture, with U²³² produced by (n, 2n) reactions in sufficient amount to positively “denaturate” the Uranium if chemically separated. The U²³² isotope is relatively short-lived (70 years) and possesses decay products that are highly radioactive and produce a large amount of spontaneous heat thereby making any military diversion of the material difficult. As yet, the added toxicity due to the presence of U²³² is not so large as to make any processing of the spent fuel impossibly expensive. This feature is, of course, lost when the Pa²³³ produces later by decay, essentially pure, bomb grade U²³³ This effect is obviously maximized in the case of fast neutrons which produce about fifty times more U²³² than thermal neutrons. Fast neutrons also provide an added advantage that the production of higher-mass actinides is, in practice, suppressed. Even the production of the lower Neptunium and Plutonium isotopes, Np²³⁷ and Pu²³⁸, is virtually absent. This also applies to higher Plutonium, Americium, Curium, Californium isotopes, etc., which are the main source of long-lived toxicity of conventional nuclear reactors.

While the explanations of the relevant nuclear mechanisms set forth herein is based on the best presently known evidence, the scope of the claims appended herewith are not bound thereby as additional data may be later discovered and may modify particulars of embodiments of the present subject matter.

The amount by which neutrons are slowed down from production to fission is application-dependent. For example, one may slow down neutrons to thermal energies (Eₐᵥₑ≈0.025 eV, and generally less than 0.6 eV) or one may slow down neutrons to epithermal energies (En is generally between 0.6 eV and 0.1 MeV). In reactors where light water is utilized as a moderator, neutrons may generally reach energies on the order of several eV. In reactors where liquid metal or graphite is utilized as a moderator, neutrons may generally be thermal or epithermal. In other applications, one may also utilize coolants having little moderating action and hence operate with neutrons of energies approximately on the order of 0.1 MeV or more. These neutrons are generally known as fast neutrons.

To obtain a high energy output, the average neutron flux Φ to which the nuclear fuel material is exposed should be substantially high. However, the average neutron flux Φ should be sufficiently low to prevent neutron captures by a substantial amount of the β-precursor of the fissile element. Such a condition may ensure that practically all the β-precursor nuclei are transformed into the relevant fissile element and that the neutron balance in a respective reactor core is not affected by undesired captures thereby optimizing energy gain.

Since the breeding and fission process is generally subcritical, the effective multiplication factor k_{eff} is smaller than 1. To obtain a high gain, the fissile content of any fissile fuel material may be such that k_{eff} is relatively close to 1 (typically 0.9≦k_{eff}≦0.98). Reactor control rods, bars, blades or the like may also be utilized to reduce fissile content in the event of a reactor casualty (i.e., the fissile content increases due to the β-decays of the available β-precursors, and the system becomes critical).

The largest value of k at which embodiments of the present subject matter may operate generally depends upon the type of protections employed and the operational stability of k_{eff} due to the above-indicated effects and which in turn depend upon which energy domain is selected for the neutrons. Generally, it may be stated that the above conditions permit for fast neutrons a substantially larger k_{eff} than for thermal or epithermal neutrons.

Once the fertile nuclear fuel material has reached equilibrium conditions, a burning phase takes place, where the ratio between the concentrations of the fissile element and of the fertile element in the nuclear fuel material is substantially stable. When, in the initial fuel load for embodiments of the present subject matter, the ratio between the concentrations of the fissile element and the fertile element is substantially smaller than the stable value of the ratio in the burning phase, an initial breeding phase may be employed to reach the stable value. Such breeding may, of course, utilize additional fissile nuclear fuel material as a source such as reactor or weapons grade Plutonium and/or Uranium typically utilized in conventional reactors. It is also possible to use an initial nuclear fuel load in the fertile nuclear fuel material in which the ratio between the concentrations of the fissile element and of the fertile element is about the stable value of the ratio in the burning phase. In such a case, the fissile element content of the initial fuel load may be recovered from another nuclear fuel material consumed in a previous similar energy production operation. Alternatively, additional nuclear fuel material may be installed in the reactor core having an initial content in which the ratio between the concentrations of the fissile element and of the fertile element is substantially higher than the stable value of the ratio in the burning phase. This additional nuclear fuel material may be removed from the core once the stable value of the ratio is reached and may be utilized in subsequent energy production operations.

In embodiments of the present subject matter, a solid-phase moderator medium, such as graphite, may be utilized to achieve a substantially complete thermalization of the high energy neutrons produced by the nuclear fuel material. One advantage of this embodiment is that the heat produced by the fissions may be extracted by means of gaseous coolants, which are known to give rise to higher thermodynamic efficiencies than liquid coolants.

Liquid metals such as Lead, Bismuth, Sodium, or eutectic mixtures thereof may also be utilized as a coolant. One reason for selecting liquid metals over light water as a moderator is the fact that these materials are high energy targets offering an excellent neutron yield. Although light water as a coolant is well known due to the vast experience of pressurized water reactors, its high pressure is not without potential problems, e.g., a massive loss of the coolant due to a leak may lead to a melt-down of the reactor core. This and other problems may be strongly attenuated by reducing the temperature and, hence, the operating pressure of the water, but at the cost of a lower thermodynamic efficiency; however, light water could still be of interest for special applications, e.g., water desalination or heat production.

Embodiments of the present subject matter employing driver or seed fissile nuclear fuel material circumvents the well known difficulty that nuclear reactors are plagued by an insufficient breeding power to use natural Thorium as the primary fuel in practical conditions. To have a fully self-sufficient breeding chain reaction, the number of secondary neutrons η resulting from one neutron captured should exceed two for the fissile element each time one neutron is sacrificed to replace a fissioned nucleus out of the fertile nucleus and one neutron is needed to continue the fission chain. Such sustained breeding is difficult in conventional reactors, since for thermal neutrons η=2.29 for U²³³, very close to the minimal condition η≧2. Therefore, in a conventional reactor fully sustained breeding is plagued by the problem of neutron inventory. For example, to ensure both breeding and criticality, at most a fraction (2.29−2)/2.29=0.126 of the neutrons may be lost by containment losses and capture by other materials. This is close to the minimal value of neutron losses which can be achieved, leaving little or no room for the inevitable build up of captures due to fission fragments and other mechanisms of neutron absorption related to the breeding process. Consequently, a Thorium-based conventional thermal reactor generally cannot operate in a satisfactory manner on a self sufficient Th²³²—U²³³ cycle. Driver or seed fissile nuclear fuel material providing a supply of neutrons removes the above mentioned limitations.

Fast neutrons are in a region in which η is significantly larger than for thermal and epithermal neutrons. In addition, because of the higher energies, neutrons may be produced at each generation by different processes, e.g., fast fissions in the fertile material Th²³² and (n, 2n) reactions in the nuclear fuel and/or the moderator. To take into account these contributions, it is customary to replace the parameter η with ηε where ε represents the ratio of all neutrons produced to the neutrons produced from fissile material. Regarding fast neutrons, one expects ηε≈2.4-2.5 which is significantly larger than η=2.29.

A very large fission cross section for low energy neutrons is a unique property of a few high Z nuclei such as U²³³. Heavy nuclei such as Th²³² possess no significant fission cross section below ≈1 MeV, but may be utilized to breed fissionable materials. At low energies, the (n-γ) reaction (neutron capture) is an inelastic process, leading to a final (excited) nucleus with one more neutron. In turn, the daughter nucleus is P-unstable and leads through a cascade of decays to a final, higher Z-nucleus. Hence the neutron capture reaction offers the possibility of “breeding” fissionable fuels from initial materials:

Th²³²+n [symbol] Th²³³+γ [symbol] Pa²³³+β⁻ [symbol] U²³³+β⁻ (1)

The ratio of n-capture reaction σᵢ to fission reaction σ_{f}, averaged over the neutron spectrum and the material composition may generally be represented by α and the neutron multiplicity represented by ν. Hence the fraction of fission and capture reactions may be represented by 1/(1+α) and α/(1+α), respectively. The quantity η=ν/(1+a) represents the number of secondary neutrons resulting from one neutron interaction.

Assuming a thin slab of fertile material Th²³² is exposed to a neutron flux Φ, the successive nuclei Th²³² (X₁), Pa²³³ (X₂) and U²³³ (X₃) provided in Equation (1) may be represented by the following basic differential equations:

$$\begin{matrix}\frac{d {n}_{1}}{d t} = - {λ}_{1} {n}_{1} ( t ) & ( 2 ) \\ \frac{d {n}_{2}}{d t} = {λ}_{1} {n}_{1} ( t ) - {λ}_{2} {n}_{2} ( t ) & ( 3 ) \\ \frac{d {n}_{3}}{d t} = {λ}_{2} {n}_{2} ( t ) - {λ}_{3} {n}_{3} ( t ) & ( 4 ) \\ \frac{d {n}_{4}}{d t} = {λ}_{3} {n}_{3} ( t ) & ( 5 )\end{matrix}$$

where nₖ(t) represents the concentration of element Xₖ in the nuclear fuel materials (k=1, 2, 3) at time t, and n₄(t) is the concentration of the fission products of X₃, where the γ transition of Th²³² to its ground state and the subsequent β-transition to Pa²³³ are neglected, and where λ represents the decay constants for the respective nuclear fuel materials.

With reference to Equation (1), it follows that λ₁=σᵢ⁽¹⁾Φ, λ₂=1/τ₂, λ₃=[σᵢ⁽³⁾⁺σ_{f}⁽³⁾]Φ, where τ₂ represents the half life of X₂ under β-decay. Initially, n₂(0)=n₃(0)=0. Solving the differential equations represented in Equations (2)-(5) and assuming that λ₁<<λ₂<<λ₃ the following representations for concentrations of Th²³² (X₁), Pa²³³ (X₂), and U²³³ (X₃) at time (t) may be made:

$$\begin{matrix}{n}_{1} ( t ) = {n}_{1} ( 0 ) {e}^{- {λ}_{1} t} & ( 6 ) \\ {n}_{2} ( t ) = {n}_{1} ( t ) \frac{{λ}_{1}}{{λ}_{2}} ( 1 - {e}^{{λ}_{2} t} ) & ( 7 ) \\ {n}_{3} ( t ) = {n}_{1} ( t ) \frac{{λ}_{1}}{{λ}_{3}} [ 1 - \frac{1}{{λ}_{3} - {λ}_{2}} ( {λ}_{3} {e}^{{λ}_{2} t} - {λ}_{2} {e}^{{λ}_{3} t} ) ] & ( 8 )\end{matrix}$$

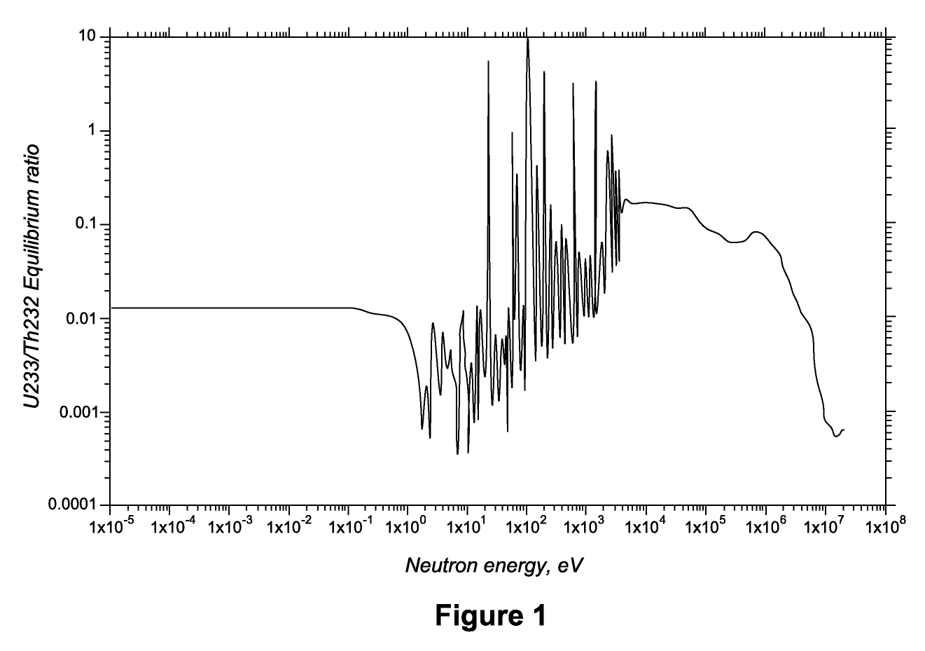

In stationary conditions, n₃/n₁=σᵢ⁽¹⁾/[σᵢ⁽³⁾⁺σ_{f}⁽³⁾] independently of the neutron flux. FIG. 1 is a plot of n₃/n₁ in the case of a Th²³² and U²³³ mixture as a function of neutron energy in MeV. Operations without a moderator and with a neutron spectrum directly from fissions (fast neutrons) generally provide an equilibrium concentration of fissile material approximately seven times larger than equilibrium concentration for a thermalized neutron alternative. It thus follows that fast neutrons allow much higher burn-up rates and hence the total amount of fuel can be correspondingly reduced.

To achieve sufficient breeding, most of the Pa²³³ must survive neutron capture and decay into U²³³, which is translated into the condition σᵢ⁽²⁾Φτ₂<<1. Inelastic cross sections for energies E up to a few eVs (e.g., below the resonance region) may be parameterized as σ(E)=(0.025 eV/E)^{1/2}Σ, with macroscopic cross sections Σ being listed for relevant elements below in Table 1.

TABLE 1
Parameters of some nuclei [σ(E) = (0.025 eV/E)^{1/2}Σ]

| | Elastic, Σ | Capture, Σ | Fission, Σ | n-multip. | sec/prim | σ(γ)/σ(f) |
|---|---|---|---|---|---|---|
| Element | barn | barn | barn | ν | η | α |
| Th²³² | 13.0 | 7.48 | <2 × 10⁻⁴ | | | |
| Pa²³³ | 13.1 | 40.6 | — | | | |
| U²³³ | 12.7 | 46.2 | 534 | 2.52 ± 0.03 | 2.28 ± 0.02 | 0.105 ± 0.007 |
| U²³⁵ | 10 ± 2 | 112 ± 110 | 582 ± 10 | 2.47 ± 0.03 | 2.07 ± 0.02 | 0.192 ± 0.007 |
| U²³⁸ | 8.3 ± 0.2 | 2.75 ± 0.04 | <5 × 10⁻⁴ | | | |
| Pu²³⁹ | 9.67 ± 0.5 | 285 ± 13 | 740 ± 9 | 2.91 ± 0.04 | 2.09 ± 0.02 | 0.39 ± 0.03 |

In the case of fast neutrons, cross sections are somewhat dependent upon the choice of the chemical composition of the fuel (pure metal vs. oxide) and upon the respective coolant. Considering the relatively long mean life of Pa²³³, i.e., the significant reactivity addition occurring during an extended shut-down and following the characteristic decay lifetime of Pa²³³, the concentration of U²³³ will increase by an amount asymptotically equal to the concentration of Pa²³³, essentially independent of the mode of operation of a respective system for a given equilibrium burn-up rate. With fast neutrons, however, the equilibrium concentration of U²³³ is about seven times larger and its effect upon reactivity will be approximately 1/7 as compared to the thermal case.

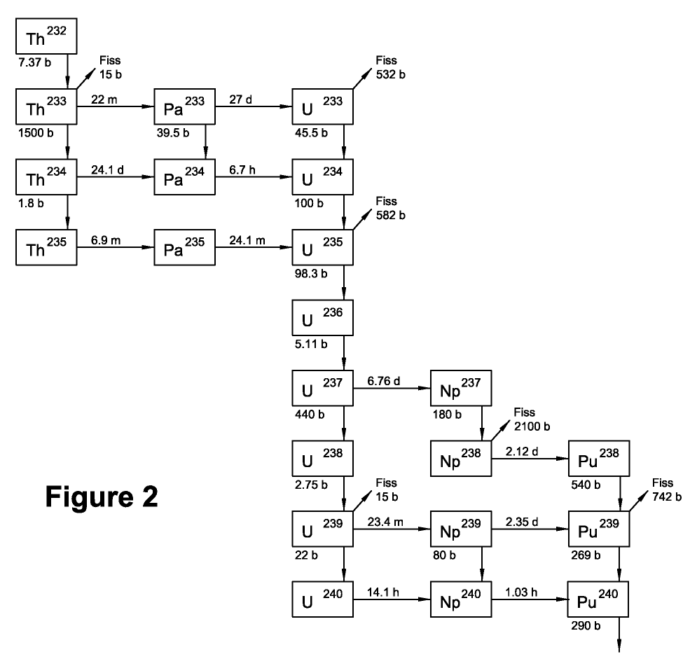

Considering fast neutron capture by the intermediate elements of the breeding process, specifically by Pa²³³, the microscopic cross section σₐ (Pa²³³) is about 43 b at thermal energies and 1.0 b for fast neutrons. Therefore, for fast neutrons, the cross section is much smaller but the flux is correspondingly larger, that is, for a given burn-up rate, the loss is approximately 0.67 times of the value for thermal neutrons. Note, however, that the allowance for neutron losses is much greater for the fast neutrons which have a larger ηε, and therefore larger burn-up rates are practical (at three times the burn-up rate the loss is twice that for thermal neutrons). Many more reactions occur because of the neutron flux and of natural decays. The chain of possible reactions starting from the initial Th²³² fuel is shown in FIG. 2, where vertical arrows identify neutron captures with the associated cross sections in barns, oblique arrows identify n-fissions with the associated cross sections in barns, and horizontal arrows identify p-decays with the associated half-lives in minutes (m), hours (h) or days (d).

As discussed above, because of the higher energies associated with fast neutrons, additional neutrons are produced at each generation by different processes, e.g., fast fission in the fertile material Th²³² and (n, 2n) reactions in the fuel and moderator. It should also be noted that, in fast neutron operation, most even-even nuclei, U²³², U²³⁴, U²³⁶ and so on, exhibit a significant fission cross section. Therefore, most of these elements also become useful fuels.

As briefly mentioned above, in a nuclear reactor, neutron flux is sustained by the neutron multiplication process, which is fission driven. A key parameter is the effective multiplication factor, k_{eff}, the ratio of neutrons at the end of a generation to the number of neutrons starting that generation. For a critical Reactor, k_{eff}=1. Separating the effects of neutron leakage, one may introduce the corresponding parameter k_{∞}=k_{eff}/P, which represents a parameter applicable to a homogeneous reactor core arrangement having dimensions large enough to make neutron leakage probability I-P negligible. k_{∞} must be significantly larger than 1 to permit criticality with a sufficiently small reactor core volume.

In the case of theoretically pure natural Uranium and graphite, the maximum possible value of k_{∞}≈1.1. When heavy water is utilized as a moderator with natural Uranium, higher k_{∞}, constants approaching 1.3 may be attainable. This leaves sufficient room for losses due to leakage and absorption to realize practical devices. For a Thorium-based reactor, however, the situation is not so favorable. As is well known, the value of k_{∞} is directly related to the concentration of fissile material. For example, for natural Uranium the relevant concentration is U²³⁵ which is fixed and known (0.7%); however, in the case of Thorium breeding, the equilibrium concentration of U²³³ is dependent upon the previous intensity and history of local neutron flux. An equilibrium level in which fissioned U²³³ is balanced by the amount of U²³³ bred from Th²³² is dependent upon the energy spectrum of the captured neutrons—which in turn is related to the basic geometry of the reactor core. In addition to U²³³, several other Uranium isotopes and actinides are formed having various decay constants, which also reach an equilibrium level and contribute to both neutron captures, multiplication with fissions, and to a minor extent (n, 2n) reactions. As a large number of moderators may be used and ample choices are available, the selection of a moderator according to embodiments of the present subject matter may be application-dependent and dictated by requirements of the specific reactor design. Generally, the moderator must be sufficient to reduce the energy of fission neutrons, since at lower energies the amount of U²³³ needed to reach breeding equilibrium is smaller.

Hence, in realistic conditions, a Thorium burning reactor cannot reach criticality with full breeding requirements. Therefore, several embodiments of the present subject matter provide an addition of a fissile neutron source to provide the practical operability of Thorium related nuclear energy.

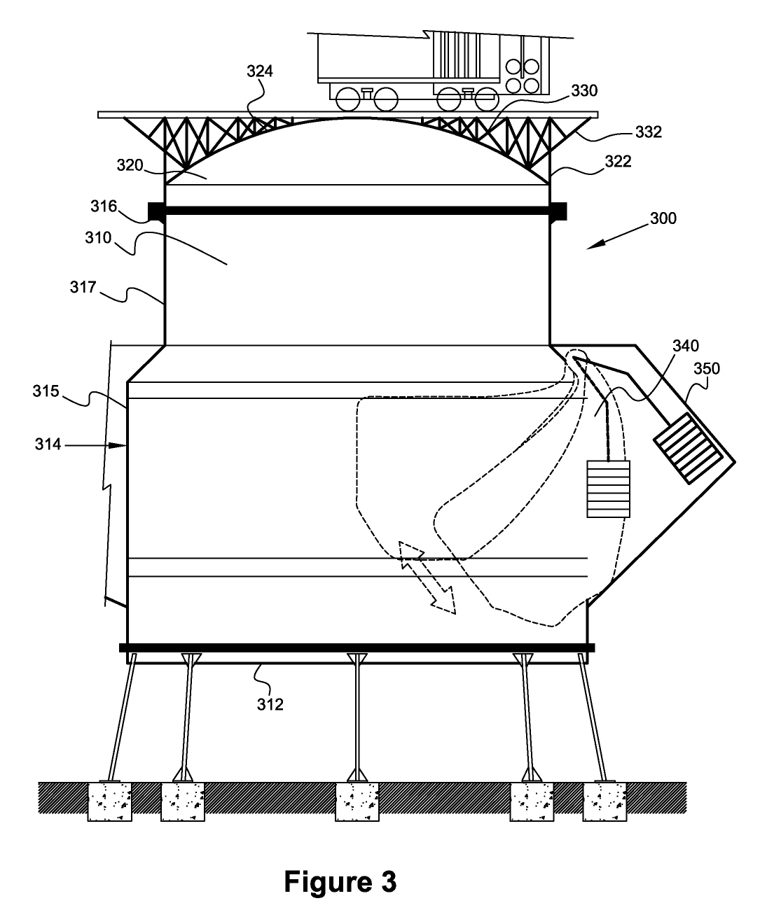

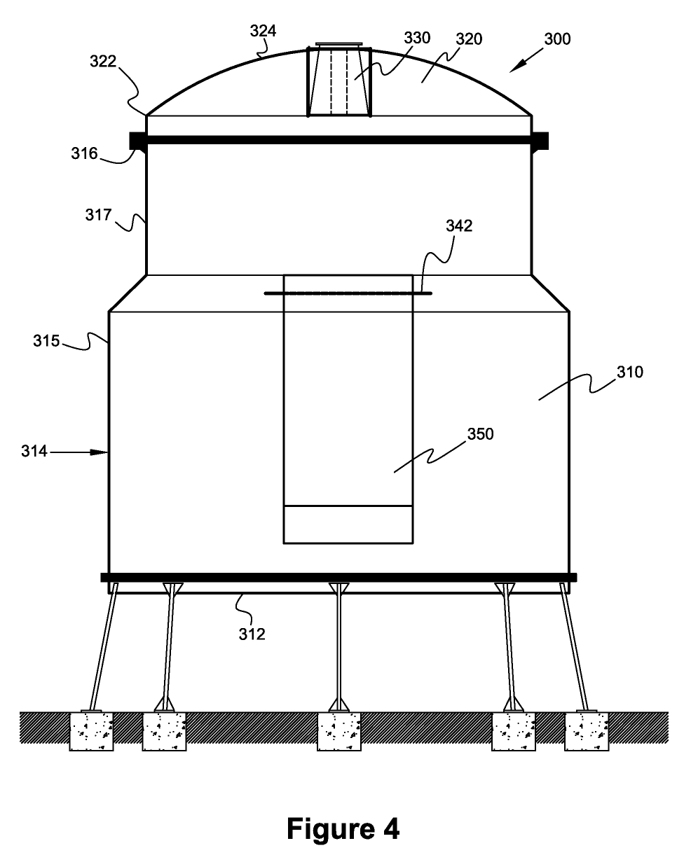

FIG. 3 is a side view of a pressure vessel according to an embodiment of the present subject matter. FIG. 4 is a side view of the pressure vessel of FIG. 3 rotated clockwise ninety degrees. With reference to FIGS. 3 and 4, an exemplary pressure vessel 300 for housing a nuclear reactor core is shown. The pressure vessel 300 may comprise a lower vessel 310 having an upwardly facing opening and a vessel closure head 320 with a sealable access port 330 extending along a radius thereof. The lower vessel 310 may have a generally planar horizontal lower deck 312 and a generally cylindrical wall 314 extending upwardly from the lower deck 312. The upper edge 316 of the wall 314 may thus form the generally circular upwardly facing opening. Of course, any shape or geometry of the lower vessel and respective opening is envisioned and the example provided above should not limit the scope of the claims appended herewith. In another embodiment of the present subject matter, the wall 314 may comprise a lower generally cylindrical portion 315 and an upper generally cylindrical portion 317 where the diameter of the upper portion 317 is smaller than the diameter of the lower portion 315. In this embodiment, the closure head 320 would be dimensioned to mate with the upper edge 316 of the upper portion 317. The upper portion 317 of the lower vessel 310 may also include a gamma attenuation and/or neutron moderation shielding area above a housed reactor core. Similarly, the lower portion 315 may also include a neutron moderating area at the bottom thereof.

In a further embodiment of the present subject matter, the lower vessel 310 may include one or more penetrations in a side wall thereof for insertion of one or more neutron absorbers 340, such as, but not limited to, reactor control bars, rods, blades, and the like into a nuclear reactor core housed in the pressure vessel 300. The pressure vessel 300 may also include one or more housings 350 extending outwardly from the wall 314 and forming an airtight cover over the one or more penetrations. In one embodiment, any number of penetrations may be provided in the wall of the lower vessel such as, for example, a pair of penetrations situated on opposing portions of the wall. Another embodiment may provide three penetrations on one wall and three penetrations on the opposing wall. Exemplary housings 350 would receive any reactor control blade 340 or neutron absorber that is retracted from the interior of the lower vessel 310 through the penetrations. In one embodiment, exemplary reactor control blades 340 may be rotated about an axle 342 and laterally inserted into the lower vessel 310. While not shown, the lower vessel 310 may also include a plurality of cooling pipes in the walls thereof to remove heat from the lower vessel 310 generated by the housed nuclear core.

The vessel closure head 320 may be generally supported by the lower vessel 310 and form an airtight closure of the opening. The vessel closure head 320 may possess a generally cylindrical lower portion 322 and a curved upper portion 324. Further, the lower portion 322 may mate with the upper edge 316 of the wall 314 of the lower vessel 310 to form the airtight closure. This upper portion 324 may provide the sealable access port 330 extending along a radius thereof. In one embodiment of the present subject matter, the vessel closure head 320 may be positioned or rotated in a horizontal plane about its respective central axis in differing positions so that different portions of the interior of the pressure vessel 300 may be accessed through the access port 330 without removing the closure head 320. Of course, any shape or geometry of the closure head and respective opening is envisioned and such an example should not limit the scope of the claims appended herewith. Generally, the geometry of the lower vessel 310 and closure head 320 may substantially correspond, e.g., have the same diameter, to ensure a proper seal therebetween. For example, the closure head 320 may include a circular cross-section whereby the sealable access port 330 extends from a central portion thereof along a radius toward the periphery of the closure head 320. Further, the closure head 320 may generally be torispherical. An exemplary closure head according to one embodiment of the present subject matter may include no penetrations for reactor control rod drive mechanisms; rather, the access port 330 forms the only penetration through the closure head 320. Generally, the reactor design should be in compliance with ASME standards and different vessel thicknesses, internal pressures and temperatures are envisioned for embodiments of the present subject matter.

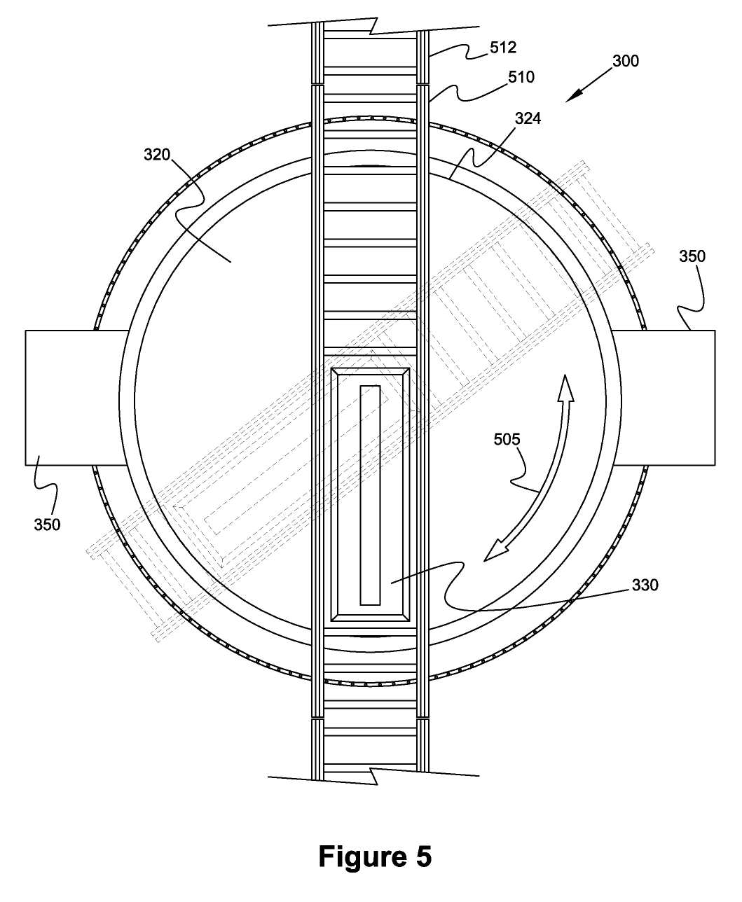

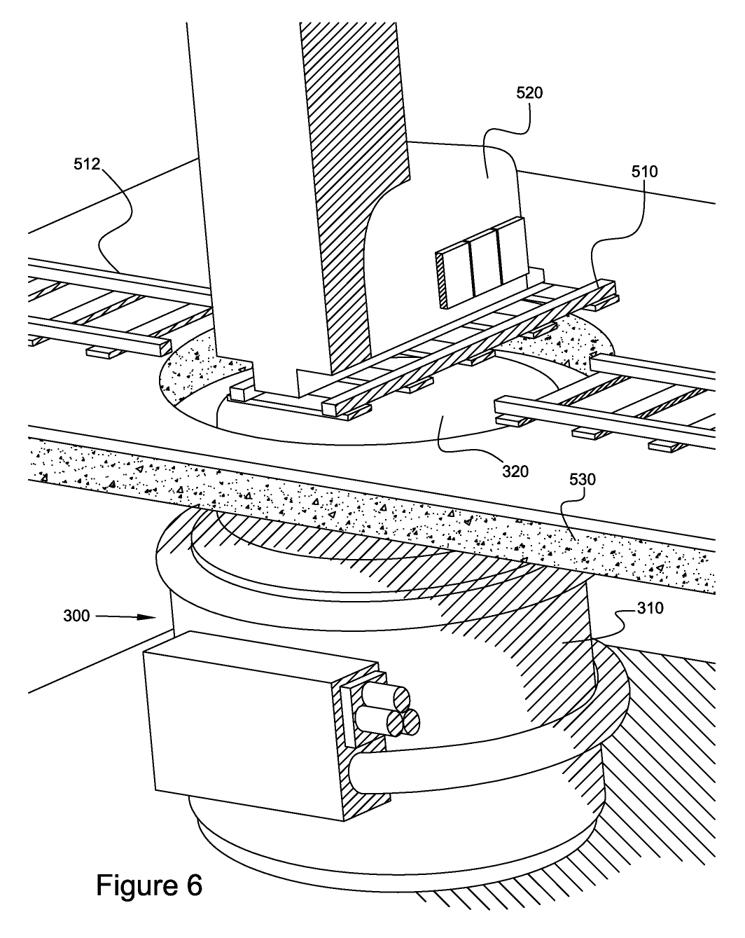

FIG. 5 is a top plan view and FIG. 6 is a perspective view of a pressure vessel according to an embodiment of the present subject matter. With reference to FIGS. 5 and 6, the pressure vessel closure head 320 may include a vehicle guide 510 affixed to an upper portion of the closure head 320 that extends along a radius thereof. In other embodiments of the present subject matter having different geometrical pressure vessel designs, the vehicle guide 510 would extend along another comparable dimension.

In one embodiment, the vehicle guide 510 may be rail tracks adapted to accept a crane 520, rail car, or other vehicle. The sealable access port 330 may be preferably aligned upon or extend along the vehicle guide 510; however, it is envisioned that the access port 330 or multiple access ports may be positioned at various locations in or on the closure head 320 and not necessarily along or aligned with the vehicle guide 510. Stationary vehicle guides 512 may also be located in the vicinity of the pressure vessel 300 but not attached to the closure head 320 thereof. These guides 512 allow the crane 520 to proceed to a different portion of a respective compound or building to retrieve reactor components, fuel arrays, and the like.

The vessel closure head 320 may also be positioned or rotated 505 in a horizontal plane about its respective central axis in differing positions so that different portions of the interior of the pressure vessel 300 may be accessed through the access port 330 via the crane 520 or other vehicle without removing the closure head 320. For example, the closure head may be rotatable by at least 180 degrees clockwise and counterclockwise 505; and, with movement of the crane 520 along the vehicle guide 510, plural portions of a housed reactor core may be accessed. The vehicle guide 510 may be affixed to the closure head by any means common in the industry. For example, in embodiments of the present subject matter having a torispherical or other dome-shaped closure head, the vehicle guide 510 may be affixed thereto by a truss 332 so that the vehicle guide 510 is generally planar. Thus, the vehicle guide 510 may be substantially horizontal and extends from across the width of the closure head 320 along a diameter or dimension thereof. In one embodiment, the pressure vessel 300 may be situated below ground or below a horizontal plane 530 having the stationary vehicle guides 512 thereon.

While not illustrated, a pressure vessel closure head according to another embodiment of the present subject matter may be substantially rectangular in shape and may include a vehicle guide affixed to an upper portion of the closure head and extending along an upper horizontal surface of the closure head. In this embodiment, the sealable access port may be partially or substantially aligned upon or extend along the vehicle guide. The vessel closure head may be adaptable to be positioned or moved along a horizontal plane parallel to a plane defined by the vehicle guide in differing positions so that different portions of the interior of the pressure vessel may be accessed through the access port via a crane or other vehicle without removing the closure head. For example, the closure head may be moved by predetermined distances forward or backward along the horizontal plane; and, with movement of the crane along the vehicle guide, plural portions of a housed reactor core may be accessed.

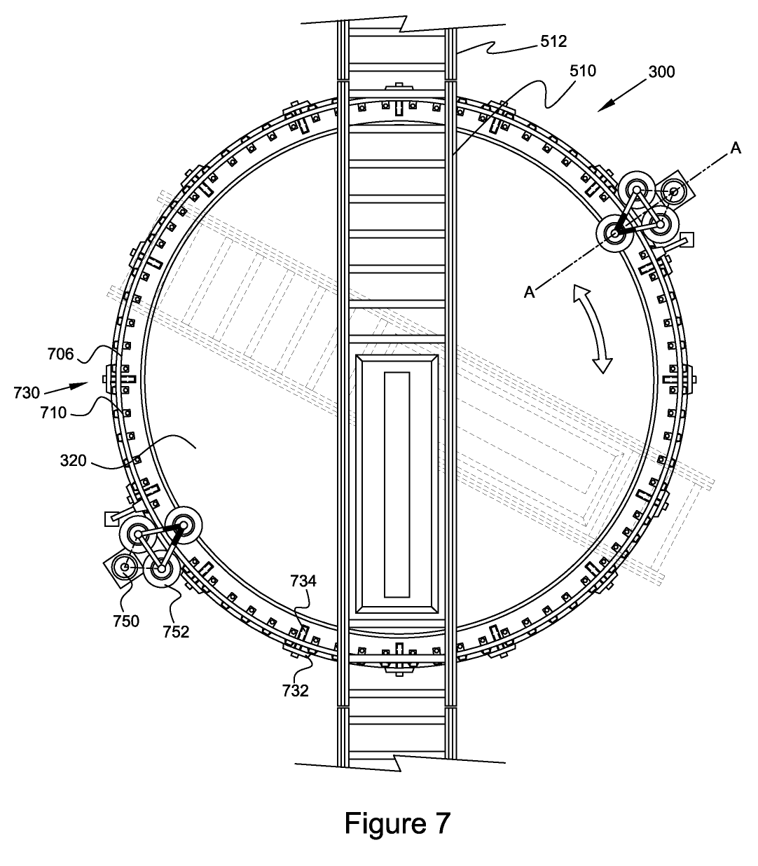

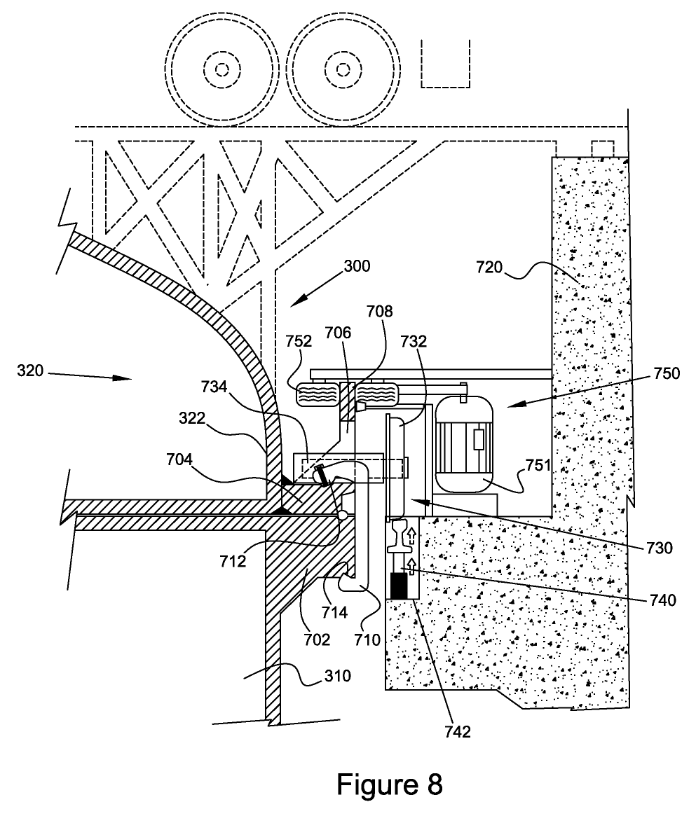

FIG. 7 is a top plan view of a pressure vessel according to another embodiment of the present subject matter. FIG. 8 is a portion of a cross section of the pressure vessel of FIG. 7 along line A-A. With reference to FIGS. 7 and 8, an exemplary pressure vessel 300 is shown having a lower vessel 310 and vessel closure head 320. The lower vessel 310 may include a generally cylindrical upper wall having a circumferential laterally extending rim 702 defining an upwardly facing mating surface. The vessel closure head 320 may include a generally cylindrical lower portion 322 having a circumferential laterally extending rim 704 defining a downwardly facing mating surface and a circumferential vertically extending rim 706. The circumferential vertically extending rim 706 may also include a geared surface 708. Plural removable clamps 710 may be spaced around the periphery of the circumferential laterally extending rims 702, 704. Each of the clamps 710 may include an upper engaging surface 712 for engaging an upper surface of the laterally extending rim 704 of the closure head 320 and a lower engaging surface 714 for engaging a lower surface of the laterally extending rim 702 of the lower vessel 310.

One embodiment of the present subject matter may include a rigid support structure 720 laterally surrounding the upper portion of the lower vessel 310 and the lower portion of the closure head 320. The rigid support structure 720 may be the ground or a portion of a support facility or building. Plural jack rollers 730 may be attached to the closure head 320 and include a vertically oriented disc 732 having an axle 734. Any number of jack rollers 730 may be spaced around the circumference of the closure head 320 and the number of jack rollers depicted in the figures should not limit the scope of the claims appended herewith. Exemplary jack rollers may include a vertically oriented disc having an axle. One or more jacks 740 or similar mechanisms may be positioned or spaced around an inner portion of the rigid support structure 720. Each of the jacks 740 may be appropriately positioned to engage the disc 732 of a jack roller 730 to thereby elevate the closure head when the jacks 740 are extended. The elevation of the closure head may be approximately, for example, one-quarter of an inch or more to allow rotation thereof. An exemplary jack 740 may be, but is not limited to, a rail that continuously or substantially continuously extends along an inner portion 742 of the rigid support structure 720. In embodiments of the present subject matter having a plurality of jacks 740 rather than a single jack or rail, movement of the plural jacks 740 may be simultaneous to thereby lift the closure head in a single movement.

Additionally, one or more driving mechanisms 750 may also be supported by the rigid support structure 720. During operation, these driving mechanisms 750 may engage the geared surface 708 of the upwardly extending rim 706 of the closure head 320 via any number of gears or rollers 752 to thereby rotate the closure head 320 when the closure head 320 is elevated by the jacks 740. An exemplary driving mechanism 750 may be, but is not limited to, a motor 751 adaptable to drive or rotate plural gears or rollers 752. The motor 751 may be operably connected to any one or plural rollers via a chain, belt or other apparatus such that the motor may drive respective rollers 752 to rotate about its respective axis to thereby effect a rotation of the closure head 320 when the closure head 320 is elevated by the jacks 740.

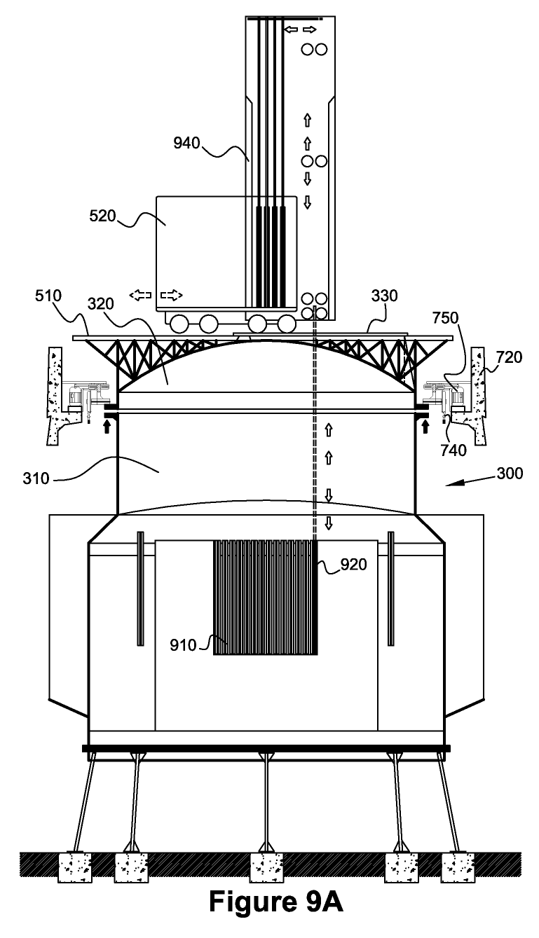

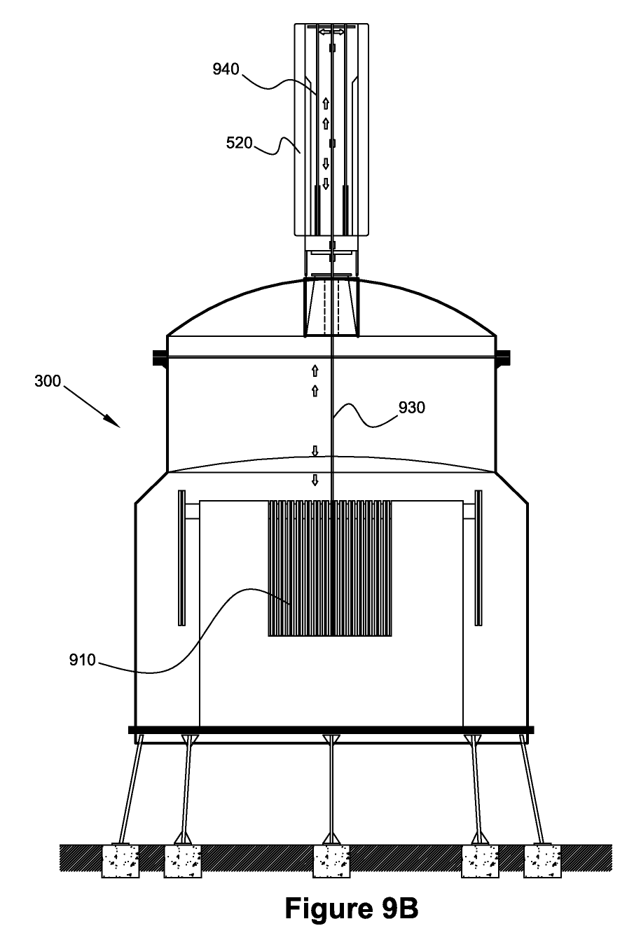

FIGS. 9A and 9B are side views of a pressure vessel according to an embodiment of the present subject matter. With reference to FIGS. 9A and 9B, a system and method is illustrated for allowing access to fuel cells in a nuclear reactor core 910 having a fuel cell array housed within a reactor pressure vessel 300. The method may include housing the reactor core 910 in a pressure vessel 300 having a lower vessel 310 with an upper cylindrical wall and a closure head 320 supported by the wall, the closure head 320 having an access port 330 extending along a radius thereof. A vehicle guide 510 may be affixed to the upper surface of the closure head 320 along the radius so that a vehicle 520 supporting a crane may be positioned above the access port 330. The closure head 320 may be rotated relative to the lower vessel so that the crane may be positioned above a selected cell 920 in the fuel cell array. The rotation of the closure head may be clockwise or counterclockwise, 180 degrees or more, depending upon the location of the selected cell 920. In one embodiment, the access port 330 may be opened and a portion of the fuel from the selected cell removed 930. The closure head 320 may then be rotated again relative to the lower vessel 310 so that the crane is positioned above a second selected cell in the fuel cell array. The removed portion of fuel may then be installed into the second selected cell. The second selected cell may be in a different portion of the reactor core 910 or may be in a different portion of the pressure vessel 300 such as a burner region or the like. The access port 330 may then be closed upon completion of the fuel removal/installation procedure. Of course, the removed portion of fuel may be temporarily stored in a shielded compartment 940 of the crane and/or moved to a shielded compartment external and adjacent the crane.

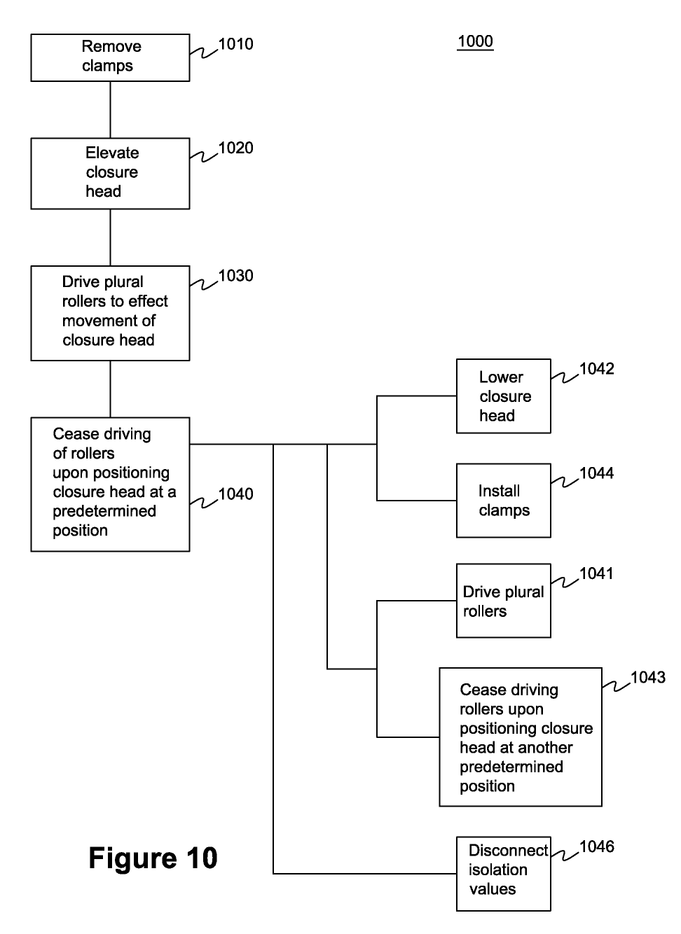

FIG. 10 is a block diagram representing a method according to one embodiment of the present subject matter. With reference to FIG. 10, a method is provided for positioning a reactor vessel closure head 1000 having a lower surface mated on an upper surface of a lower vessel from a first position maintained by a plurality of clamps spaced about the periphery of the closure head to a second position. At step 1010, the clamps may be removed from the periphery of the closure head, and at step 1020, the closure head then elevated so that the lower surface of the closure head is spaced from the upper surface of the lower vessel. At step 1030, a plurality of rollers may be driven, each of the rollers having a surface in frictional contact with a surface of the closure head. Thus, through rotation of the rollers, movement and rotation of the closure head about a vertical axis may be effected. The rotation of the closure head may be clockwise or counterclockwise any number of degrees. At step 1040, the driving of the rollers may be ceased when the closure head has rotated to the second position. In one embodiment, the closure head may then be lowered so that the lower surface of the closure head is mated with the upper surface of the lower vessel at step 1042. The clamps may then be installed about the periphery of the closure head at step 1044.

In another embodiment, the method may further include driving the plurality of rollers to again rotate the closure head about the vertical axis at step 1041 and ceasing the driving of the rollers when the closure head has rotated to a third position at step 1043. This third position may be the same position as the first position or may be a different position. The method may also comprise the step of disconnecting one or more isolation valves configured to provide a cooling media to the closure head at step 1046.

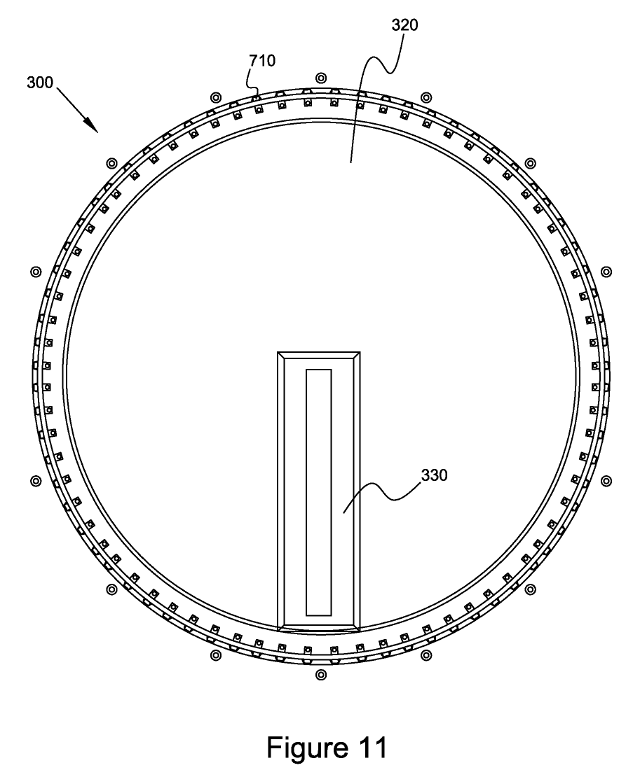

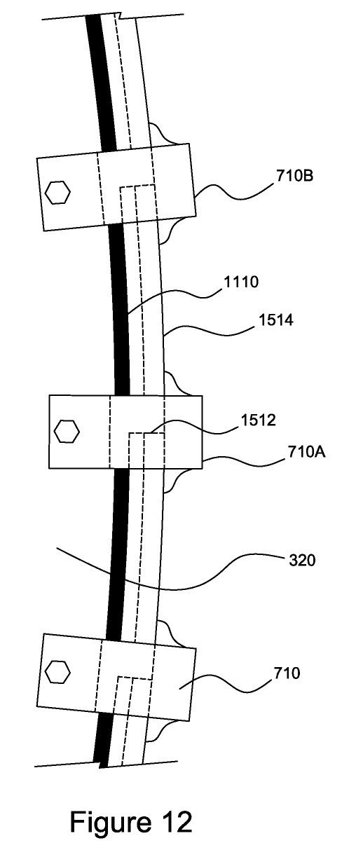

FIG. 11 is a top plan view of a closure head according to one embodiment of the present subject matter. FIG. 12 is a top plan view of a segment of a sealing system according to an embodiment of the present subject matter. With reference to FIGS. 11 and 12, an exemplary pressure vessel 300 having a lower vessel 310 and a vessel closure head 320 being supported by the lower vessel may form an airtight closure without threaded bolts or welds affixing the closure head 320 to the lower vessel 310. For example, conventional nuclear reactors provide large threaded bolts and/or welds that are generally utilized to penetrate mating portions or surfaces of a closure head and lower vessel to hold the closure head and lower vessel tightly together and maintain containment thereof. In embodiments of the present subject matter, however, the airtight closure may be maintained by an inflatable and/or flexible seal 1110 positioned between mating surfaces of the lower vessel 310 and vessel closure head 320 when the interior of the pressure vessel contains a pressure greater than a predetermined pressure, e.g., 100 psi. Of course, the vessel closure head 320 may be positionable in differing positions relative to the lower vessel 310 so that portions of the interior of the pressure vessel 310 may be accessed through an access port 330 on the closure head 320.

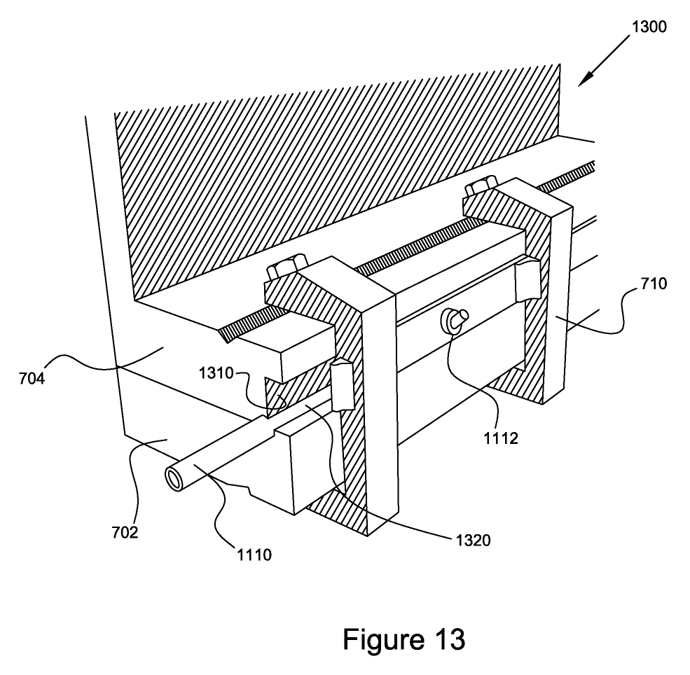

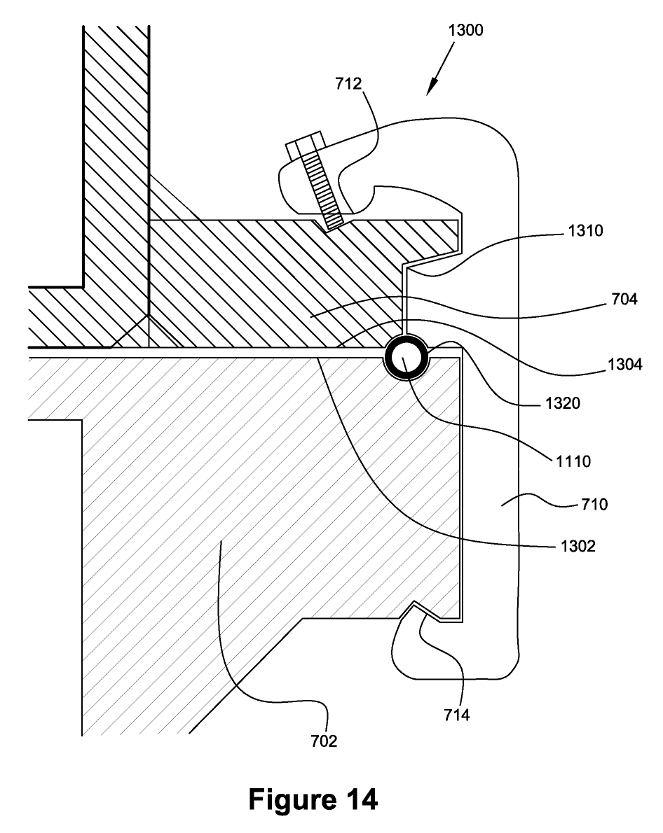

FIG. 13 is an enlarged view of a sealing system according to an embodiment of the present subject matter. FIG. 14 is a cross-sectional view of a clamp in a sealed position according to an embodiment of the present subject matter. With reference to FIGS. 13 and 14, a system 1300 for sealing a nuclear reactor pressure vessel is illustrated. The system 1300 may comprise a lower vessel having a generally cylindrical upper wall having a circumferential laterally extending rim 702 defining an upwardly facing mating surface 1302, a vessel closure head having a generally cylindrical lower portion with a circumferential laterally extending rim 704 defining a downwardly facing mating surface 1304, a circumferential vertically extending rim (not shown) having a geared surface, and a circumferential laterally facing channel 1310. An inflatable and/or flexible seal 1110 may be positioned between the upwardly and downwardly facing mating surfaces 1302, 1304 whereby a portion 1320 of the seal 1110 is accessible via the channel 1310. In one embodiment, the seal 1110 may include an access valve 1112 accessible via the channel 1310. The seal 1110 may be inflated to a predetermined pressure. Plural removable clamps 710 may be spaced around the periphery of the circumferential laterally extending rims 702, 704. Any number of clamps 710 may be utilized in embodiments of the present subject matter; however, it should be noted that the greater the number of clamps, the lower the responsible pressure for each clamp.

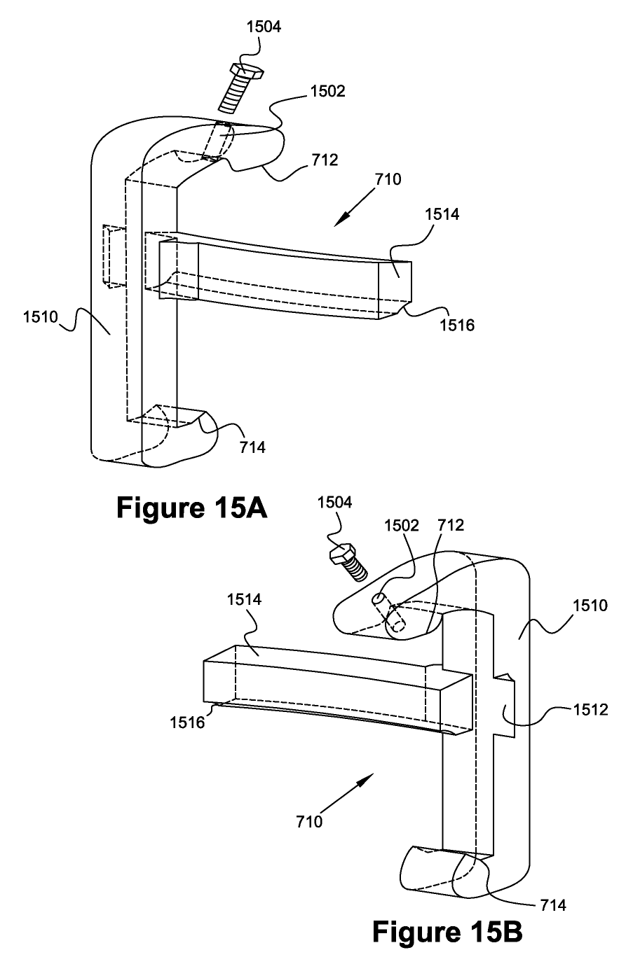

FIGS. 15A and 15B are perspective views of a clamp according to an embodiment of the present subject matter. With reference to FIGS. 15A and 15B and continued reference to FIG. 12, an exemplary device, such as a clamp 710, may be utilized for sealing a nuclear reactor pressure vessel having a lower vessel supporting a vessel closure head. In one embodiment, the clamp 710 may be substantially C-shaped, however, such a form is exemplary only and should not limit the scope of the claims appended herewith as other forms are equally envisioned for sealing pressure vessels according to embodiments of the present subject matter. For example, the clamp 710 may include an upper clamping arm 712 for engaging an upper surface of the laterally extending rim 704 of the closure head 320 and a lower clamping arm 714 for engaging a lower surface of the laterally extending rim 702 of the lower vessel 310. In one embodiment, the upper clamping arm 712 may be substantially more elongated than the lower clamping arm 714. The upper clamping arm 712 may further include a hole 1502 therethrough that is adaptable to accept a fastener 1504 for securing the upper clamping arm 712 to the upper surface of the laterally extending rim 704 of the closure head 320. In one embodiment, the hole 1502 and fastener 1504 may be threaded.

The clamp 710 may include a vertically extending portion 1510 connecting the upper and lower clamping arms 712, 714. The vertically extending portion 1510 may include a recess 1512 on one lateral side and an interlocking portion or extension 1514 on an opposing side thereof laterally extending from one side of the clamp 710. The interlocking portion 1514 of one clamp 710A may extend from approximately the midsection of the vertically extending portion 1510 to a recess on a facing lateral side of an adjacent clamp 710B. In one embodiment, the interlocking portion 1514 may further include an arcuate or curved surface 1516. The arcuate surface 1516 may extend from a lower surface of the interlocking portion 1514 that engages an upper surface of the laterally extending rim of the lower vessel to a vertical surface of the interlocking portion 1514 that engages a vertical surface of the laterally extending rim of the vessel closure head. The arcuate surface 1516 may also engage with a portion of and accommodate the inflatable or flexible seal 1110. Therefore, certain embodiments of the present subject matter may install an exemplary seal 1110 in a circumferential substantially cylindrical groove formed by the arcuate surface 1516 of the interlocking portions 1514 of one or more clamps 710 and the mating of the lower surface 1304 of the vessel closure head and the upper surface 1302 of the lower vessel. In one embodiment, any one or plural clamps 710 may include an access port (not shown) providing access to an access valve 1112 of the inflatable seal 1110. Clamps 710 may be adaptable for automatic or manual installation on the laterally extending rims 702, 704. For example, a mechanism may be installed that automatically removes or loosens the fasteners 1504 of one or plural clamps 710 in any order, or each of the fasteners 1504 may be manually removed or loosened by an operator.

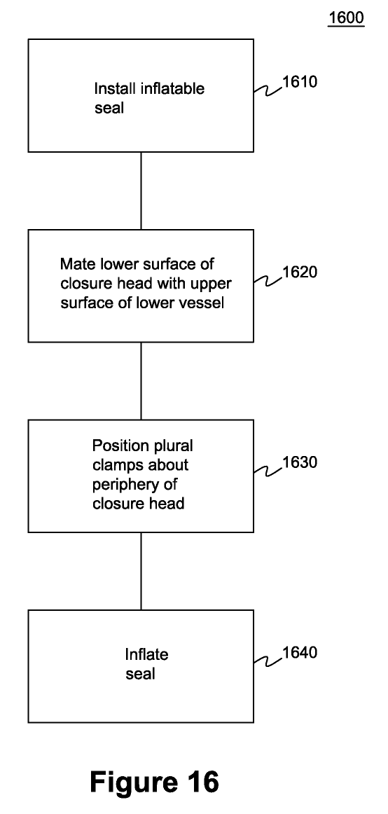

FIG. 16 is a block diagram representing a method according to one embodiment of the present subject matter. With reference to FIG. 16, a method 1600 is provided for sealing a reactor pressure vessel having a vessel closure head with a lower surface adaptable to mate with an upper surface of a lower vessel. The method may include, at step 1610, installing an inflatable seal between the lower surface of the vessel closure head and the upper-surface of the lower vessel. The inflatable seal may be installed in a circumferential substantially cylindrical groove formed by a portion of the plural clamps and the mating of the lower surface of the vessel closure head and the upper surface of the lower vessel. The lower surface of the closure head may then be mated with the upper surface of the lower vessel at step 1620 and a plurality of clamps positioned about the periphery of the closure head at step 1630. The inflatable seal may then be inflated at step 1640 thereby sealing the pressure vessel. The seal may be inflated by a gas or liquid. In one embodiment, each of the clamps may include an upper engaging portion for engaging an upper surface of a laterally extending rim of the vessel closure head, a lower engaging portion for engaging a lower surface of a laterally extending rim of the lower vessel, an elongated portion connecting the upper and lower engaging portions. The elongated portion of the clamp may also include a notch on one lateral side and a horizontal extension on an opposing lateral side extending from approximately the midsection of the elongated portion to a notch on a facing lateral side of an adjacent clamp. In one embodiment, the positioning of the plural clamps may include securing the upper engaging surface of one or more clamps to the upper surface of the closure head via a fastener. Of course, this securing may be conducted manually or automatically. In another embodiment of the present subject matter, the step of mating the lower surface may further include driving a plurality of rollers each having a surface in frictional contact with a surface of the closure head to thereby rotate the closure head about a vertical axis, ceasing the driving of the rollers when the closure head has rotated to a predetermined position, and lowering the closure head so that the lower surface of the closure head is mated with the upper surface of the lower vessel.

Similar to conventional nuclear reactors, embodiments of the present subject matter employ certain provisions to accommodate power-level changes and to compensate for fuel depletion and related effects. Conventional nuclear reactor designs rely upon the following common neutron-balance controls: (i) production, e.g., adjusting the amount of fissile material in the active core region; (ii) absorption, e.g., control rods, soluble poisons, and burnable poisons; and (iii) leakage, e.g., changing system dimensions and density or modifying the effectiveness of neutron reflection. Conventional reactors may also include any number of the following integrated reactivity-control features: (i) control rods with limited drive speeds and limited individual reactivity worths; (ii) control system producing scrams or full/partial rod insertions for overpower or excess periods; and (iii) negative temperature feedbacks to mitigate the consequences of unintentional large reactivity insertions.

Reactor control rods are generally utilized to change power level, provide for shutdown when safety limits are exceeded, and compensate for long-term reactivity changes. For example, conventional reactor control rods are gradually withdrawn as fuel burn, transmutation, and fission-product effects reduce the capability of the core to maintain a neutron chain reaction. Reactor control rods may also be utilized to compensate for the start-up and operational reactivity effects of xenon and samarium.

To control neutron density throughout the entire core, conventional nuclear reactors generally insert neutron absorbing devices, such as control rods, vertically between or among Uranium fuel cells or arrays. This vertical insertion requires a highly-complex ball bushing mechanism, commonly referred to as control rod drive mechanisms (“CRDM”). CRDMs are generally kept at a distance from the actual rods they control so that a rod that has been in contaminated water will not contact the lubrication of the bushing. Precision guidance for control rods carries a number of disadvantages, and extreme precision and numerous back-up systems are necessary to ensure the proper lubrication and functioning of conventional control rod drive system. Notable disadvantages include: (i) the rod and ball-bushing system that allows precise insertion and retrieval of the rod into the reactor core; (ii) the size, together with the space required for CRDM storage in a reactor thus requiring multi-story reactors; (iii) the necessary height of the reactor prevents underground building; and (iv) the access above-ground to the control rod assembly makes conventional systems susceptible to externally imposed damage.

Embodiments of the present subject matter eliminate the hazards and complexities of conventional control rod drive systems by absorbing neutrons from the periphery to control reactivity. Without vertically-inserted control rods, the height of an exemplary nuclear reactor is reduced and the pressure vessel has no penetrations in the vessel closure head. Further, without a complex ball-bushing reliant control rod drive system, the numerous back-up protections in conventional reactors are unnecessary.

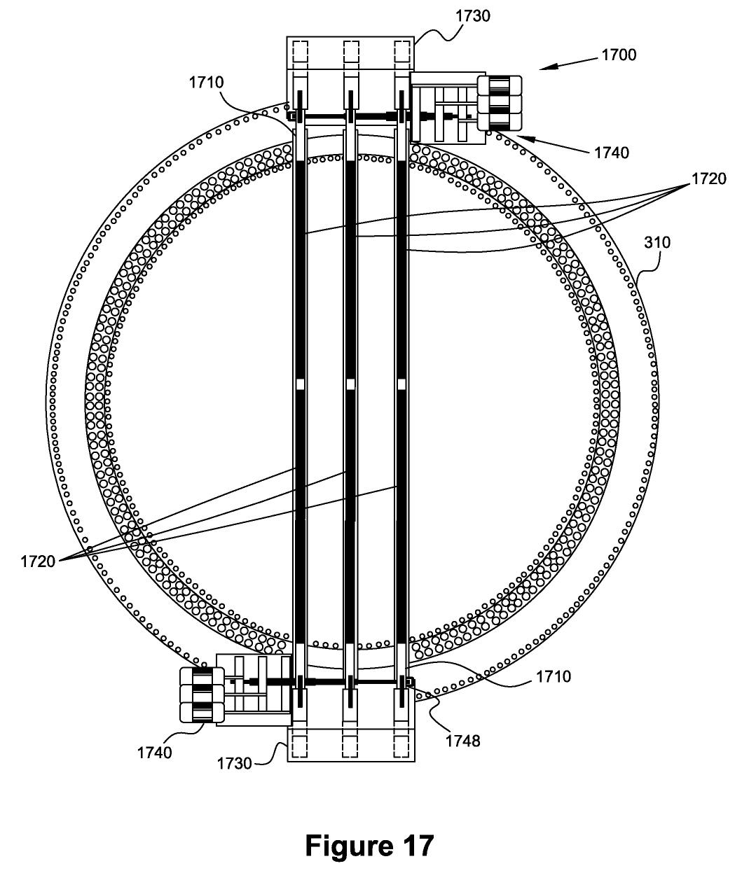

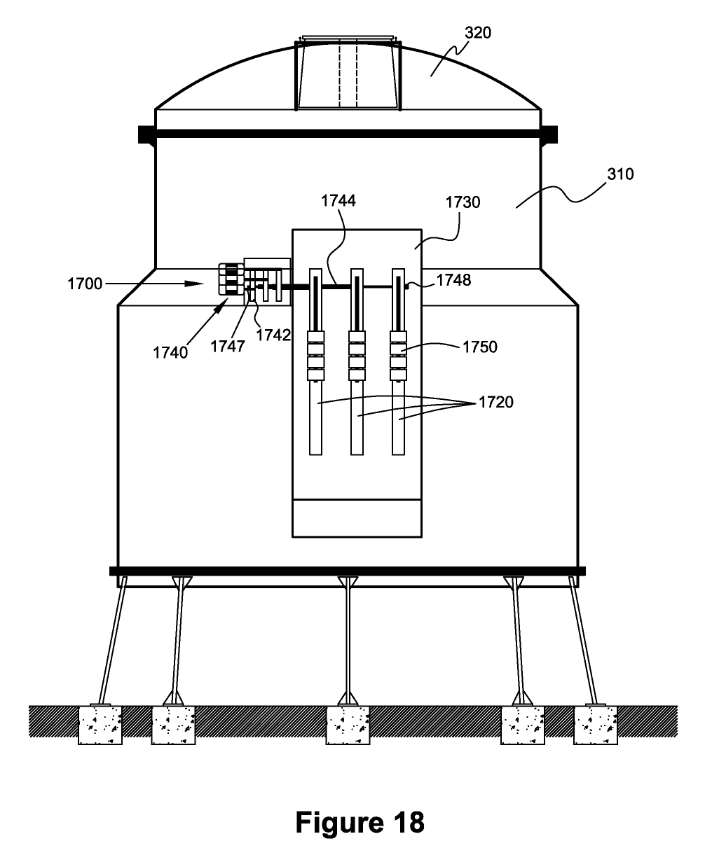

FIG. 17 is a horizontal cross section of a lower vessel of a pressure vessel according to an embodiment of the present subject matter. FIG. 18 is a cross section of a pressure vessel protuberance that houses neutron absorbing devices according to an embodiment of the present subject matter. With reference to FIGS. 17 and 18, a system 1700 for controlling the reactivity of a nuclear reactor core is provided. As discussed above, an exemplary pressure vessel 300 may include a lower vessel 310 with a generally planar horizontal lower deck and a generally cylindrical wall extending upwardly from the lower deck, the upper edge of the wall may form a generally circular upwardly facing opening with a pressure vessel closure head 320 adaptable to mate thereto. The closure head 320 provides no penetrations for reactor control rod drive mechanisms. The system 1700 may include a plurality of penetrations 1710 in the generally cylindrical wall of the lower vessel 310 for lateral insertion of a plurality of neutron absorbing devices 1720 into the interior of the lower vessel 310. Exemplary neutron absorbing devices 1720 may be reactor control blades, rods, bars and the like. A housing 1730 may extend outwardly from the wall of the lower vessel and form an airtight cover over ones of the plural penetrations 1710. The housing 1730 may also be adaptable to receive one or more neutron absorbing devices 1720 when the devices are retracted from the interior of the lower vessel 310. Embodiments of the present subject matter may employ any number of penetrations 1710, and the depiction of two sets of three opposing penetrations should not limit the scope of the claims appended herewith. For example, it is envisioned that nuclear reactors according to embodiments of the present subject matter may be designed on several scales, smaller and/or larger; therefore, a lesser or greater number of neutron absorbing devices, and hence penetrations, may be utilized to control reactivity in exemplary reactor cores.

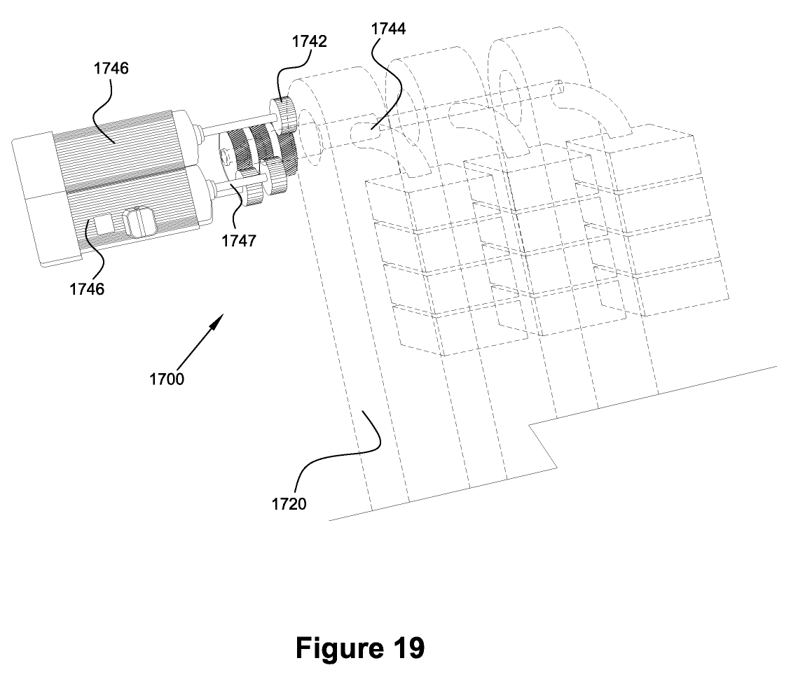

FIG. 19 is a perspective view of a neutron absorber actuator assembly according to an embodiment of the present subject matter. With reference to FIG. 19, embodiments of the present subject matter may employ one or more actuator or driving mechanisms 1740 to control the operation of one or plural neutron absorbing devices 1720. An exemplary driving mechanism 1740 may include, but is not limited to, a plurality of rollers, discs or gears 1742 each having a geared surface positioned to engage a geared surface of a rotatable axle 1744. The rotatable axle 1744 may be connected to one or more neutron absorbing devices 1720. A motor 1746 may be operably connected to any one or plural discs 1742 via a geared surface and/or a drive shaft 1747 to drive each disc 1742 about its respective axis 1748. The motion of a respective disc 1742 may thus effect the retraction or insertion of one or more neutron absorbing devices 1720. For example, in embodiments of the present subject matter employing reactor control blades as the neutron absorbing devices 1720, movement of one or more discs 1742 effects a clockwise or counter-clockwise movement of a respective reactor control blade about the rotatable axle 1744, depending upon the location of the blade with regard to the lower vessel 310 and the method of operation (insertion or retraction). Thus, any one or several of the neutron absorbing devices 1720 may be rotated into the respective reactor core about an axis substantially perpendicular to the respective vertical fuel cell axes.

In one embodiment of the present subject matter, each driving mechanism 1740 and thus neutron absorbing device 1720 may be independently operable and/or controllable. Of course, an operator may control and operate each motor and/or driving mechanism simultaneously. It is also envisioned that embodiments of the present subject matter may control reactivity in different portions of the reactor core by altering the position of any single or combination of neutron absorbing devices 1720. The lateral insertion of each neutron absorbing device 1720 may also be effected by gravity alone and counter weights 1750 are provided for this purpose. In certain embodiments of the present subject matter, the position of each of the plural neutron absorbing devices 1720 may be a function of the core life and/or poison loading of the reactor core.

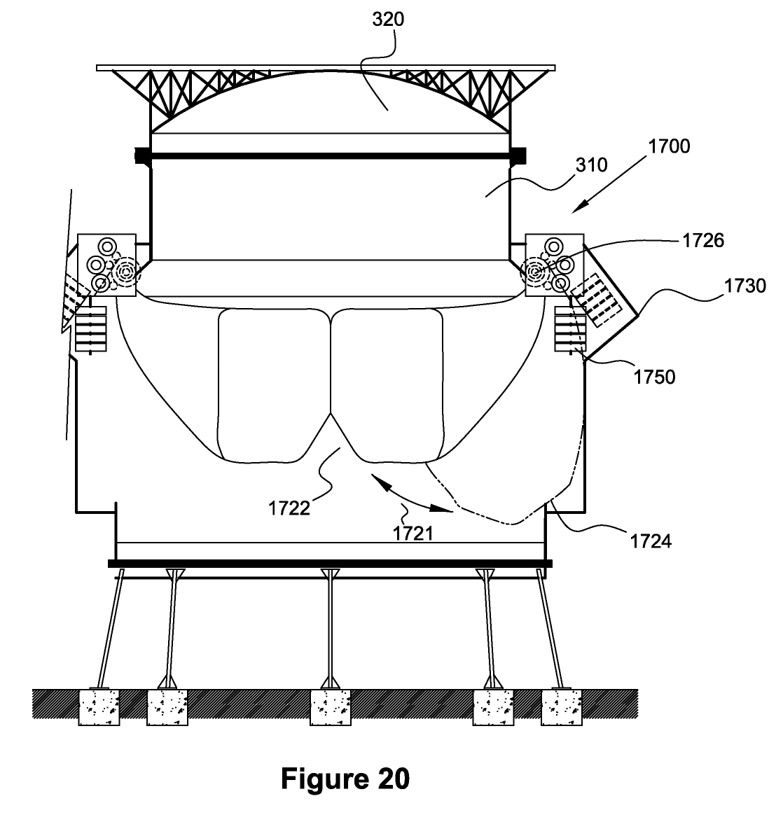

FIG. 20 is a vertical cross section of a lower vessel of a pressure vessel according to an embodiment of the present subject matter. With reference to FIG. 20, the movement of a neutron absorbing device 1720 according to an embodiment of the present subject matter may be in an arc 1721 from full insertion 1722 to full retraction 1724 and may have a centroid or axis 1726 of rotation substantially external to the reactor core. The range of the arc 1721 may generally be less than ninety degrees. In embodiments of the present subject matter employing plural neutron absorbing devices, adjacent control devices may move in parallel planes, and opposing neutron absorbing devices may move in substantially the same plane but in opposite directions having substantially tangential arcs. It is also envisioned that neutron absorbing devices may be laterally inserted or retracted from different quadrants of the lower vessel and/or perpendicular directions, and the above examples of opposing and adjacent neutron absorbing devices should not limit the scope of the claims appended herewith.

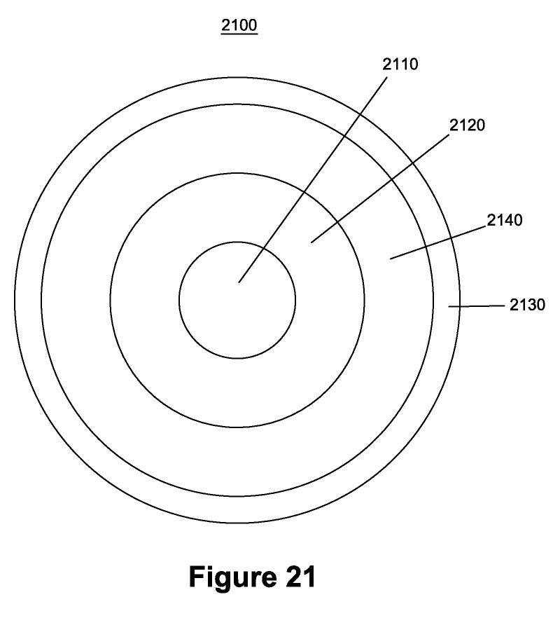

While reference to the reactor core has been made as being a Thorium-based breeder/burner reactor, the pressure vessel and supporting components are equally applicable to other types of reactors. FIG. 21 is a schematic diagram illustrating different regions of a reactor core 2100 according to one embodiment of the present subject matter. With reference to FIG. 21, one region of an exemplary reactor core 2100 is the driver region 2110 which maintains a controlled nuclear reaction to release heat and neutrons. Surrounding fuel assemblies in a breeder region 2120 may be breeder assemblies, where most of the neutrons escaping the driver region 2110 are captured in Thorium to breed U²³³ fuel. The reactor core 2100 may utilize a thermal, epithermal and/or fast neutron energy spectrum to maximize fuel breeding therein. Over the operation of the reactor core 2100, neutron-absorbing fission products may build up in the driver region 2110 as U²³³ accumulates in the breeder region 2120. Periodically, the most depleted driver nuclear fuel material may be moved to a distal burner region 2130 and replaced by the most active fuel from the breeder region 2120. Additional Thorium (ThO₂) fuel may be added to the breeder region 2120 to continue the cycle. The depleted fuel moved to the burner region 2130 will absorb neutrons escaping the driver and breeder regions after traversing a substantially thick moderator region 2140 and being substantially thermalized. These thermal neutrons provide a larger actinide reaction cross-section, and subsequently destroy most of the long-lived isotopes that generally make disposal difficult and expensive for conventional nuclear waste. In embodiments of the present subject matter where the respective reactor is decommissioned, breeder and driver fuel assemblies may then be transferred to a new reactor core and utilized in a similar fashion as explained above.

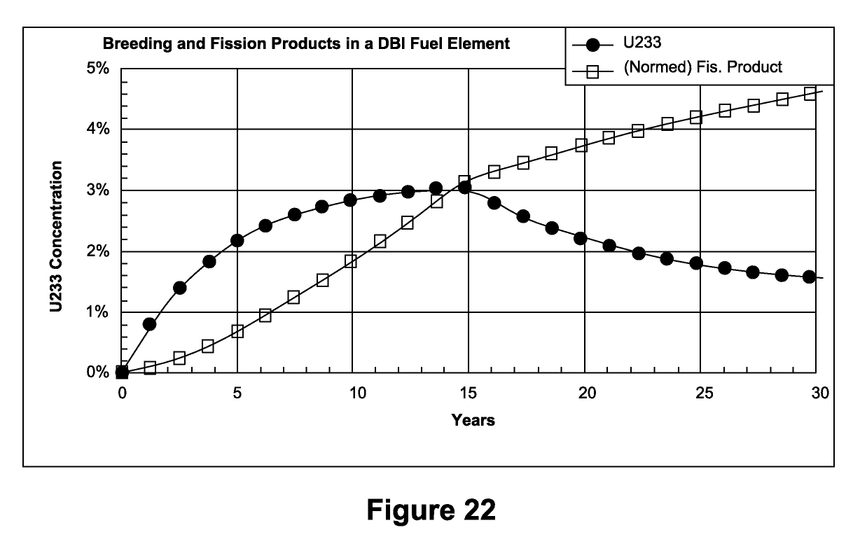

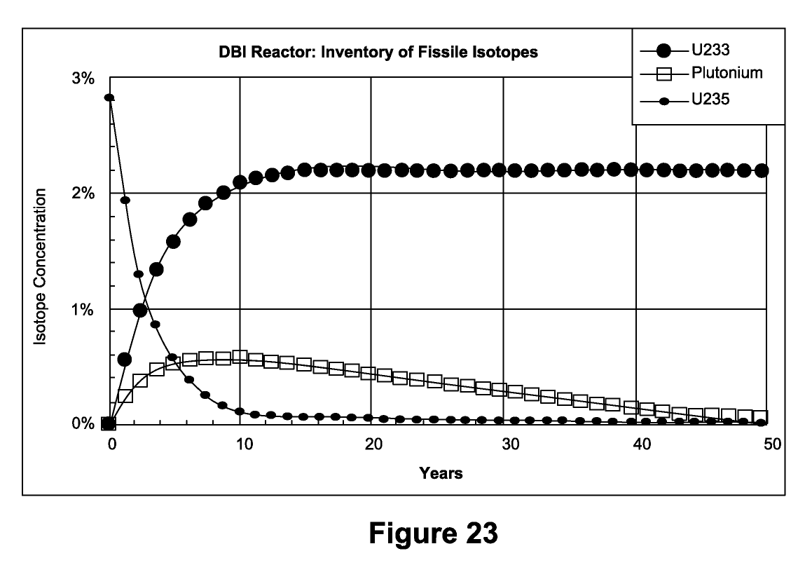

FIG. 22 is a graph showing U²³³ concentration in a fertile nuclear fuel element according to one embodiment of the present subject matter. With reference to FIG. 22, a typical thorium oxide fuel element may generally follow the history shown therein. Approximately nine years of irradiation in an exemplary reactor core neutron flux would generally produce a concentration of U²³³ in the fertile nuclear fuel to provide useful reactivity for the reactor core. Initially, U²³³ accumulates more rapidly than neutron-absorbing fission products because the breeding of U²³³ is proportional to the concentration of Thorium in the fuel while the accumulation of fission products is proportional to the U²³³ concentration, initially zero. In this embodiment, it is possible to run a Thorium breeder reactor without reprocessing a Thorium blanket. In the region spanned by years 9-15, the net contribution of the fertile nuclear fuel to the reactivity and breed ratio of the reactor core is positive, that is, the fertile fuel provides more than two neutrons on average to the core for every two neutrons it consumes in U²³³ fission, Th²³² breeding, and capture losses. After year 15, accumulating fission products absorb enough neutrons that the fertile fuel element no longer performs well in the driver region of an exemplary reactor core. The respective nuclear fuel element would then be moved to the burner region and its respective U²³³ concentration would be reduced over time by exposure to thermal neutrons. While the fuel concentration in a single exemplary nuclear fuel element may evolve as shown in FIG. 22, nuclear fuel inventory of an exemplary reactor core may generally follow the history illustrated in FIG. 23.

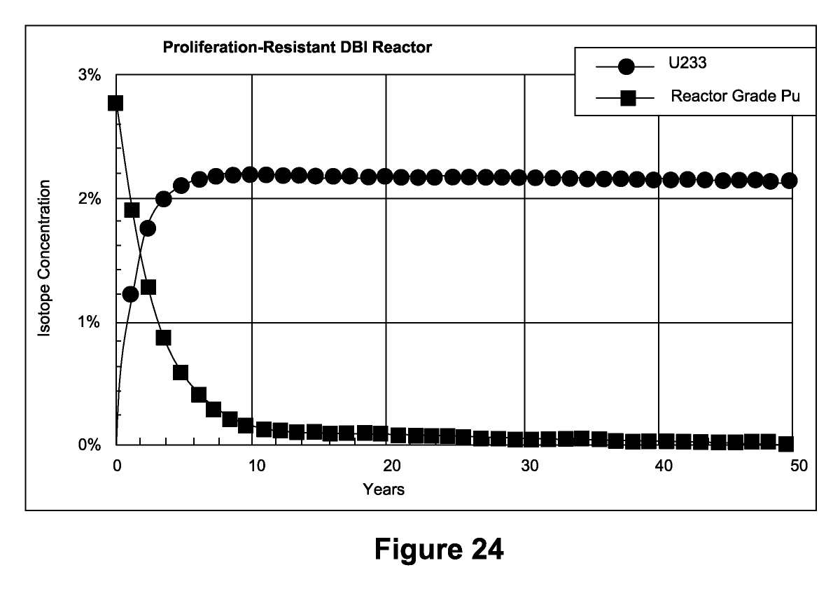

FIG. 23 is a graph showing the evolution of fissile isotopes over time averaged over a nuclear reactor core according to an embodiment of the present subject matter. With reference to FIG. 23, a load of conventional nuclear fuel material such as enriched Uranium Oxide (UO₂) may provide the initial driver or starter fuel material. In the case of enriched Uranium, there may also be a significant breeding of Plutonium due to U²³⁸. As the starter fuel material accumulates fission products, the respective nuclear fuel element may be moved to the burner region where the Plutonium and other fission products will be destroyed over time. Because the starter fuel material achieves a high fuel burn-up rate, the Plutonium may be reactor grade material, Pu²³⁸, Pu²⁴⁰, after the first couple of years. In embodiments of the present subject matter where weapons proliferation is a concern in the first few years, the reactor core may employ proliferation resistant starter fuel material generally comprising reactor-grade Plutonium mixed with Thorium. The respective fuel inventory for this embodiment is illustrated in FIG. 24. In either case exemplified in FIGS. 23 and 24, the equilibrium average concentration of U²³³ may be established at just above 2% concentration and maintained by regularly moving nuclear fuel material at various stages in their respective life history.

Energy systems employing nuclear reactors according to embodiments of the present subject matter may utilize one or plural exemplary nuclear reactor cores utilizing enriched UO₂ and/or reactor-grade Plutonium-Thorium nuclear fuel material as the driver fuel material. Minimizing nuclear fuel costs and nuclear waste disposal, embodiments may generally provide 25% of the nuclear fuel assemblies of the reactor core with fissile fuel material, at a relatively high enrichment such as 10% U²³⁵. Over the first decade of operation, the reactivity of the driver or starter fuel material declines as its respective reactivity is transferred to the surrounding breeder fuel. By approximately year 9, the reactivity that was originally concentrated in 25% of the nuclear fuel material will now be dispersed more widely, at lower concentration, in the form of U²³³ throughout the ThO₂. Computer simulations have shown that the effective active fuel volume generally increases by about 50% as a result of this dispersal resulting in a higher total heat transfer from the nuclear reactor core.

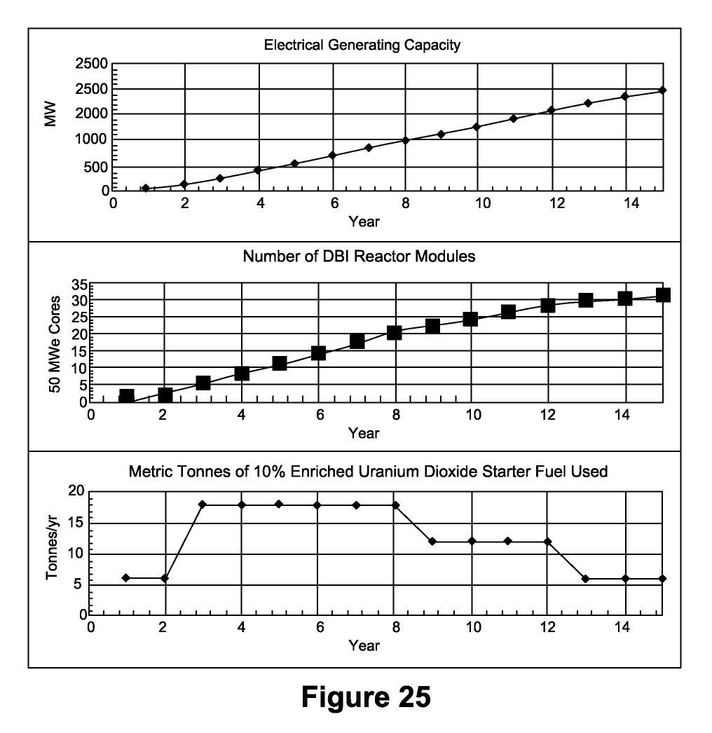

After the first decade of nuclear fuel breeding, the starter fuel material may be fully transferred to the burner region, and the nuclear fuel mixture in an exemplary reactor core should achieve an equilibrium ratio of about 97.7% Thorium and 2.3% U²³³. Computer modeling has shown that from this point forward, the increase in available U²³³ is estimated at about 2% per year. FIG. 25 is a graph showing electrical generation over a fifteen year period according to an embodiment of the present subject matter. For example, if a nation operates 50 exemplary reactor modules at 50 Megawatts electric power output, the excess U²³³ produced by all of these modules would be enough to start one new 50 Megawatt module each year. However, nations with rapidly growing economies or nations wishing to convert their energy infrastructure rapidly from other fuel sources to nuclear energy will find that 2% growth per year may be insufficient to keep pace with their respective energy demands. In such cases, any number of new exemplary reactor modules may be started any time using a conventional starter fuel such as enriched Uranium or reactor-grade Plutonium-Thorium, and these new reactors may be sustained with Thorium fuel thereafter.

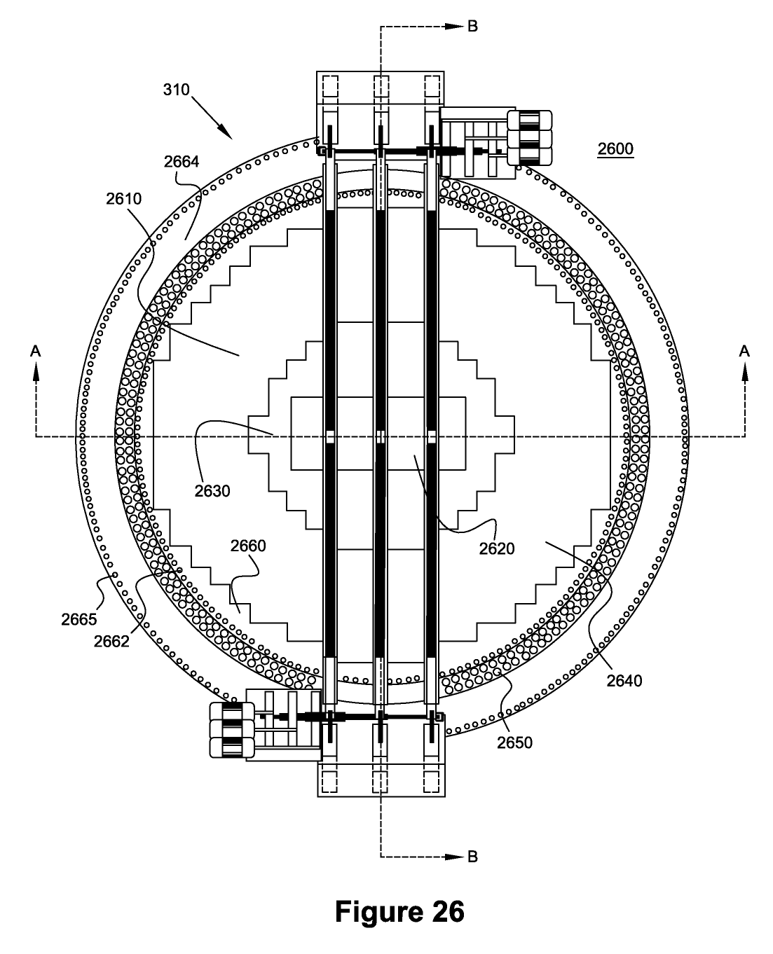

FIG. 26 is a horizontal cross-sectional view of a pressure vessel including a reactor core according to an embodiment of the present subject matter.

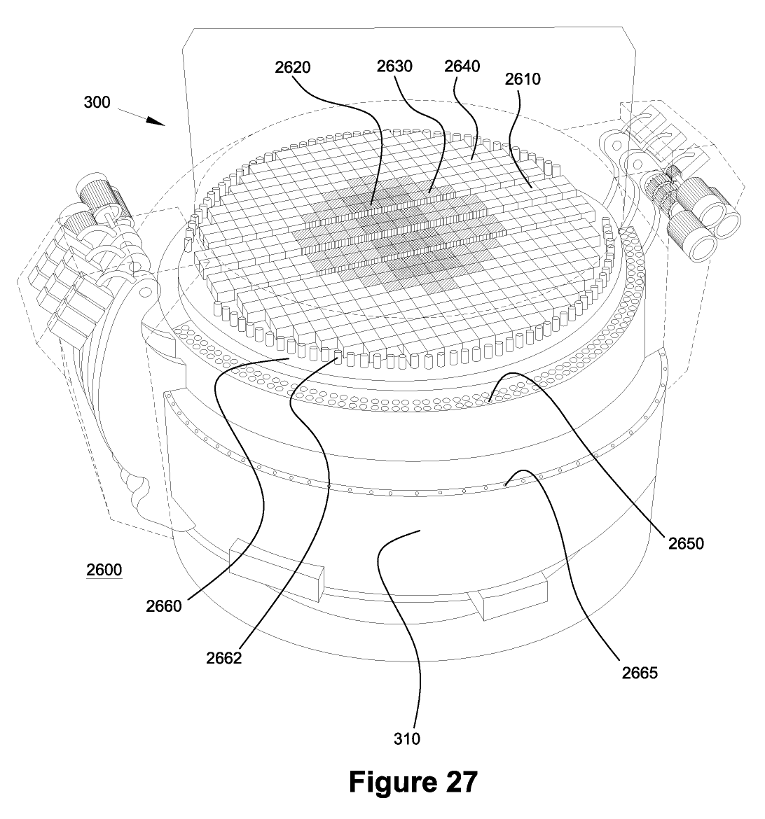

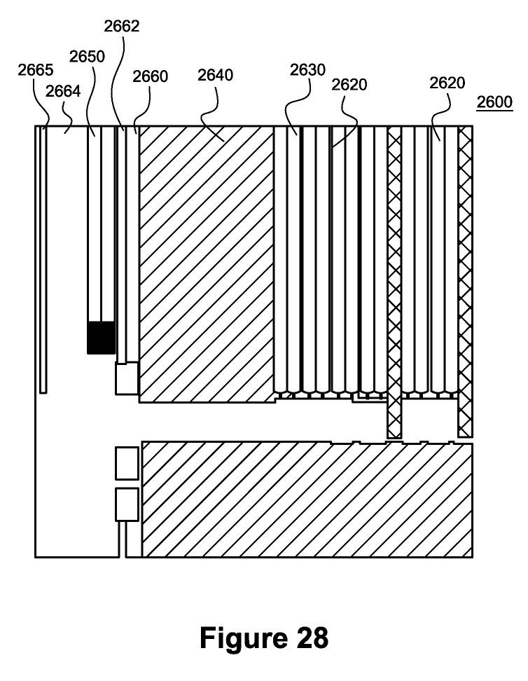

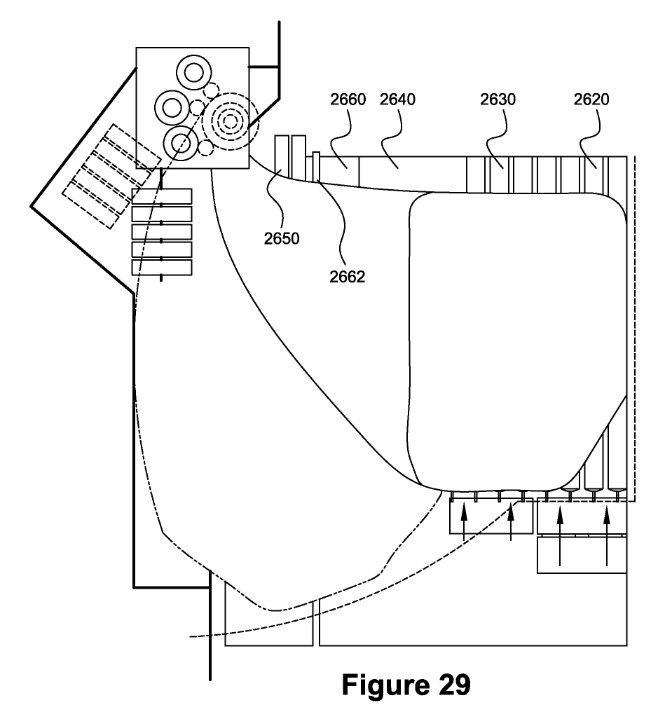

FIG. 27 is a perspective view of the pressure vessel and reactor core of FIG. 26. FIGS. 28 and 29 are a cross-sectional views of the pressure vessel and reactor core of FIG. 26 along lines A-A and B-B, respectively. With reference to FIGS. 26-29, a nuclear reactor 2600 having a pressure vessel 300 for housing a nuclear reactor core 2610 is shown. The pressure vessel 300 may include a lower vessel 310 having an upwardly facing opening and a vessel closure head 320 being supported by the lower vessel 310. The nuclear reactor core 2610 may be positioned in the lower vessel 310 and possess an inner driver region 2620 having substantially fissile nuclear fuel material and a breeder region 2630 substantially surrounding the driver region and having substantially fertile nuclear fuel material. Exemplary fissile nuclear fuel material may be Uranium, Thorium, Plutonium, isotopes of Uranium, Thorium and Plutonium, oxides of Uranium, Thorium and Plutonium, decay elements of Uranium, Plutonium and Thorium, and combinations thereof. Exemplary fertile nuclear fuel material may be Uranium and Thorium, isotopes of Uranium and Thorium, oxides of Uranium and Thorium, decay elements of Uranium and Thorium, and combinations thereof. A moderator region 2640 may substantially surround the breeder region and include an exemplary moderator. In one embodiment, the moderator may be solid and may be carbon-based, such as graphite. The moderator may generally be constructed of moderator tiles or the like, assembled to appropriate dimensions. A distal burner region 2650 having substantially fissile nuclear fuel material and having a substantially higher fission product concentration than the driver region 2620 may receive neutrons from the driver and breeder regions 2620, 2630. In one embodiment of the present subject matter the nuclear fuel material present in the core may have a 3 to 1 ratio of fertile to fissile nuclear fuel material whereby the fissile material may be 5% enriched uranium. It should be noted, however, that the type and amount of fissile material included in exemplary nuclear cores may vary from reactor plant to reactor plant, depending upon the reactor plant size and government regulations of the country of installation, therefore such a disclosure should not limit the scope of the claims appended herewith.

The reactor 2600 may also include a buffer region 2660 substantially surrounding the moderator region 2640. The buffer region 2660 may be adapted to distribute heat to the moderator region 2640 to maintain the temperature thereof at or above a predetermined temperature to preclude the Wigner effect. Briefly, the Wigner effect (also known as the decomposition effect) is the displacement of atoms in a solid caused by neutron radiation. Any solid may be subject to the Wigner effect, but the displacement of atoms is of most concern in neutron moderators, such as graphite, that are utilized to slow down fast neutrons. An exemplary temperature may be approximately 700° F. or greater. The buffer region 2660 may generally comprise silica or another suitable buffer material and may include a plurality of reactor coolant exhaust pipes 2662. The buffer region 2660 may assist in preventing erosion of the exhaust pipes 2662 and may also remove heat from any nuclear fuel material contained in the burner region 2650. In another embodiment, the reactor 2600 may also include a plurality of cooling pipes 2665 positioned within the outer wall of the lower vessel 310 to remove heat from the lower vessel. Suitable shielding 2664 may be provided between the burner region 2650 and the cooling pipes 2665.

In one embodiment of the present subject matter, an exemplary nuclear reactor core 2610 may comprise a driver region 2620 having fissile nuclear fuel material, a breeder region 2630 substantially surrounding the driver region 2620 and having fertile nuclear fuel material, and a moderator region 2640 substantially surrounding the driver region 2630. In a further embodiment of the present subject matter, the reactor core 2610 may include a distal burner region 2650 having fissile nuclear fuel material with a substantially higher fission product concentration than the driver region 2620, where the burner region 2650 is adaptable to receive neutrons from the driver and breeder regions 2620, 2630.

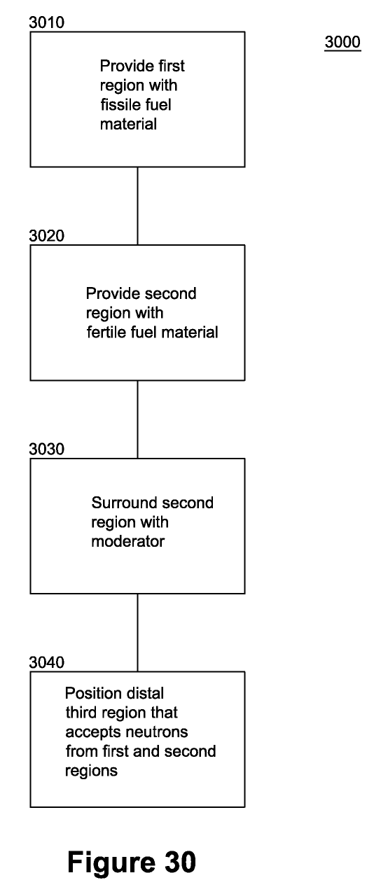

FIG. 30 is a block diagram representing a method according to one embodiment of the present subject matter. With reference to FIG. 30, a method 3000 for reducing concentration of fission products in a nuclear reactor is provided. The method may include providing an inner first region in a nuclear reactor core where the first region has substantially fissile nuclear fuel material at step 3010, and providing a second region in the reactor core where the second region substantially surrounds the first region and has substantially fertile nuclear fuel material at step 3020. The second region may be substantially surrounded with a moderator to slow neutrons escaping from the first and second regions at step 3030. A distal third region may be positioned in a respective reactor where the third region has substantially fissile nuclear fuel material, a substantially higher fission product concentration than the first region, and is adapted to receive neutrons from the first and second regions at step 3040. In one embodiment, the moderator may be a solid moderator such as the carbon-based moderator, graphite. In another embodiment of the present subject matter, the method for reducing concentration of fission products 3000 may be employed to reduce weapons-grade Plutonium, reactor-grade Plutonium, and/or other fission products and actinides. The respective nuclear fuel material may be placed in the first and/or distal third regions as a function of the fission product concentrations.

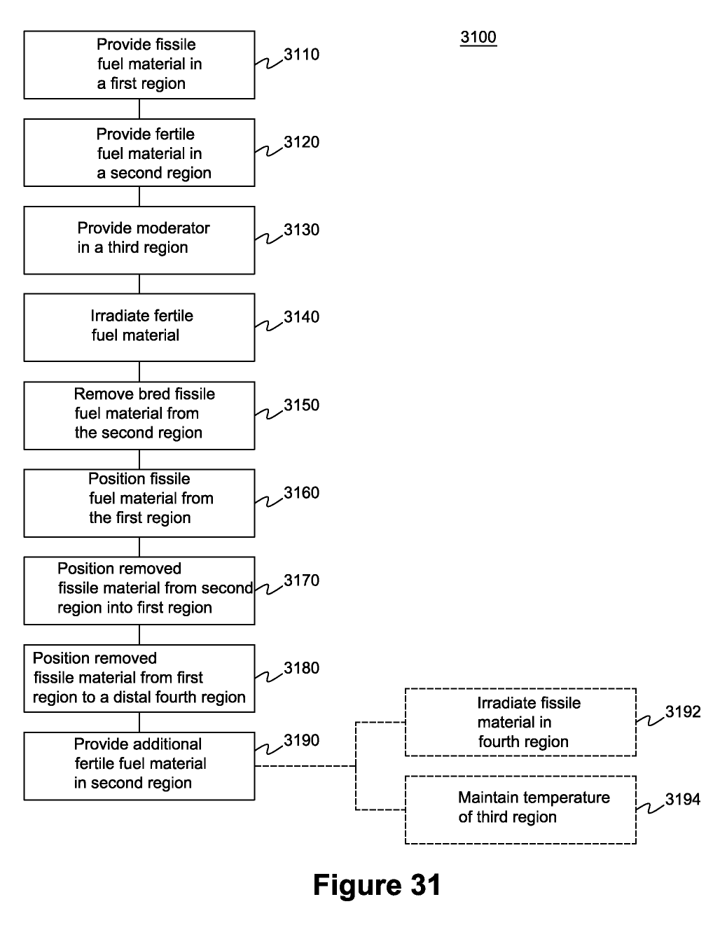

FIG. 31 is a block diagram representing a method according to another embodiment of the present subject matter. With reference to FIG. 31, a method 3100 for producing energy is provided. The method may include providing fissile nuclear fuel material in a first region of a nuclear reactor core at step 3110 and providing fertile nuclear fuel material in a second region of the nuclear reactor core at step 3120. At step 3130, a moderator may be provided in a third region of the nuclear reactor core. The fertile nuclear fuel material may then be irradiated with neutrons from the first region to breed fissile nuclear fuel material in the second region at step 3140. Fissile nuclear fuel material may be removed from the second region as a function of fissile material concentration at step 3150, and fissile nuclear fuel material may be removed from the first region as a function of fission product concentration at step 3160. At step 3170, the removed fissile nuclear fuel material from the second region may positioned into the first region. At step 3180, the removed fissile nuclear fuel material from the first region may be positioned into a distal fourth region of the nuclear reactor core. Additional fertile nuclear fuel material may be provided in the second region to replace the removed fissile nuclear fuel material at step 3190. In a further embodiment, the method may further comprise irradiating fissile nuclear fuel material in the fourth region by moderated neutrons from the first and second regions to reduce fission product concentrations at step 3192. In another embodiment, the method may comprise maintaining the temperature of the third region at or above a predetermined temperature at step 3194.

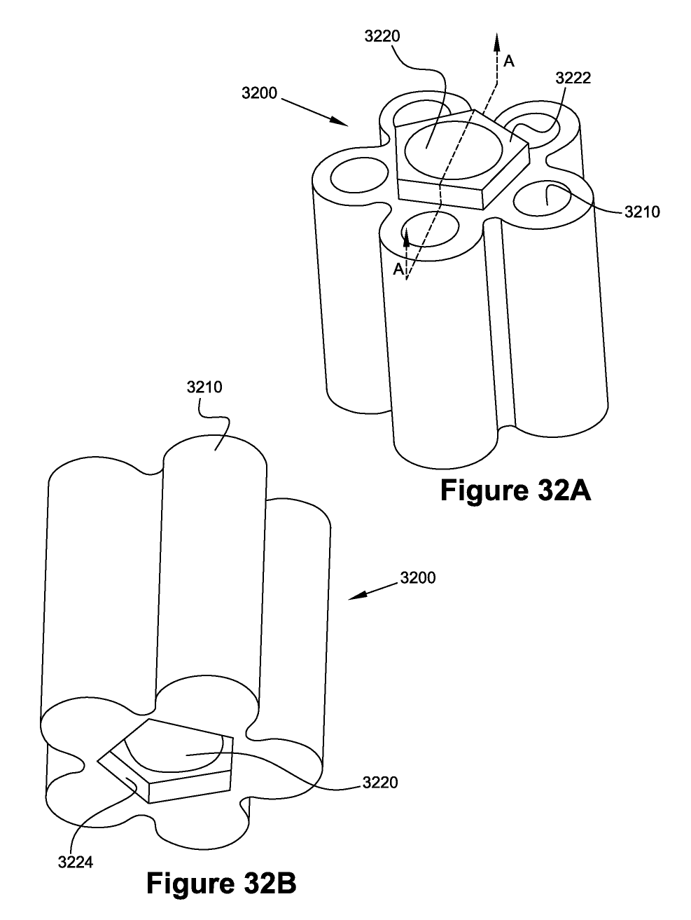

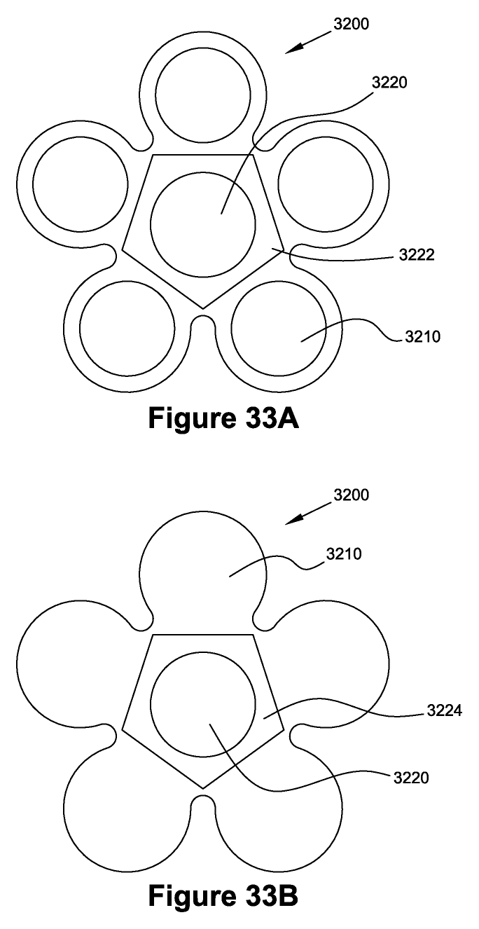

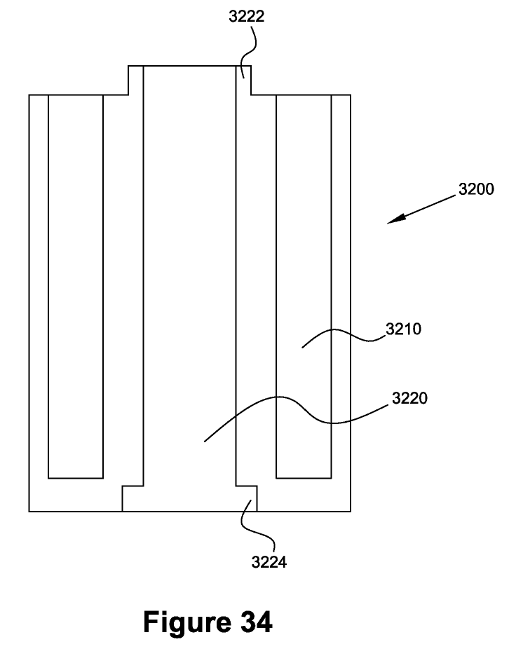

Each of the regions having nuclear fuel material in an exemplary reactor core according to embodiments of the present subject matter may provide fuel elements that contain the respective fissile or fertile nuclear fuel material. Conventional nuclear fuel fabrication generally begins by converting enriched Uranium Hexafluoride (UF₆) to Uranium Dioxide (UO₂). The UO₂ powder may then be formed into cylindrical pellets and loaded into long zirconium-alloy cladding tubes to form individual fuel pins or rods. The final fuel assembly generally includes an array of fuel pins and other components. Conventional nuclear fuel rods are generally bundled in a generally rectangular prism form to about twenty feet high and within a twenty four inch square area. Individual fuel pins generally include the cladding tube, the fuel pellet stack, a retention spring, and welded end caps. Upper and lower tie plates plus interim spacers secure the fuel pins into a square array with eight pins to a side. A fuel channel encloses the fuel pin array such that coolant entering at the bottom of the assembly remains within the boundary formed by the channel as the coolant flows up and between the fuel pins to removes the fission energy. Nuclear fuel housings utilized by embodiments of the present subject matter may be conventional fuel housings or preferably the fuel housings shown in FIGS. 32A though 34. FIGS. 32A and 32B are perspective views of a nuclear fuel housing according to an embodiment of the present subject matter. FIGS. 33A and 33B are top plan and bottom plan views of a nuclear fuel housing according to an embodiment of the present subject matter. FIG. 34 is a cross-sectional view of the nuclear fuel housing of FIG. 32A along line A-A. With reference to FIGS. 32A through 34, an exemplary nuclear fuel housing 3200 may comprise a plurality of nuclear fuel wells 3210. In one embodiment of the present subject matter, tangents drawn from each fuel well 3210 to an adjacent fuel well may form a polygon, such as, but not limited to, a triangle, square, pentagon, hexagon, heptagon, octagon, enneagon, and decagon. Thus, the fuel housing 3200 shown in the figures with five fuel wells 3210 is exemplary only and should not limit the scope of the claims herewith. For example, exemplary fuel housings according to embodiments of the present subject matter may include ten or more fuel wells. Each of the nuclear fuel wells 3210 may have a generally planar horizontal lower floor and a wall extending upwardly from the lower floor. The upper edge of the wall may form an upwardly facing opening adaptable to accept nuclear fuel material. Exemplary nuclear fuel material may be Uranium, Thorium, Plutonium, isotopes of Uranium, Thorium and Plutonium, oxides of Uranium, Thorium and Plutonium, decay elements of Uranium, Plutonium and Thorium, and combinations thereof. An exemplary fuel well wall may be generally cylindrical, however, the fuel well walls may be another arcuate and/or planar form and such an example should not limit the scope of the claims appended herewith. The walls of the fuel housing may comprise suitable high-temperature ceramic or similar material.

The fuel housing 3200 may also include a central coolant channel 3220 aligned about a central longitudinal axis of the housing 3200. The coolant channel 3220 may possess a wall defining a passage through the housing 3200. An exemplary coolant channel 3220 may be generally cylindrical, however, coolant channels may possess other arcuate and/or planar forms and such a disclosure should not limit the scope of the claims appended herewith. In one embodiment, each of the plural fuel wells 3210 may be equally spaced about the coolant channel 3220. For example, in an embodiment having five fuel wells 3210, the centroid of adjacent fuel wells 3210 may be 72 degrees apart as measured from the channel longitudinal axis. Of course, in embodiments having more or less fuel wells 3210, the angle may vary accordingly. A portion of the channel wall may axially extend from the upper edge of the housing 3200 and form a protrusion or lip 3222. Another portion of the channel wall may also form an axial indentation or recess 3224 laterally extending beyond the periphery of the channel 3220 and axially extending above the lower floor of the housing 3200. The geometric figure formed by the lip 3222 and the recess 3224 may be the same to assist in the construction and/or interlocking of axially adjacent fuel housings. Exemplary geometric figures may be, but are not limited to, a circle, triangle, square, pentagon, hexagon, heptagon, octagon, enneagon, and decagon.

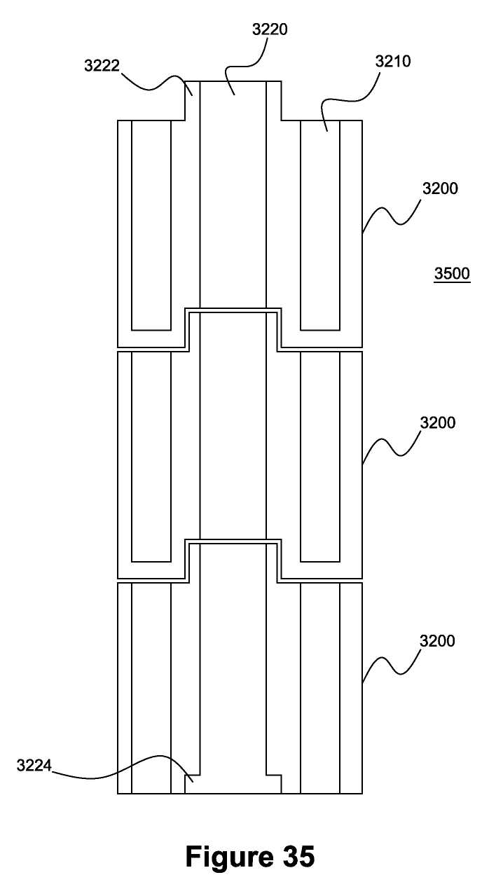

FIG. 35 is a cross-sectional view of a nuclear fuel sub-assembly according to an embodiment of the present subject matter. With reference to FIG. 35, an exemplary nuclear fuel sub-assembly 3500 may comprise a plurality of nuclear fuel housings 3200 described above where the fuel housings 3200 are axially stacked on or interlocked with one another. Any number of fuel housings 3200 may be axially stacked on one another, and generally, such number is a function of the height or size of the respective nuclear reactor design. For example, in one embodiment a first housing may be positioned on top of a second housing so that the axially extending recess of the first housing is positioned over the lip of the second housing, the channel of the first housing is axially aligned with the channel of the second housing, and the bottom surface of the first housing covers the open ends of the fuel wells of the second housing. The geometric figure formed by the lip 3222 and the recess 3224 of adjacent fuel housings 3200 assists in the interlocking and mating of axially adjacent fuel housings 3200. The geometric figure formed by the lip 3222 and the recess 3224 of mated fuel housing surfaces should generally correspond to achieve a secure interlock; however, geometric figures for indentations and protrusions in non-mating fuel housing surfaces may be different. Axially adjacent fuel housings 3200 may also contain the same or different numbers of fuel wells 3210. The coolant channel 3220 of axially adjacent fuel housings 3200 may define a passage through the sub-assembly 3500 allowing flow of reactor coolant. In one embodiment of the present subject matter, an exemplary nuclear fuel sub-assembly 3500 may comprise a plurality of nuclear fuel housings 3200, each fuel housing having a plurality of nuclear fuel wells 3210 adaptable to accept nuclear fuel where adjacent fuel housings 3200 are oriented along a common axis to provide closed fuel wells 3210 and a continuous coolant channel 3220 that defines a passage through the sub-assembly 3500.

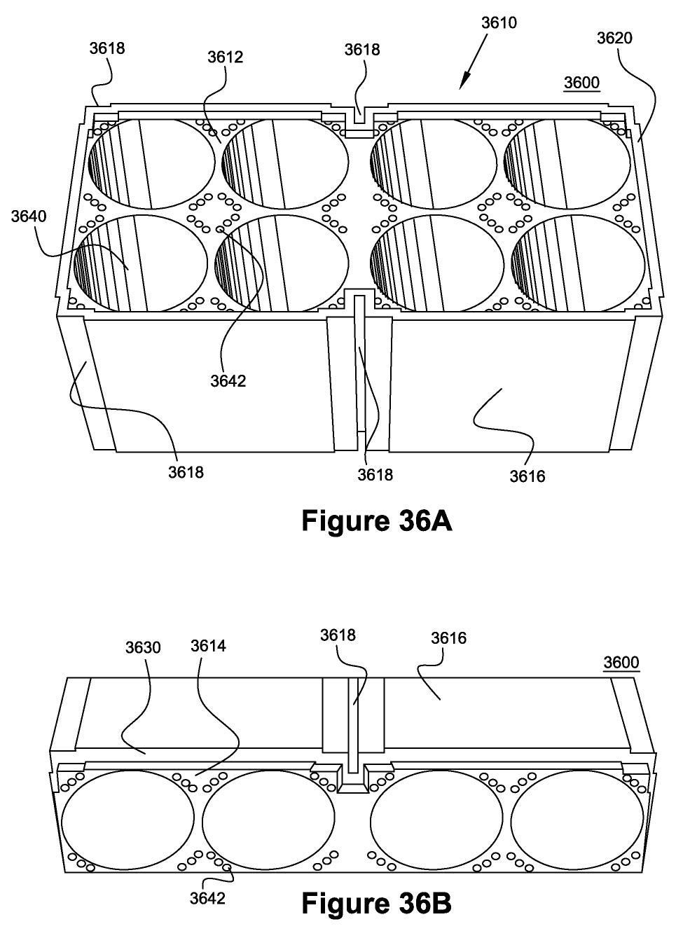

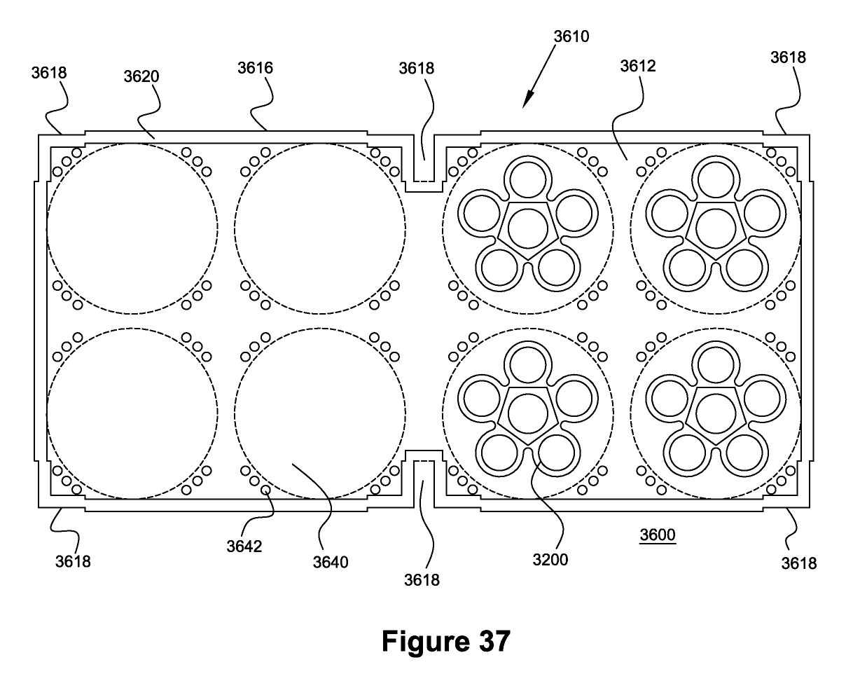

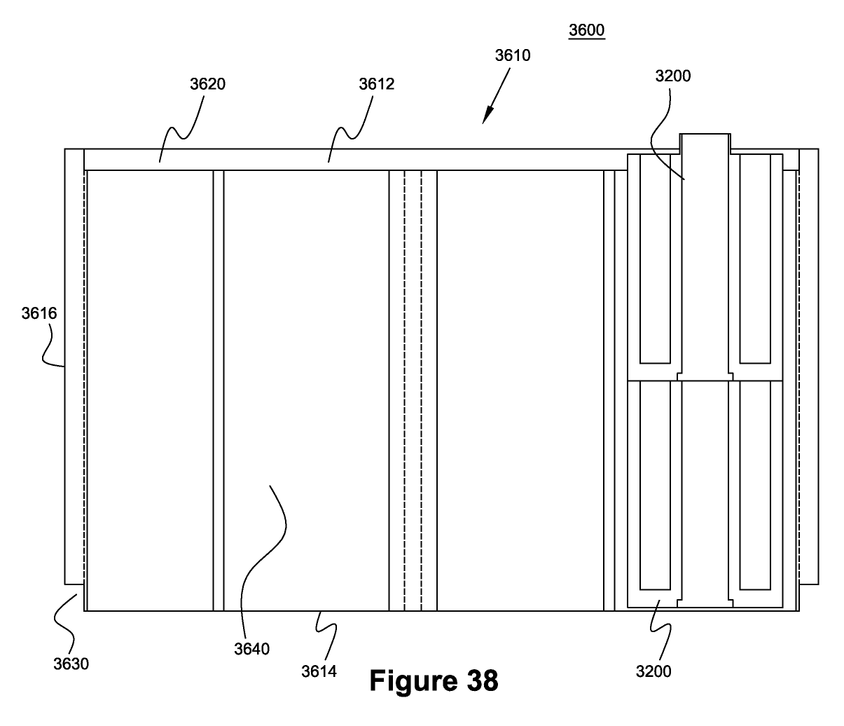

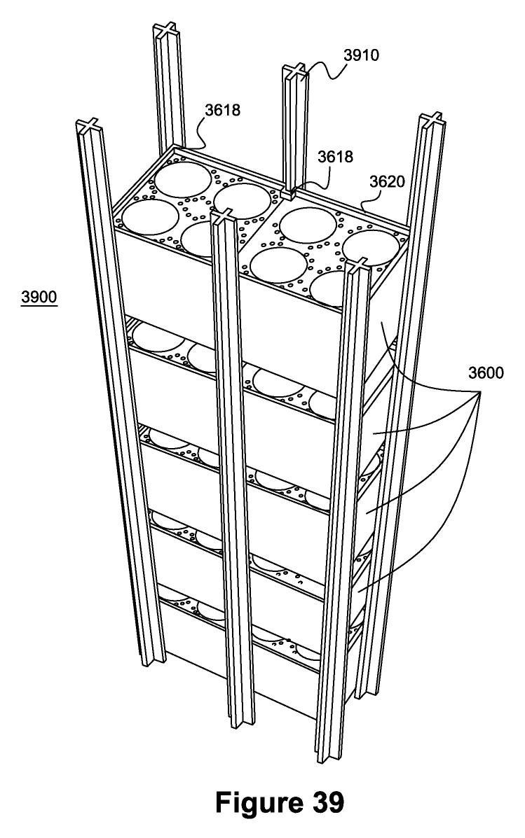

Exemplary fuel sub-assemblies 3500 may be placed inside a fuel assembly shown in FIGS. 36A through 38. FIGS. 36A and 36B are perspective views of a nuclear fuel assembly according to an embodiment of the present subject matter. FIGS. 37 and 38 are a top plan view and a cross-sectional view of a nuclear fuel assembly according to an embodiment of the present subject matter. With reference to FIGS. 36A through 38, an exemplary nuclear fuel assembly 3600 may comprise a substantially rectangular or cubical block 3610 made from high-temperature ceramic or other suitable material and having a substantially planar upper surface or upper major face 3612, a substantially planar lower surface or lower major face 3614, and four substantially planar lateral surfaces forming a peripheral wall 3616. One or more of the surfaces 3612, 3614, 3616 may provide one or more notches 3618 along the periphery thereof for seismic reinforcement. A portion of the upper major face 3612 may axially protrude or extend from the perimeter thereof and form a peripheral protrusion or lip 3620. A portion of the lower major face 3614 may form a peripheral indentation or recess 3630 axially extending above the lower face 3614. The peripheral lip 3620 and recess 3630 may assist in the construction and/or interlocking of axially adjacent fuel assemblies 3600. One or more fuel wells 3640 may define one or more passages through the block 3610. These fuel wells may be generally cylindrical or arcuate in shape, however, such an example should not limit the scope of the claims appended herewith. While exemplary fuel assemblies 3600 are shown as providing eight fuel wells 3640, such a depiction should not limit the scone of the claims appended herewith as any number of fuel wells 3640 may be contained by fuel assemblies 3600 according to embodiments of the present subject matter. Each of the fuel wells 3640 may accept one or more nuclear fuel housings 3200 having nuclear fuel such as, but not limited to, Uranium, Thorium, Plutonium, isotopes of Uranium, Thorium and Plutonium, oxides of Uranium, Thorium and Plutonium, decay elements of Uranium, Plutonium and Thorium, and combinations thereof. In one embodiment of the present subject matter, the fuel assembly 3600 may also include a plurality of passages 3642 to permit the flow of coolant therethrough. The passages 3642 may be any shape or size, and exemplary coolant may be gas or liquid.

FIG. 39 is a perspective view of a nuclear fuel array according to an embodiment of the present subject matter. With reference to FIG. 39, an exemplary nuclear fuel array 3900 may comprise a plurality of nuclear fuel assemblies 3600 where the fuel assemblies 3600 are axially stacked on and/or interlocked with one another. Any number of fuel assemblies 3600 may be axially stacked on one another, and such number is generally a function of the height or size of the respective nuclear reactor. The peripheral lips 3620 and recesses 3630 of adjacent fuel assemblies 3600 assist in the interlocking and mating of axially adjacent fuel assemblies 3600. The lip 3620 and recess 3630 of mated fuel housing surfaces should generally correspond to achieve a secure interlock; however, indentations and protrusions in non-mating fuel assembly surfaces may be different. The plural notches 3618 along the periphery and/or lateral surfaces of the fuel assemblies 3600 may mate with axially extending or vertical rails or beams 3910 for seismic reinforcement of the fuel array 3900. It should be noted that many alternatives are envisioned for seismic reinforcement of the fuel arrays 3900, and the depiction provided in the figures should not limit the scope of the claims appended herewith.

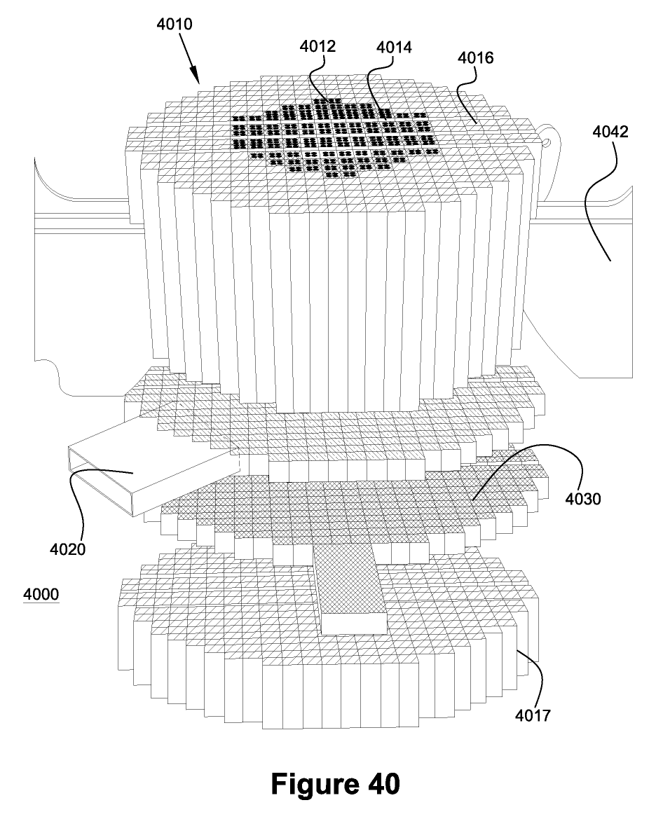

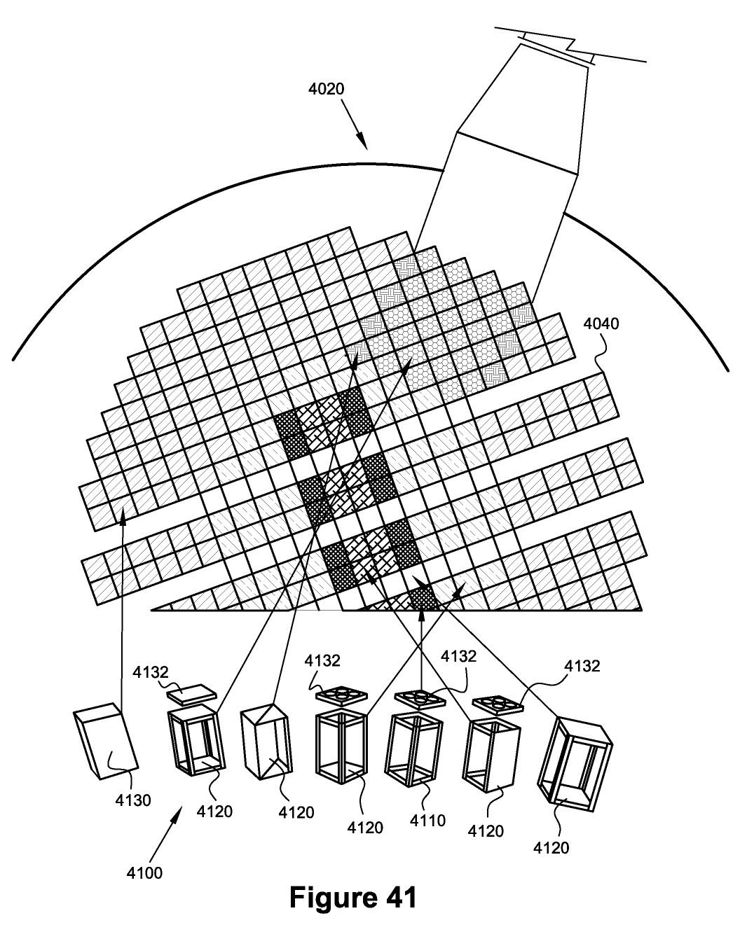

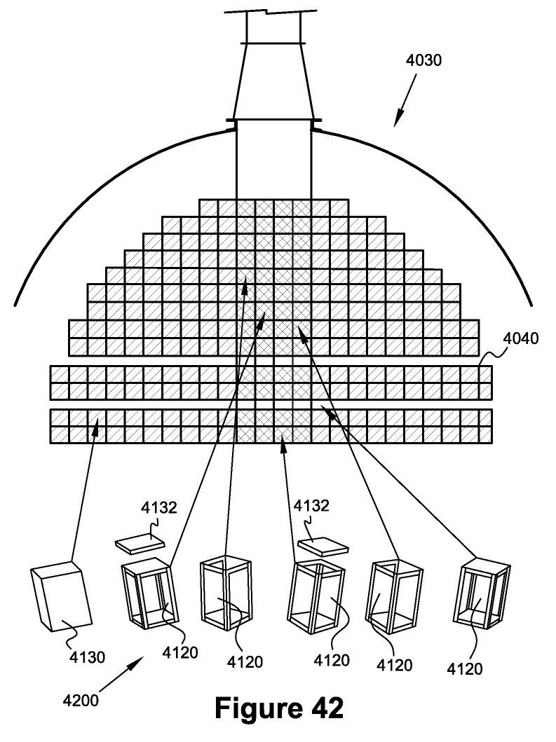

FIG. 40 is a perspective view of a coolant manifold system according to an embodiment of the present subject matter. FIGS. 41 and 42 are a horizontal cross-sectional views of the upper and lower coolant manifolds, respectively, of FIG. 40. With reference to FIGS. 40-42, a system 4000 for cooling a nuclear reactor may comprise a pressure vessel having a lower vessel and a vessel closure head being supported by the lower vessel. An exemplary nuclear reactor core 4010 may be positioned in the lower vessel. The lower vessel may include one or more penetrations 4040 for lateral insertion of one or more reactor control blades 4042 into the reactor core 4010. The reactor core 4010 may also include a driver region 4012 having substantially fissile nuclear fuel material, a breeder region 4014 having substantially fertile nuclear fuel material, and a moderator region 4016 having a suitable moderator. An exemplary moderator may be, but is not limited to, a solid moderator such as graphite. The system 4000 may further include a first coolant manifold 4020 having a plurality of pylons 4100 for directing reactor coolant substantially to the driver region 4012 and a second coolant manifold 4030 having a plurality of pylons 4200 for directing reactor coolant substantially to the breeder region 4014. The passage of the reactor coolant through the driver and breeder 4012, 4014 may remove heat generated by the fissile and fertile nuclear fuel materials. Further, the flow rate of the reactor coolant may also be a function of the generated heat. In one embodiment, a full insertion of the one or more reactor control blades 4042 into the reactor core 4010 may alter the flow of the reactor coolant. An exemplary reactor core 4010 may also include an additional moderator region 4017 adjacent and below the second coolant manifold 4030. An exemplary system 4000 according to another embodiment of the present subject matter may also be utilized to prevent the Wigner effect. For example, an exemplary reactor core 4010 may also include a buffer region (not shown) being adapted to distribute heat to the moderator region 4016 to maintain the temperature thereof. The buffer region may generally comprise silica and/or one or more reactor coolant exhaust pipes that receive heated reactor coolant from the driver and breeder regions 4012, 4014. The heat produced from the reactor coolant exhaust pipes may be distributed through the buffer region to maintain and control the temperature of the moderator region 4016.

With reference to FIGS. 41 and 42, the geometry of any one of the plural pylons 4100, 4200 are generally a function of predetermined circulation rates desired in the first coolant manifold 4020 and the second coolant manifold 4030. For example, any one of the plural pylons 4100, 4200 may be a hollow rectangular prism having no solid faces 4110, a hollow cube having no solid faces, a hollow polygonal prism having no solid faces, a hollow rectangular prism having one or more solid faces 4120, a hollow cube having one or more solid faces, a hollow polygonal prism having one or more solid faces, a partially filled polygonal prism, and combinations thereof. Pylons 4100, 4200 adjacent to columns or tiles of moderator 4130 may also generally provide one or more solid faces adjacent the moderator. Further, any number of the pylons 4100, 4200 may include caps or lids 4132 to interface with axially adjacent fuel cells, other pylons, or moderator regions and/or prevent or direct flow of coolant. For example, pylons 4100, 4200 that include lids 4132 having channels generally direct flow to the respective fertile or fissile nuclear fuel material. Similarly, pylons 4100, 4200 that include solid lids generally prevent coolant flow to an axially adjacent region or pylon. Generally, the first coolant manifold 4020 may be utilized to provide coolant flow for the fertile nuclear fuel material or breeder region 4014, and the second coolant manifold 4030 may be utilized to provide coolant flow for the fissile nuclear fuel material or driver region 4012. Separate coolant paths allow different circulation and flow rates for the differing fuel materials and hence coolant channels though the respective fuel arrays, i.e., regions, as each respective coolant channel and region may generate different heat outputs. Significant cross-circulation between coolant paths and coolant manifolds also exist to ensure that the temperature of the coolant at the coolant outlet (not shown) is approximately the same. Exemplary reactor coolant may be liquid or gas. Further, movement of the reactor coolant may purely be a function of the amount of heat to be removed, i.e., natural circulation, or may be a forced flow or circulation. In one embodiment, movement of the reactor coolant may be a function of the geometry of the inlet plenums of the first and second coolant manifolds.

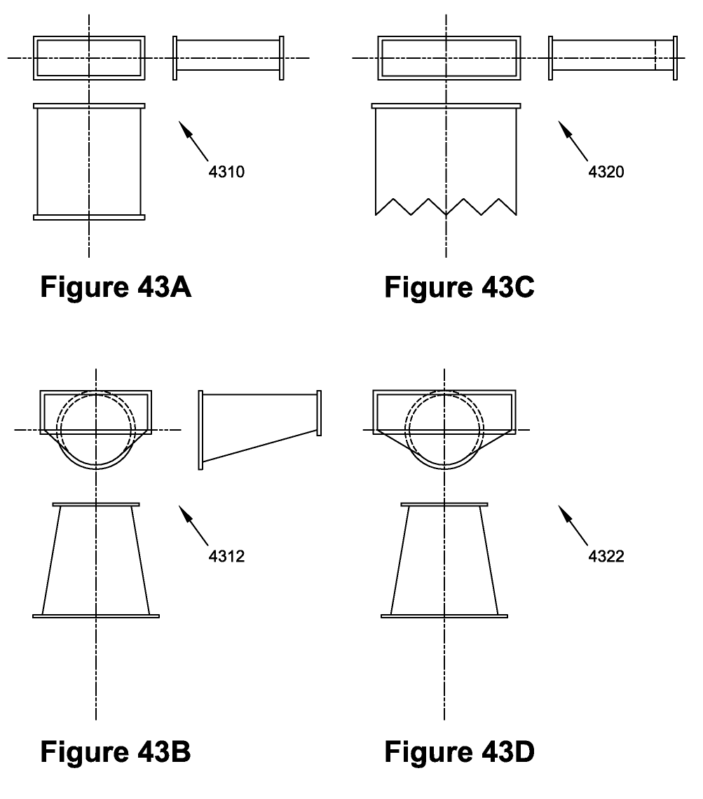

FIGS. 43A-D are graphical illustrations of upper and lower manifold inlet plenums and transition components according to an embodiment of the present subject matter. With reference to FIGS. 43A and B, the first coolant manifold 4020 may include a plenum 4310 and transition pieces 4312 providing some measure of control of the initial flow rate of coolant into the manifold 4020. With reference to FIGS. 43C and D, the second coolant manifold 4030 may also include a plenum 4320 and transition pieces 4322 providing some measure of control of the initial flow rate of coolant into the assembly 4030. Venturi meters (not shown) may be operably connected to the inlet manifolds 4310, 4320 to monitor and measure coolant flow.

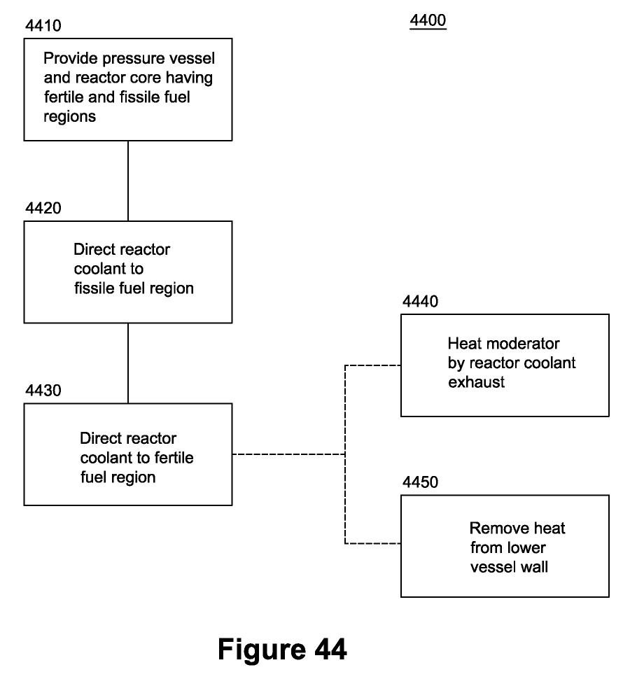

FIG. 44 is a block diagram representing a method according to one embodiment of the present subject matter. With reference to FIG. 44, a method 4400 is provided for cooling a nuclear reactor comprising, at step 4410, providing a pressure vessel having a lower vessel, a vessel closure head being supported by the lower vessel, and a nuclear reactor core positioned in the lower vessel. The reactor core may include first and second regions having substantially fissile and fertile nuclear fuel material, respectively. The core may also include a third region having a moderator. Reactor coolant may be directed to the first and second regions via first and second coolant assemblies, respectively, at steps 4420 and 4430. The passage of the reactor coolant through the first and second regions may thus remove heat generated by the fissile and fertile nuclear fuel materials and the flow rate of the reactor coolant may also be a function of the generated heat. In another embodiment, the method may further comprise the step of heating the third region by exhausted reactor coolant from the reactor core at step 4440. In a further embodiment, the method may include removing heat from the lower vessel to a medium contained in a plurality of cooling pipes positioned within the wall at step 4450.

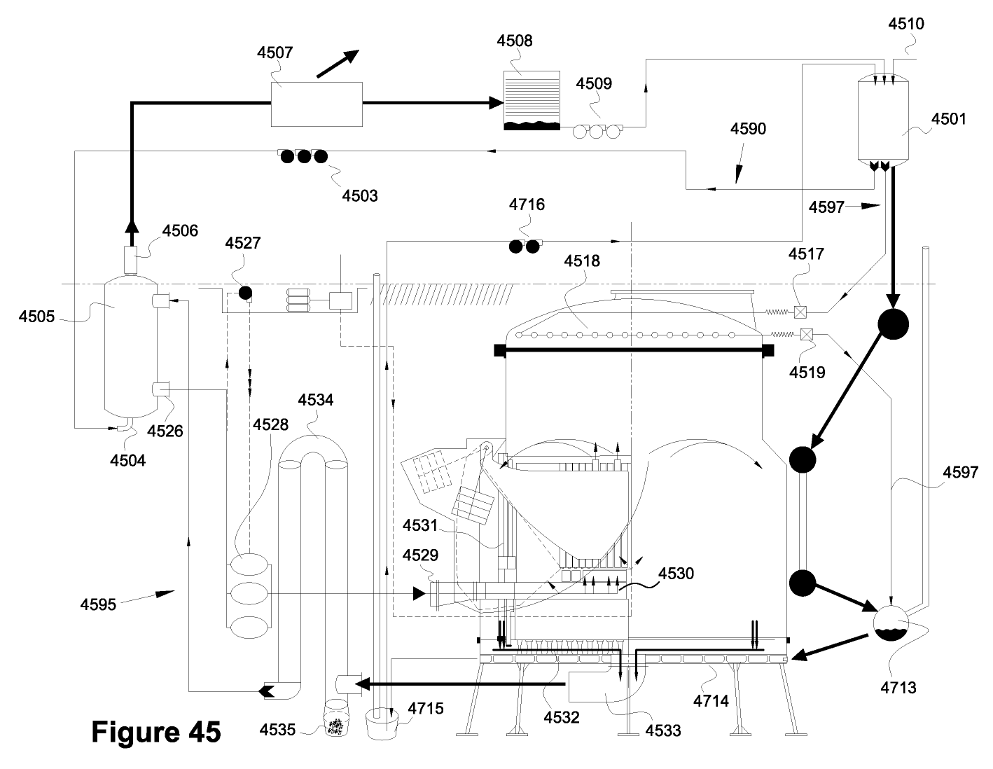

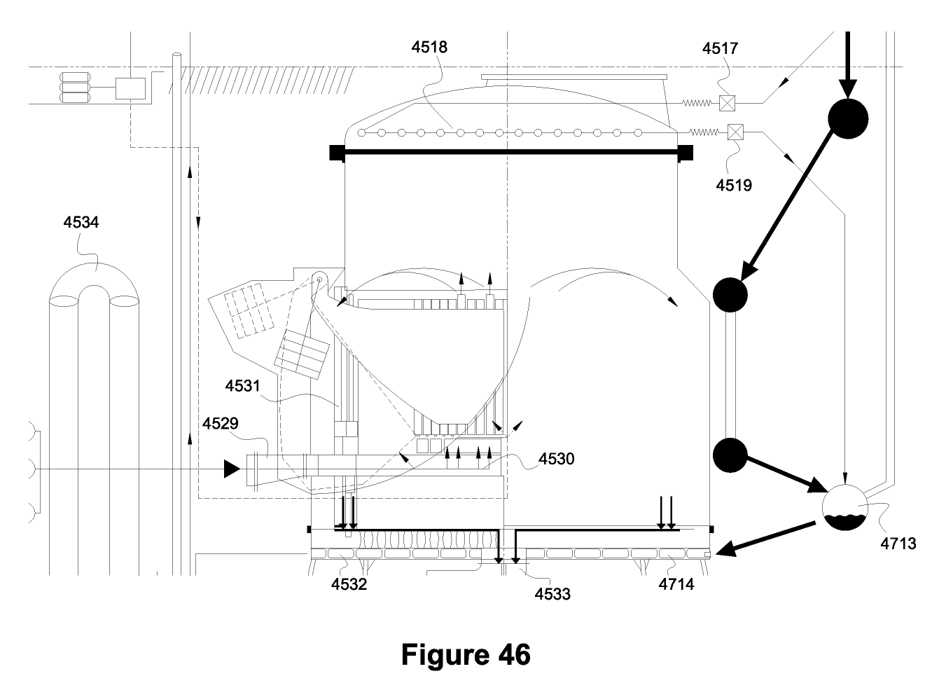

FIGS. 45 and 46 are schematic diagrams of a reactor system under normal operating conditions according to an embodiment of the present subject matter. With reference to FIGS. 45 and 46, a normal closed heat exchanger water loop 4590 according to one embodiment of the present subject matter provides a path for water to remove heat from the reactor coolant. A main water reservoir 4501 feeds cold water on the normal closed heat exchanger water loop 4590 via gravity through high-pressure feedwater pumps 4503. The outlet of the feedwater pumps 4503 provides cold pressurized water through an inlet 4504 of the gas/water heat exchanger 4505. Inside the gas/water heat exchanger 4505, cold pressurized water accepts sufficient quantities of heat from the reactor coolant to change state to pressurized steam. The pressurized steam exits through an outlet 4506 of the gas/water heat exchanger 4505 and proceeds to a power recovery unit 4507. Exemplary units 4507 may be turbines and the like. Recovered power may then be redirected to a desired electrical market. The pressurized steam, now at a lower pressure, continues through the power recovery unit 4507 to a condenser 4508. The water condensed from the steam in the condenser 4508 then travels through low-pressure circulation pumps 4509 into a water quality control system 4510. Water cleaned in the water quality control system 4510 may then be pumped back into the main water reservoir 4501.

With continued reference to FIGS. 45 and 46, a normal closed heat exchanger reactor gas coolant loop 4595 according to one embodiment of the present subject matter provides a path for gaseous reactor coolant to remove heat from the reactor core. Cold gas exiting the gas/water heat exchanger 4505 through an outlet 4526 passes through two or more Venturi driver pumps 4527 with Venturi meters 4528 to provide low-pressure circulation. The pressurized gas circulates to both reactor coolant inlet manifolds 4529 (depicted here as a single inlet manifold for ease of illustration). From the inlet manifolds 4529 the pressurized gas flows through the respective pylons 4530 and through the coolant channels in each individual fuel array, accepting heat generated from the respective nuclear fuel material. The heated pressurized gas exits the top of each fuel array and enters the reactor coolant exhaust pipes 4531 surrounding the periphery of the reactor core to a lower gas passage 4532 at the bottom of the pressure vessel and to a hot gas outlet 4533. The reactor coolant exhaust pipes 4531 may be utilized to provide a heating mechanism for graphite moderator in the reactor core and remove heat generated by fissile fuel material in the respective burner region of the core. When the heated gas leaves the pressure vessel, the gas enters a vertical manifold 4534. The vertical manifold 4534 may possess a large diameter that decreases pressure to promote gravity drop of foreign particles in the coolant stream into a particle collector 4535. Of course, the manifold 4534 may also contain a tortuous path to accomplish the same goal. The gas continues through the manifold 4534 and to an inlet 4536 at the top of the gas/water heat exchanger 4505. Hot gas circulates down the heat exchanger 4505, transferring heat to the water, and exits as cold gas through the outlet 4526.

A separate pressure vessel closure head water coolant flow 4597 may also occur in an embodiment of the present subject matter. With reference to FIGS. 45 and 46, in the closure head water flow 4597 the main water reservoir 4501 may feed cold water through a first closure head isolation valve 4517 (inlet) into a heat exchange system 4518 in the closure head. The heat exchange system 4518 may be a series of horizontal or vertical pipes and/or U-tubes. Heated water exits through the a second closure head isolation value 4519 (outlet) and feeds via gravity into a lower loss of coolant accident tank 4713. The water from the lower tank 4713 feeds into cooling pipes 4714 passing below the main pressure vessel frame. The heated water from the cooling pipes 4714 may pass into another water reservoir 4715. In embodiments where the flow is pressurized, the reservoir 4715 will not be vented to atmosphere. From the reservoir 4715 the water feeds through a set of recovery pumps 4716 which return the water to the main water reservoir 4501. It should be noted that the isolation valves 4517, 4519 may be disconnected to allow access to the nuclear fuel material in the reactor core. Proper flow in the closure head water coolant flow 4597 may be sensed and/or monitored as a function of any one or combination of the following parameters: (1) water does not exit the main reservoir 4501 in the proper flow path 4597; (2) water from the main reservoir 4501 fails to enter the first isolation valve 4517; (3) water fails to exit the first isolation valve 4517; (4) water from the first isolation valve 4517 fails to enter the heat exchange system 4518; (5) water from the first isolation valve 4517 fails to circulate through the heat exchange system 4518; (6) water in the heat exchange system 4518 does not receive sufficient heat from the closure head; (7) water from the heat exchange system 4518 fails to enter the second isolation valve 4519; (8) water fails to exit the second isolation valve 4519; and (9) water from the second isolation valve 4519 fails to enter the lower tank 4713.

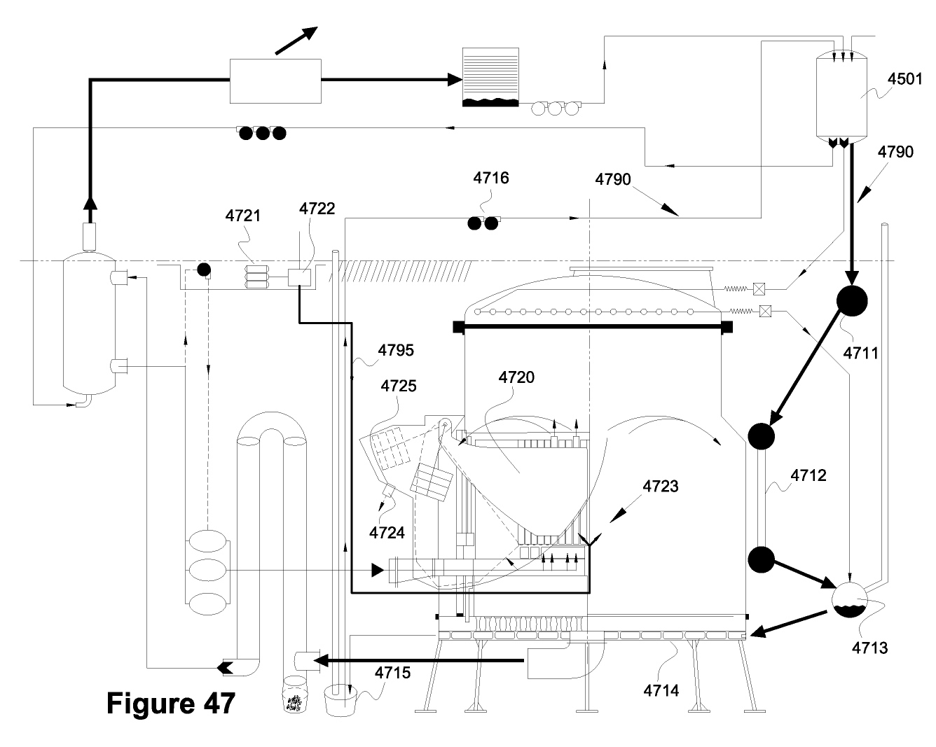

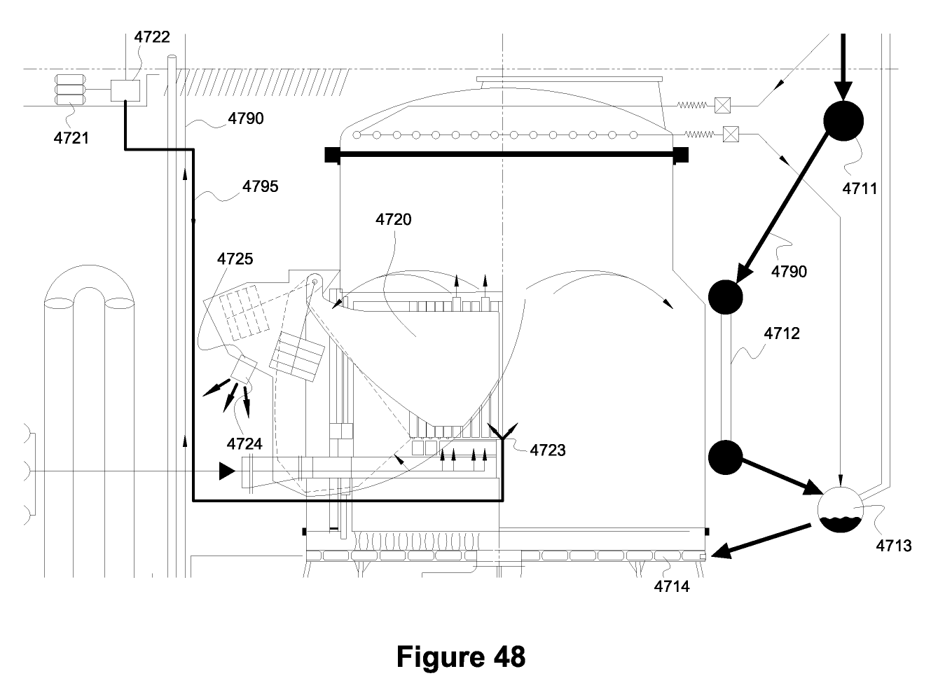

As discussed above, embodiments of the present subject matter provide several flow paths for coolant to remove generated heat in the reactor core and for coolant to remove heat from various components of an exemplary reactor system. In the event that a loss in any one of the coolant flow paths is sensed or anticipated, appropriate actions may be employed to ensure reliable removal of heat from the reactor core and/or reactor system components. FIGS. 47 and 48 are schematic diagrams of a reactor system under loss of coolant conditions according to an embodiment of the present subject matter. Loss of coolant in the closed heat exchanger water loop 4590 may be sensed as a function of any one or combination of the following parameters: (1) water from the heat exchanger 4505 does not pick up enough heat to turn into steam; (2) steam does not exit through outlet 4506; (3) steam does not enter the power recovery unit 4507; (4) recovered power is not redirected out of unit 4507 to a desired market; (5) steam does not exit the power recovery unit 4507; (6) steam does not enter the condenser 4508; (7) steam does not condense into liquid water (i.e., condenser 4508 does not function properly); (8) water from the condenser 4508 does not enter one or more of the low-pressure circulation pumps 4509; (9) any one of the low-pressure circulation pumps 4509 do not provide an appropriate pressure; (10) water does not enter the water quality control system 4510; (11) water does not exit the water quality control system 4510; (12) water does not enter the main water reservoir 4501; (13) water does not exit the main reservoir 4501; (14) water does not enter the high-pressure feedwater pumps 4503; (15) any one of the high-pressure feedwater pumps 4503 does not provide an appropriate pressure; (16) water does not exit any one of the operating high-pressure pumps 4503; and (17) water does not enter the inlet 4504 of the heat exchanger 4505. With reference to FIGS. 47 and 48, if loss of coolant is sensed in the closed heat exchanger water loop 4590, then the following alternative closed heat exchanger coolant path 4790 and respective process may be implemented. The main water reservoir 4501 feeds cold water along the alternative path 4790 to fill an upper loss of coolant accident tank 4711. Water from the upper tank 4711 circumnavigates the reactor pressure vessel via surface heat exchangers 4712 down to the lower loss of coolant accident tank 4713. Such flow may be gravity fed or pressurized. Further the surface heat exchangers 4712 may be in the form of multiple annular rings or pipes, spiral or vertical pipes and U-tubes. In embodiments where the flow is pressurized, the lower tank 4713 would not be vented to atmosphere. The water from the lower tank 4713 may then feed into cooling pipes 4714 passing below the main pressure vessel frame. The heated water from the cooling pipes 4714 may pass into another water reservoir 4715. In embodiments where the flow is pressurized, the reservoir 4715 will not be vented to atmosphere. From the reservoir 4715 the water feeds through a set of recovery pumps 4716 which return the water to the main water reservoir 4501.

Proper flow in the alternative closed heat exchanger coolant path 4790 may be sensed and/or monitored as a function of any one or combination of the following parameters: (1) water fails to exit the main reservoir 4501 via the path 4790; (2) water from the main reservoir 4501 fails to enter the upper tank 4711; (3) water fails to exit the upper tank 4711; (4) water from the upper tank 4711 fails to circumnavigate the pressure vessel through the surface heat exchanger 4712; (5) water from the surface heat exchanger 4712 fails to enter the lower tank 4713; (6) water fails to exit the lower tank 4713; (7) water from the lower tank 4713 fails to enter the lower frame cooling pipes 4714; (8) water fails to exit the lower frame cooling pipes 4714; (9) water from the lower frame cooling pipes 4714 fails to enter the water reservoir 4715; (10) air fails to vent from the reservoir vent; (11) water from the reservoir 4715 fails to enter one or more of the recovery pumps 4716; (12) water fails to exit one or more recovery pumps 4716; and water from the recovery pumps 4716 fails to enter the main reservoir 4501.

Loss of coolant in the normal closed heat exchanger reactor gas coolant loop 4595 may be sensed as a function of any one or combination of the following parameters: (1) gas coolant does not exit the gas/water heat exchanger 4505 through the outlet 4526; (2) Venturi pumps 4527 do not function properly; (3) Venturi meters 4528 do not provide proper pressure circulation; (4) gas coolant does not enter the inlet manifolds 4529; (5) gas coolant does not flow up around each individual fuel array; (6) gas coolant does not exit the top of each fuel array; (7) gas coolant does not flow down reactor coolant exhaust pipes 4531; (8) gas coolant does not pick up sufficient heat from the fuel arrays; (9) gas coolant does not enter passage 4532 at the bottom of the pressure vessel; (10) gas coolant does not exit the gas outlet 4533; (11) gas coolant does not enter the manifold 4534; (12) particles do not collect in the particle collector 4535; (13) gas coolant does not flow through the manifold 4534; (14) gas coolant does not enter the inlet 4536 of the gas/water heat exchanger 4505; and (15) heated gas coolant does not circulate down the heat exchanger 4505 to heat the water. With reference to FIGS. 47 and 48, if loss of coolant is sensed in the closed heat exchanger reactor gas coolant loop 4595, then the following alternative closed heat exchanger reactor gas coolant path 4795 and respective process may be implemented. At any time during, before or after the following process or if the reactor core temperature exceeds a predetermined temperature, neutron control blades 4720 according to embodiments of the present subject matter may be activated by the respective driving mechanisms or by gravity to immediately shut down the reactor. To remove residual heat build-up from the reactor core, a storage container 4721 of gas coolant may be will be activated to feed through a loss of coolant auxiliary controller 4722. The storage container 4721 may be pressurized in one embodiment. The controller 4722 directs the gas coolant to an auxiliary cold gas inlet 4723. The auxiliary gas inlet 4723 directs the gas coolant to the neutron control blade cavities. Since the neutron control blades 4720, when activated, may block the gas coolant outlet used by the coolant during normal operating conditions, the heated gas exits through an auxiliary gas coolant outlet 4724 controlled by a valve 4725.

Proper flow in the alternative closed heat exchanger reactor gas coolant path 4795 may be sensed and/or monitored as a function of any one or combination of the following parameters: (1) stored back-up gas coolant fails to exit storage containers 4721; (2) gas coolant from 4721 fails to enter the auxiliary controller 4722; (3) gas coolant fails to exit the auxiliary controller 4722; (4) gas coolant from the auxiliary controller 4722 fails to enter the auxiliary gas inlet 4723; (5) neutron control blades 4720 fail to activate (i.e., remain fully or partially retracted); (6) gas coolant is not properly directed throughout the blade cavities from the auxiliary gas inlet 4723; (7) gas coolant from the blade cavities fails to enter the auxiliary gas outlet 4724; (8) gas coolant fails to exit the gas coolant outlet 4724 (e.g., the valve 4725 does not function properly); and (9) vented gas coolant from the outlet 4724 is not pure.

It is therefore an aspect of embodiments of the present subject matter to provide multiple redundant safety systems, e.g., large peripheral neutron absorbers that can be inserted rapidly to stop a nuclear reaction, even in the event of electrical power loss or operator incapacity; as a backup in case of coolant loss, a gravity-flow water tank may be opened automatically or manually to cool the reactor for up to several days while radioactive decay heat in the core diminishes; thermal self-regulating reactor core.

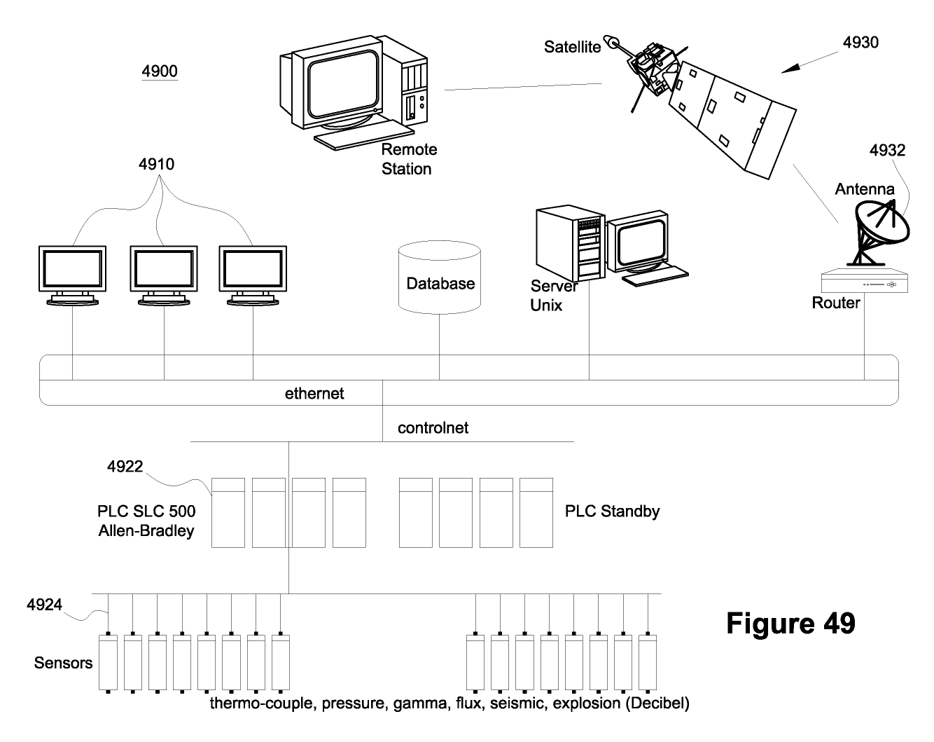

It is another aspect of embodiments of the present subject matter to provide reliable automated safety systems. FIG. 49 is a diagram of a reactor safety and control system according to one embodiment of the present subject matter. With reference to FIG. 49, an exemplary reactor safety and control system 4900 is shown. A local reactor operator(s) may monitor conditions and parameters of an exemplary reactor core and supporting systems and components in a control room. Monitoring may occur via touch-screen displays 4910 via an Ethernet 4920 in communication with programmable logic controllers 4922 that interface with thermocouples, resistance temperature detectors, pressure sensors, and gamma, flux, seismic and other sensors 4924 in the reactor and supporting components. Of course, monitoring may be conducted directly via gages in the control room that provide a direct output of the sensors 4924. In the event of an incapacitation of the operator, a satellite communication link 4930 may permit an external operator control of the system 4900 via an antenna 4932 to shut down and/or control the reactor and supporting components remotely. In one embodiment the monitoring and control may be automated.

It is also an aspect of embodiments of the present subject matter that when safety-critical gauges exceed predetermined emergency thresholds, or when complete electric power loss and electronic control failure occurs, exemplary electronic solenoids and similar interlock devices will fail in a “safe” position that automatically deploys the gravity-propelled reactor shut-down system and emergency coolant. An exemplary reactor system may also be equipped with a short-term back-up electricity supply system for critical functions to allow the reactor system to accommodate brief power surges or power interruptions without disrupting the normal operation.

Embodiments of the present subject matter may also provide several layers of physical barriers to contain radiation and provide protection. For example, fuel arrays may be surrounded by a sealed pressure vessel to prevent any leakage of radioactive material. The reactor core may be housed in a thick concrete and steel containment structure providing shielding and physical security.

Embodiments may also provide multiple controls on the nuclear reaction. For example, reactivity in an exemplary reactor core may be controlled by neutron absorbers with backup emergency systems. It is also envisioned that a movable neutron moderator may also be utilized to fine-tune the reactivity breed ratio. The reactor core may also be designed with a strong negative thermal coefficient of reactivity just above the operating temperature to provide a nearly fail-safe protection against core melt-down.

In one aspect of embodiments of the present subject matter, the reactor may be positioned underground with auto-closing exit passages to prevent radiation escape; thus, the top of a containment structure would generally be at ground level.

Another aspect of embodiments of the present subject matter provide a thermally self-regulating reactor capable of operating for 30-50 years due to the breed-fission process described above. The reactor may then serve as the burial cask for its respective waste/decommissioning. For example, the reactor core at end of life may be vitrified, and the underground reactor core and accompanying containment levels act as the storage vessel for the small amount of nuclear waste produced in each reactor generation.

As shown by the various configurations and embodiments illustrated in FIGS. 1-49, a nuclear reactor and method supporting systems have been described.

While preferred embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

I claim:

1. A pressure vessel for housing the core of a nuclear reactor, said pressure vessel comprising:
a lower vessel comprising a generally cylindrical wall forming a generally circular upwardly facing opening; and
a pressure vessel closure head comprising:
a generally cylindrical lower portion having a dimension for mating with the upper edge of said wall of said lower vessel to form an airtight closure of said opening; and
a curved upper portion having a sealable access port extending along a radius thereof,
said closure head being rotatable in a horizontal plane about its central axis so that said access port may be positioned relative to said lower vessel for accessing differing portions of the interior of said pressure vessel without removing said closure head,
wherein said lower vessel and said closure head being adapted to house the core of a nuclear reactor.

2. The pressure vessel of claim 1 further comprising a vehicle guide affixed to the upper portion of said closure head.

3. The pressure vessel of claim 2 wherein said vehicle guide comprises rail tracks.

4. The pressure vessel of claim 3 wherein said rail tracks are substantially horizontal and extend from across the width of said closure head along a diameter thereof.

5. The pressure vessel of claim 3 wherein said rail tracks are adapted to support a crane on a rail car.

6. The pressure vessel of claim 1 wherein said closure head is torispherical.

7. The pressure vessel of claim 1 wherein said wall comprises a lower generally cylindrical portion and an upper generally cylindrical portion wherein the diameter of said upper portion is smaller than the diameter of said lower portion and said closure head is dimensioned to mate with the upper edge of said upper portion of said wall.

8. The pressure vessel of claim 1 wherein said wall includes a penetration for lateral insertion of one or more reactor control blades into the interior of said lower vessel.

9. The pressure vessel of claim 8 comprising a housing extending outwardly from said wall and forming an airtight cover over said penetration, said housing being adapted to receive a reactor control blade that is retracted from the interior of said vessel through said penetration.

10. The pressure vessel of claim 8 wherein said wall includes a pair of opposing penetrations.

11. The pressure vessel of claim 1 wherein said closure head is rotatable at least 180 degrees clockwise and counterclockwise.

12. The pressure vessel of claim 1 wherein said lower vessel includes a plurality of cooling pipes in said cylindrical wall to remove heat from said lower vessel.

13. A pressure vessel comprising:
a lower vessel having an upwardly facing opening; and
a vessel closure head having a sealable access port, said vessel closure head being supported by said lower vessel and being adapted to form an airtight closure of said opening, said vessel closure head being positionable in differing positions relative to said lower vessel so that differing portions of the interior of said pressure vessel may be accessed through said access port.

14. The pressure vessel of claim 13 wherein said closure head includes a circular cross-section and said sealable access port extends from a central portion of said closure head along a radius toward the periphery of said closure head.

15. The pressure vessel of claim 14 including a vehicle guide extending along said radius of said closure head.

16. The pressure vessel of claim 15 wherein said vehicle guide comprises rail tracks.

17. The pressure vessel of claim 14 wherein said closure head is torispherical.

18. The pressure vessel of claim 13 including a vehicle guide attached to said closure head.

19. The pressure vessel of claim 18 wherein said vehicle guide comprises rail tracks.

20. The pressure vessel of claim 13 wherein said vessel houses a nuclear reactor core.

21. A vessel for providing an airtight chamber, said vessel comprising:
a lower portion having an upwardly facing opening;
a closure head supported by said lower portion and being adapted to form an airtight closure of said opening, said lower portion and said closure head forming an airtight chamber on the interior thereof; and
a vehicle guide supported by said closure head.

22. The vessel of claim 21 wherein said vehicle guide includes rail tracks.

23. The vessel of claim 21 wherein said closure head includes a circular cross-section, and wherein said vehicle guide extends along a radius thereof.

24. The vessel of claim 23 wherein said closure head comprises a sealable access port extending along said radius.

25. The vessel of claim 21 wherein said closure head is torispherical and said vehicle guide is supported by said head by a truss so that said guide is generally planar.

26. A system for rotating the closure head of a nuclear reactor pressure vessel, said system comprising:
a lower vessel comprising a generally cylindrical upper wall, said wall having a circumferential laterally extending rim defining an upwardly facing mating surface;
a vessel closure head comprising a generally cylindrical lower portion having:
a circumferential laterally extending rim defining a downwardly facing mating surface, and
a circumferential vertically extending rim, said rim comprising a geared surface,
said closure head being positioned on said lower vessel with said downwardly facing mating surface adjacent said upwardly facing mating surface of said lower vessel;
a plurality of clamps spaced around the periphery of said circumferential laterally extending rims, each of said clamps comprising an upper engaging surface for engaging the upper surface of said laterally extending rim of said closure head and a lower engaging surface for engaging the lower surface of said laterally extending rim of said lower vessel;
a rigid support structure laterally surrounding the upper portion of said lower vessel and the lower portion of said closure head;
a plurality of jack rollers attached to said vessel closure head and spaced around the circumference of said vessel closure head, each of said rollers comprising a vertically oriented disc having an axle;
one or more jacks spaced around an inner portion of said rigid support structure, each of said jacks being positioned to engage the disc of a jack roller to thereby elevate said closure head when said jacks are extended; and
one or more driving mechanisms supported from said rigid support structure, said driving mechanisms comprising a gear for engaging the geared surface of said vertically extending rim of said closure head, and a motor for turning said gear to thereby rotate said closure head when the closure head is elevated by said jacks.

27. The system of claim 26 wherein said closure head includes a circular cross-section and a sealable access port extending from a central portion of said closure head along a radius toward the periphery of said closure head.

28. The system of claim 27 wherein said access port forms the only penetration through said closure head.

29. The system of claim 27 further comprising a vehicle guide extending along said radius of said closure head.

30. The system of claim 29 wherein said vehicle guide comprises rail tracks.

31. The system of claim 26 wherein said closure head is rotatable at least 180 degrees clockwise and counterclockwise.

32. The system of claim 26 wherein said one or more jacks comprises a rail adapted to support said jack rollers when in a raised position.

33. A method of positioning a vessel closure head having a lower surface mated on an upper surface of a lower vessel from a first position maintained by a plurality of clamps spaced about the periphery of the closure head to a second position, said method comprising:
removing the clamps from the periphery of the closure head;
elevating the closure head so that the lower surface of the closure head is spaced from the upper surface of the lower vessel;
driving a plurality of rollers each having a surface in frictional contact with a surface of the closure head to thereby rotate the closure head about a vertical axis; and
ceasing the driving of the rollers so that the closure head has rotated to the second position.

34. The method of claim 33 further comprising the steps of:
lowering the closure head so that the lower surface of the closure head is mated with the upper surface of the lower vessel; and
installing the clamps on the periphery of the closure head.

35. The method of claim 33 wherein said rotation is clockwise or counterclockwise.

36. In a nuclear reactor having a nuclear core comprising a horizontal array of vertically elongated fuel cells housed within a reactor pressure vessel, a method of providing access to each fuel cell from above the cell, said method comprising:
housing the reactor core in a pressure vessel having a lower vessel with an upper cylindrical wall and a closure head supported by the wall, the closure head having an access port extending from a central portion to the periphery of the closure head along a radius thereof;
rotating the closure head relative to the lower vessel so that a selected cell in the fuel cell array is accessible from above the cell through the access port.

37. The method of claim 36 further comprising the step of positioning a crane along the access port so that the crane may be positioned above a selected cell in the fuel cell array.

38. The method of claim 37 wherein said crane is positionable along a set of rails extending along the radius of the access port

39. The method of claim 36 wherein the closure head may be rotated clockwise or counterclockwise.

40. A pressure vessel comprising:
a lower vessel having an opening defined by a lip forming a mating surface;
a vessel closure head having a lip forming a mating surface, said closure head being positioned so that said closure head mating surface is mated to said lower vessel mating surface;
a flexible seal positioned between opposing grooves formed in said mating surfaces, said seal being inflatable to a predetermined pressure; and
a plurality of clamps positioned along said mated lips, each of said clamps engaging the closure head lip and the lower vessel lip to thereby maintain an airtight seal between said mating surfaces when the interior of the vessel contains a pressure greater than 100 psi.

41. The vessel of claim 40 wherein:
said lower vessel comprises a generally cylindrical wall having a circumferential laterally extending lip forming an upwardly facing mating surface, said mating surface forming a circumferential groove;
said closure head comprises a circumferential laterally extending lip forming a downwardly facing mating surface, said mating surface forming a circumferential groove, said closure head being positioned on said lower vessel so that said mating surfaces are mated and said grooves form a channel containing said flexible seal; and
each of said clamps comprises an upper flange engaging a groove formed in the upper surface of said closure head lip, and a lower flange engaging a groove formed in the lower surface of said lower vessel lip, said flanges being held in frictional engagement with said lips.

42. The vessel of claim 41 adapted to house the core of a nuclear reactor.

43. A system for sealing a closure head on a pressure vessel wherein the closure head includes a mating surface positioned adjacent a mating surface of the vessel, said system comprising an inflatable seal positioned in opposing grooves formed in the mating surfaces and a plurality of interlocking clamps frictionally engaged with the closure head and vessel to thereby maintain an airtight closure when the vessel contains pressure greater than 100 psi.

44. A pressure vessel having a weldless and threadless system for maintaining a pressure containing seal between a lower vessel and closure head, said pressure vessel comprising:
a lower vessel comprising a generally cylindrical upper wall, said wall having a circumferential laterally extending rim defining an upwardly facing mating surface having a circumferential groove formed therein, the lower surface of said rim having a circumferential groove formed therein;
a vessel closure head comprising a generally cylindrical lower portion having a circumferential laterally extending rim defining a downwardly facing mating surface, the upper surface of said rim having a circumferential groove formed therein, the lateral surface of said rim forming a circumferential recessed portion, said rim including a curved surface interconnecting a lateral wall of said recessed portion to said mating surface, said closure head being positioned on said lower vessel with said downwardly facing mating surface adjacent said upwardly facing mating surface of said lower vessel to thereby form a channel bounded on the bottom half by the groove formed in said lower vessel mating surface and bounded on an upper quadrant by said curved interconnecting surface of said closure head rim;
an inflatable seal positioned within said channel; and
a plurality of interlocking clamps spaced around the periphery of said circumferential laterally extending rims, each of said clamps comprising a vertically extending portion having an upper clamping arm and a lower clamping arm, an interlocking portion extending laterally from one side of the clamp and including a curved surface interconnecting an inner face and a lower face, and a recess for receiving the end portion of the interlocking portion of an adjacent clamp, each of said clamps being positioned so that said upper clamping arm engages the groove formed in the upper surface of said laterally extending rim of said closure head, and said lower clamping arm engages the groove formed in the lower surface of said laterally extending rim of said lower vessel, the interlocking portions of said clamps forming a circumferential ring positioned in said recess formed in the rim of the closure head so that the curved interconnecting surfaces of said interlocking portions form an upper quadrant of said channel, each of said clamps being held in frictional engagement with said rims by a threaded bolt extending through a portion of the upper clamping arm and engaging the groove in the upper surface of said closure head rim.

45. A method for sealing a pressure vessel having a vessel closure head with a lower mating surface adaptable to mate with an upper mating surface of a lower vessel, the method comprising the steps of:
installing an inflatable seal between the lower mating surface of the vessel closure head and the upper mating surface of the lower vessel;
positioning the vessel closure head to thereby mate the upper and lower mating surfaces;
positioning a plurality of clamps about the periphery of the closure head, each of the clamps including:
an upper engaging portion for engaging an upper surface of a laterally extending rim of the vessel closure head,
a lower engaging portion for engaging a lower surface of a laterally extending rim of the lower vessel,
an elongated portion connecting the upper and lower engaging portions, the elongated portion including:
a notch on one lateral side, and
a lateral extension on an opposing lateral side extending from approximately the midsection of the elongated portion to the notch of an adjacent clamp;
securing the position of each clamp by frictionally engaging the upper and lower engaging portions with the rims; and
inflating the inflatable seal to a predetermined pressure.

46. The method of claim 45 wherein the step of securing includes threading a fastener though a portion of the upper engaging portion of the clamp so that the end of the fastener engages the upper surface of the rim on the closure head.

47. The method of claim 45 wherein the seal is inflated by a gas or liquid.

48. In a system for controlling the reactivity of a nuclear reactor core, the system including a pressure vessel for housing said nuclear reactor core and having a lower vessel and a vessel closure head, said vessel closure head being supported by said lower vessel, the improvement comprising a plurality of neutron absorbing devices adaptable to laterally insert into the lower vessel.

49. The system of claim 48 wherein each of said neutron absorbing devices is a blade.

50. The system of claim 48 wherein each of said neutron absorbing devices is independently controllable.

51. The system of claim 48 wherein at least one of said plural neutron absorbing devices is adaptable to laterally insert into said lower vessel in a clockwise direction.

52. The system of claim 48 wherein at least one of said plural neutron absorbing devices is adaptable to laterally insert into said lower vessel in a counter-clockwise direction.

53. The system of claim 48 wherein said closure head includes no penetrations for reactor control rod drive mechanisms.

54. In a nuclear reactor having a core comprising a plurality of fuel cells aligned along substantially parallel axes and a system for controlling the reactivity of the reactor core comprising a plurality of neutron absorbing devices being insertable into the reactor core, the improvement comprising a plurality of neutron absorbing devices being insertable into said reactor core by rotating said devices about one or more axes substantially perpendicular to the axes of said fuel cells.

55. The system of claim 54 wherein each of said substantially perpendicular axes are external to said reactor core.

56. The system of claim 54 comprising two sets of one or more neutron absorbing devices, one set being insertable into said reactor core by rotation in a clockwise direction, the other set being insertable into said reactor core by rotation in a counterclockwise direction.

57. The system of claim 56 wherein each set of neutron absorbing devices comprises three devices.

58. In a nuclear reactor having a core comprising one or more fuel cells and a system for controlling the reactivity the reactor core comprising a plurality of neutron absorbing devices being insertable into the reactor core, the improvement comprising a plurality of neutron absorbing devices being insertable into said reactor core by moving along an arcuate path.

59. The system of claim 58 wherein the length of the arcuate path is less than ninety degrees.

60. The system of claim 58 wherein each of said neutron absorbing devices is independently moveable.

61. The system of claim 58 comprising at least two neutron absorbing devices being moveable in coplanar arcuate paths.

62. The system of claim 61 wherein each neutron absorbing device is moveable in an arcuate path that is coplanar with the arcuate path of movement of another neutron absorbing device.

63. The system of claim 58 comprising at least two neutron absorbing devices being moveable in parallel arcuate paths.

64. The system of claim 58 the each neutron absorbing device is moveable in an arcuate path that is either coplanar or parallel the arcuate paths of movement of each of the other neutron absorbing devices.

65. The system of claim 58 wherein each neutron absorbing devices forms a blade.

66. A system for inserting one or more neutron absorbing devices into a nuclear reactor core and for withdrawing the one or more devices from the core, said system comprising:
a rotatable axle having a disc connected proximate one end of said axle, said disc having a geared surface and being connected to said axle so that rotation of the disc effects rotation of the axle;
a neutron absorbing device having a configuration adapted for insertion of at least a neutron absorbing portion of said device into the nuclear reactor core, said device being connected to said rotatable axle and extending laterally from said axle so that said device rotates about the axis formed by said axle; and
an axle driving mechanism comprising a motor operatively connected to a drive shaft, said drive shaft having a geared surface engaged with the geared surface of said disc so that rotation of said drive shaft effects rotation of said disc and axle,
whereby said neutron absorbing device is rotatable about the axis of said axle from a position wherein the neutron absorbing portion is withdrawn from the core to a position wherein at least a portion of the neutron absorbing portion is inserted in the core.

67. The system of claim 66 wherein said neutron absorbing device comprises a blade configuration having a rigid frame connected at one end to said axle and a neutron absorbing portion at the other end.

68. The system of claim 66 further comprising one or more counterweights connected to said axle so that the gravitation force exerted on said counterweights tends to cause rotation of said device to a position at least partially inserted into the core.

69. The system of claim 66 comprising a plurality neutron absorbing devices.

70. The system of claim 69 comprising two sets of opposing neutron absorbing devices.

71. The system of claim 70 the axles connected to each neutron absorbing device in a set of devices are axially aligned.

72. A nuclear reactor core comprising:
a central driver region comprising a plurality of fissile nuclear fuel assemblies;
a breeder region surrounding said central driver region, said breeder region comprising a plurality of fertile nuclear fuel assemblies; and
a moderator region surrounding said breeder region, said moderator region comprising a material suitable for thermalizing fast neutrons.

73. The nuclear reactor core of claim 72 further comprising a burner region surrounding said moderator region, said burner region comprising a plurality of fuel assembly wells each adapted to receive a fissile nuclear fuel assembly from said plurality of fissile nuclear fuel assemblies in said driver region.

74. The nuclear reactor core of claim 72 wherein said fissile nuclear fuel assemblies contain enriched uranium.

75. The nuclear reactor core of claim 74 wherein said fertile nuclear fuel assemblies contain ThO2.

76. The nuclear reactor core of claim 72 wherein said fertile nuclear fuel assemblies contain ThO2.

77. The nuclear reactor core of claim 72 wherein said moderator region comprises a solid moderator material.

78. The nuclear reactor core of claim 77 wherein said moderator material is carbon-based.

79. A nuclear reactor having a pressure vessel housing a nuclear reactor core, said nuclear reactor core comprising:
a central driver region comprising a plurality of fissile nuclear fuel assemblies containing fissile nuclear fuel material;
a breeder region surrounding said central driver region, said breeder region comprising a plurality of fertile nuclear fuel assemblies containing ThO2;
a moderator region surrounding said breeder region, said moderator region comprising a carbon-based material suitable for thermalizing fast neutrons;
a buffer region surrounding said moderator region;
a burner region surrounding said buffer region, said burner region comprising a plurality of fuel assembly wells each adapted to receive a fissile nuclear fuel assembly from said plurality of fissile nuclear fuel assemblies in said driver region;
a plurality of coolant pipes positioned within said buffer region for transferring heat from said burner region to said moderator material;
a shielding region surrounding said burner region; and
a plurality of coolant pipes positioned between said shielding region and the wall of the pressure vessel for cooling the pressure vessel wall.

80. The reactor of claim 79 wherein said reactor core further comprises a plurality of nuclear fuel housings, each housing having:
a block having substantially planar upper and lower surfaces and four substantially planar lateral surfaces, a portion of said upper surface axially extending from the perimeter thereof and a portion of said lower surface forming a peripheral indentation axially extending above said lower surface, and
one or more fuel wells defining one or more passages through said block, each of said fuel wells being adaptable to accept a nuclear fuel element having said fertile or fissile nuclear fuel material,
wherein ones of said plurality of housings are axially mated with an adjacent housing via said portions of said upper and lower surfaces.

81. The reactor of claim 80 wherein each fuel element comprises:
a plurality of nuclear fuel cells each having a generally planar horizontal lower floor and a wall extending upwardly from said lower floor, the upper edge of said wall forming an upwardly facing opening, and
a coolant channel aligned about a central longitudinal axis of said element having a wall defining a passage through said element, a portion of said channel wall axially extending from said upper edge and a portion of said channel wall forming an indentation laterally extending beyond the periphery of said channel and axially extending above said lower floor.

82. The reactor of claim 79 wherein the fissile nuclear fuel material contains plutonium.

83. The reactor of claim 79 wherein the fissile nuclear fuel material contains uranium.

84. A method for reducing concentration of fission products in a nuclear reactor comprising the steps of:
providing an inner first region in a nuclear reactor core, the first region having substantially fissile nuclear fuel material;
providing a second region in the reactor core, the second region substantially surrounding the first region and having substantially fertile nuclear fuel material;
substantially surrounding the second region with a moderator to slow neutrons escaping from the first and second regions; and
positioning a distal third region having substantially fissile nuclear fuel material, the third region having a substantially higher fission product concentration than the first region and being adapted to receive neutrons from the first and second regions.

85. The method of claim 84 wherein the moderator is a solid moderator.

86. The method of claim 84 wherein the moderator is carbon-based.

87. The method of claim 84 wherein the fission product is plutonium.

88. A method for reducing concentration of fission products in nuclear fuel material comprising the steps of:
providing an inner first region in a nuclear reactor core, the first region having substantially fissile nuclear fuel material having substantially high fission product concentrations;
providing a second region in the reactor core, the second region substantially surrounding the first region and having substantially fertile nuclear fuel material; and
substantially surrounding the second region with a moderator to slow neutrons escaping from the first and second regions,
wherein one of the substantially high fission product concentrations is a function of plutonium.

89. A method of producing energy comprising the steps of:
providing fissile nuclear fuel material in a first region of a nuclear reactor core;
providing fertile nuclear fuel material in a second region of the nuclear reactor core;
providing a moderator in a third region of the nuclear reactor core;
irradiating the fertile nuclear fuel material with neutrons from the first region to breed fissile nuclear fuel material in the second region;
removing fissile nuclear fuel material from the second region as a function of fissile material concentration;
removing fissile nuclear fuel material from the first region as a function of fission product concentration;
positioning the removed fissile nuclear fuel material from the second region into the first region;
positioning the removed fissile nuclear fuel material from the first region into a distal fourth region of the nuclear reactor core; and
providing additional fertile nuclear fuel material in the second region to replace the removed fissile nuclear fuel material.

90. The method of claim 89 further comprising the step of irradiating fissile nuclear fuel material in the fourth region by moderated neutrons from the first and second regions to reduce fission product concentrations.

91. The method of claim 90 wherein one fission product concentration is a function of plutonium.

92. The method of claim 89 further comprising the step of maintaining the temperature of the third region at or above a predetermined temperature.

93. The method of claim 92 wherein said predetermined temperature is approximately 700° F.

94. The method of claim 89 wherein the second region substantially surrounds the first region.

95. The method of claim 89 wherein the third region substantially surrounds the second region.

96. A nuclear reactor core sub-assembly for supporting and containing nuclear fuel material, said sub-assembly comprising a plurality of stacked fuel housing structures, each of said structures comprising:
a central region forming a central coolant channel having an axially extending lip surrounding said channel at one end and an axially extending recess at the other end surrounding said channel; and
a peripheral region forming a plurality of fuel wells spaced around said central region, each of said wells having a closed bottom portion and being adapted to receive nuclear fuel material from an open top end,
wherein a first housing is positioned on top of a second housing so that (i) the axially extending recess of the first housing is positioned over the lip of the second housing; (ii) the channel of the first housing is axially aligned with the channel of the second housing; and (iii) the bottom surface of the peripheral region of the first housing covers the open ends of the fuel wells of the second housing.

97. The sub-assembly of claim 96 wherein said peripheral region forms at least three fuel wells.

98. The sub-assembly of claim 97 wherein said peripheral region forms five fuel wells.

99. The sub-assembly of claim 96 wherein each of said fuel wells is generally cylindrical.

100. The sub-assembly of claim 96 wherein said coolant channel is generally cylindrical.

101. The sub-assembly of claim 96 wherein the geometric figure formed by the lateral wall of said axially extending lip and recess are the same.

102. The sub-assembly of claim 101 wherein the geometric figure is selected from the group consisting of: circle, triangle, square, pentagon, hexagon, heptagon, octagon, enneagon, and decagon.

103. A nuclear reactor core fuel array comprising a plurality of stacked rectangular blocks, each of said blocks comprising:
a generally rectangular interior region forming a plurality of generally cylindrical wells extending between opposing major faces of said region, each well being adapted to receive a fuel housing structure; and
a peripheral wall surrounding said interior region, said wall extending axially from one of said major faces of said interior region forming a lip about the periphery of said major face, said peripheral wall terminating at a point axially spaced from the other of said major faces forming a recess about the periphery of said major face, said recess being adapted to receive the lip of an adjacent block.

104. The fuel array of claim 103 wherein said interior region forms a plurality of coolant channels extending between said major faces.

105. The fuel array of claim 103 wherein said fuel housing structure further comprises:
a central region forming a central coolant channel having an axially extending lip surrounding said channel at one end and an axially extending recess at the other end surrounding said channel; and
a peripheral region forming a plurality of fuel wells spaced around said central region, each of said fuel wells having a closed bottom portion and being adapted to receive nuclear fuel material from an open top end,
wherein a first housing is positioned on top of a second housing so that (i) the axially extending recess of the first housing is positioned over the lip of the second housing; (ii) the channel of the first housing is axially aligned with the channel of the second housing; and (iii) the bottom surface of the peripheral region of the first housing covers the open ends of the fuel wells of the second housing.

106. A nuclear reactor comprising:
a pressure vessel having a lower vessel forming an upwardly facing opening and a vessel closure head being supported by said lower vessel and being adapted to form an airtight closure of said opening;
a nuclear reactor core positioned in said lower vessel, said reactor core comprising:
a central driver region comprising a plurality of fissile nuclear fuel assemblies, each assembly comprising a substantially vertical coolant channel for providing an coolant flow path from an inlet plenum beneath said assembly to an outlet plenum above said assembly,
a breeder region comprising a plurality of fertile nuclear fuel assemblies, each assembly comprising a substantially vertical coolant channel for providing an coolant flow path from an inlet plenum beneath said assembly to an outlet plenum above said assembly, and
a moderator region; and
a coolant system comprising:
a first coolant manifold having an inlet plenum and a plurality of pylons positioned beneath said fertile nuclear fuel assemblies, said pylons being in fluid communication with the coolant channels of said fertile fuel assemblies and being configured to direct coolant flow substantially into said channels at a first predetermined coolant flow rate;
a second coolant manifold having an inlet plenum and a plurality of pylons positioned beneath said fissile nuclear fuel assemblies, said pylons being in fluid communication with the coolant channels of said fissile fuel assemblies and being configured to direct coolant flow into substantially said channels at a second predetermined coolant flow rate;
one or more coolant pumps adapted to pump coolant into said first and second coolant manifold inlet plenums; and
a coolant outlet positioned above said fertile and fissile nuclear fuel assemblies and being configured to receive coolant flowing from the coolant channels of said fertile and fissile nuclear fuel assemblies and to direct heated coolant to an outlet plenum.

107. The system of claim 106 wherein a portion of the coolant directed to the outlet plenum flows through reactor coolant exhaust pipes to control the temperature of said moderator region.

108. The system of claim 106 wherein said reactor coolant is selected from the group consisting of: liquid and gas.

109. The system of claim 106 wherein the first predetermined coolant flow rate is less than the second predetermined coolant flow rate.

110. The system of claim 106 wherein the pylons in the first and second coolant manifolds are adaptable to allow cross-circulation between the respective coolant flows in the manifolds.
